(19) United States
(12) Patent Application Publication
(10) Pub. No.: US 2026/0065484 A1
(43) Pub. Date: Mar. 5, 2026

(54) SYSTEMS AND METHODS FOR USE OF GENERATIVE ARTIFICIAL INTELLIGENCE (AI) IN CARDIAC PATIENT CARE

(71) Applicant: Heartflow, Inc., Mountain View, CA (US)

(72) Inventors: Michiel SCHAAP, Oegstgeest (NL); Matthew SINCLAIR, London (GB); Andreas SCHUH, Cambridge (GB); Peter Kersten PETERSEN, Palo Alto, CA (US); Esther PUYOL ANTON, London (GB); Samuel GERBER, Fayetteville, WV (US); Souma SENGUPTA, Cupertino, CA (US); Benjamin Michael GLOCKER, Cambridge (GB); Timothy A. FONTE, San Francisco, CA (US); James BATTEN, Monbalen (FR); Tian XIA, London (GB); Nan XIAO, San Jose, CA (US); Patrick VIOLETTE, Austin, TX (US); Justin VASQUEZ, San Francisco, CA (US)

(21) Appl. No.: 19/320,787

(22) Filed: Sep. 5, 2025

Related U.S. Application Data
(60) Provisional application No. 63/690,895, filed on Sep. 5, 2024.
(60) Provisional application No. 63/762,256, filed on Feb. 24, 2025.

(51) Int. Cl. G06T 7/00; G06V 10/774; G06V 10/82

(52) U.S. Cl. CPC G06T 7/0016; G06V 10/774; G06T 2207/10081; G06T 2207/20081; G06T 2207/20084; G06T 2207/30048; G06T 2207/30101; G06T 2207/30104; G06V 10/82; G06V 2201/031

(57) ABSTRACT

A computer implemented method for training a whole medical image foundation model, including: receiving a plurality of medical image datasets; extracting local sections of image data from the plurality of medical image datasets; obtaining one or more causal variables associated with the local sections and/or patient; training one or more self-supervised learning models based on the local sections of image data and the causal variables; combining the one or more trained self-supervised learning models with a deep learning network configured to combine a latent representation of the local sections of image data from the one or more trained self-supervised learning models into a patient-level representation; and combining, with the one or more trained self-supervised learning models and the deep learning network, at least one further network or function configured to accept the patient-level representation as input, the at least one further network or function operable to perform one or more patient-specific prediction tasks.

### CROSS-REFERENCE TO RELATED APPLICATION

This application claims priority to U.S. Provisional Application No. 63/690,895, titled “Systems and Methods for Generation of Outlier Training Samples”, filed Sep. 5, 2024, and U.S. Provisional Application No. 63/762,256, titled “Systems and Methods for Use of Generative AI in Cardiac Patient Care”, filed Feb. 24, 2025, which are hereby incorporated by reference in their entirety.

### FIELD OF DISCLOSURE

The present disclosure relates to artificial intelligence systems for medical imaging analysis, and more particularly to systems and methods for using generative artificial intelligence models in cardiac patient care and for generation of outlier training samples from medical imaging data.

### BACKGROUND

Medical imaging has become an indispensable tool in modern healthcare, enabling physicians to visualize internal structures and diagnose diseases non-invasively. Among various imaging modalities, computed tomography (CT) and coronary computed tomography angiography (CCTA) have emerged as valuable techniques for assessing cardiovascular conditions. These imaging technologies provide detailed three-dimensional representations of cardiac anatomy and coronary vasculature, allowing clinicians to evaluate the presence, extent, and severity of coronary artery disease.

The analysis and interpretation of medical images, particularly cardiac CT scans, involves complex processes that require substantial expertise and time. Radiologists and cardiologists must examine large volumes of image data to identify anatomical structures, detect pathological changes, and quantify disease parameters. This manual interpretation process can be subject to inter-observer variability, and may be influenced by factors such as image quality, artifacts, and the experience level of the interpreting physician.

Artificial intelligence and machine learning technologies have shown promise in augmenting medical image analysis workflows. These computational approaches can assist in automating various tasks such as image segmentation, feature extraction, and disease classification. However, developing robust AI models for medical imaging applications faces several challenges, including the need for large, diverse training datasets and the ability to handle variations in image acquisition parameters, patient anatomy, and disease presentations.

Generative artificial intelligence models represent a relatively new class of machine learning algorithms that can create synthetic data resembling real-world examples. These models have demonstrated capabilities in generating realistic images, text, and other forms of data across various domains. In the context of medical imaging, generative models offer potential applications in data augmentation, artifact removal, and simulation of disease progression.

Training effective machine learning models for medical imaging applications often requires extensive datasets that adequately represent the full spectrum of clinical scenarios. However, certain conditions, anatomical variations, or image artifacts may be underrepresented in available training data, potentially limiting model performance in these scenarios. Additionally, the acquisition of medical imaging data involves patient privacy considerations and regulatory requirements that can constrain data availability for research and development purposes.

The integration of multiple imaging modalities and clinical data sources presents both opportunities and challenges in developing comprehensive patient assessment tools. While multi-modal approaches can provide richer information for clinical decision-making, they also introduce complexity in data processing, alignment, and interpretation. Furthermore, the development of AI systems that can adapt to new patient data as it becomes available represents an area of ongoing research interest.

Quality control and standardization remain ongoing concerns in medical imaging workflows. Variations in imaging protocols, equipment specifications, and reconstruction parameters can affect image quality and consistency. These factors can impact both human interpretation and automated analysis systems, highlighting the need for robust approaches to handle such variations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to aspects of the current disclosure, systems and methods are disclosed for training a whole medical image foundation model.

In one embodiment, a computer implemented method is disclosed for training a whole medical image foundation model, including: receiving a plurality of medical image datasets; extracting local sections of image data from the plurality of medical image datasets; obtaining one or more causal variables associated with the local sections and/or patient; training one or more self-supervised learning models based on the local sections of image data and the causal variables; combining the one or more trained self-supervised learning models with a deep learning network configured to combine a latent representation of the local sections of image data from the one or more trained self-supervised learning models into a patient-level representation; and combining, with the one or more trained self-supervised learning models and the deep learning network, at least one further network or function configured to accept the patient-level representation as input, the at least one further network or function operable to perform one or more patient-specific prediction tasks.

In other aspects, the techniques described herein relate to a method, wherein the deep learning network may include at least one of: a Convolutional Neural Network, a Graph Convolutional Neural Network, a PointNet, or a Transformer architecture.

In other aspects, the techniques described herein relate to a method, wherein the medical image datasets may include coronary computed tomography angiography images.

In other aspects, the techniques described herein relate to a method, wherein a first self-supervised learning model may be trained using a portion of the local sections of image data corresponding to regions surrounding coronary arteries.

In other aspects, the techniques described herein relate to a method, wherein at least one further self-supervised learning model may be trained using a further portion of the local sections of image data corresponding to at least one other structure in the medical image datasets; and the at least one other structure comprises myocardium.

In other aspects, the techniques described herein relate to a method, wherein the prediction tasks may include at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.

In some aspects, the techniques described herein relate to a method, which may further include incorporating an unsupervised clustering loss function trained concurrently with the at least one further network or function, wherein the clustering loss function is configured to group patients into clusters with low intra-class variations and high inter-class variations.

In some aspects, the techniques described herein relate to a method, which may further include freezing networks used to obtain the patient-level representations; and training additional tasks using the patient-level representation.

In accordance with another embodiment, a system is disclosed for generating a whole medical image foundation model, the system including: at least one memory storing instructions; and at least one processor configured to execute the instructions to perform operations, including: receiving a plurality of medical image datasets; extracting local sections of image data from the plurality of medical image datasets; obtaining one or more causal variables associated with the local sections and/or patient; training one or more self-supervised learning models based on the local sections of image data and the causal variables; combining the one or more trained self-supervised learning models with a deep learning network configured to combine a latent representation of the local sections of image data from the one or more trained self-supervised learning models into a patient-level representation; and combining, with the one or more trained self-supervised learning models and the deep learning network, at least one further network or function configured to accept the patient-level representation as input, the at least one further network or function operable to perform one or more patient-specific prediction tasks.

In some aspects, the techniques described herein relate to a system, wherein the deep learning network may include at least one of: a Convolutional Neural Network, a Graph Convolutional Neural Network, a PointNet, or a Transformer architecture.

In some aspects the techniques described herein relate to a system, wherein the medical image datasets may include coronary computed tomography angiography images.

In some aspects, the techniques described herein relate to a system, wherein a first self-supervised learning model may be trained using a portion of the local sections of image data corresponding to regions surrounding coronary arteries.

In some aspects, the techniques described herein relate to a system wherein at least one further self-supervised learning model may be trained using a further portion of the local sections of image data corresponding to at least one other structure in the medical image datasets; and the at least one other structure may include myocardium.

In some aspects, the techniques described herein relate to a system wherein the prediction tasks may include at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.

In some aspects, the techniques described herein relate to a system which may further include an unsupervised clustering loss function trained concurrently with the at least one further network or function, wherein the clustering loss function is configured to group patients into clusters with low intra-class variations and high inter-class variations.

In some aspects, the techniques described herein relate to a system which may further include freezing networks used to obtain the patient-level representations; and training additional tasks using the patient-level representation.

In accordance with another embodiment, the techniques described herein relate to a non-transitory computer readable medium storing instructions that, when executed by a computer, may cause the computer to perform a method for method for training a whole medical image foundation model, including: receiving a plurality of medical image datasets; extracting local sections of image data from the plurality of medical image datasets; obtaining one or more causal variables associated with the local sections and/or patient; training one or more self-supervised learning models based on the local sections of image data and the causal variables; combining the one or more trained self-supervised learning models with a deep learning network configured to combine a latent representation of the local sections of image data from the one or more trained self-supervised learning models into a patient-level representation; and combining, with the one or more trained self-supervised learning models and the deep learning network, at least one further network or function configured to accept the patient-level representation as input, the at least one further network or function operable to perform one or more patient-specific prediction tasks.

In some aspects, the techniques described herein relate to a non-transitory computer-readable medium, wherein the deep learning network may include at least one of: a Convolutional Neural Network, a Graph Convolutional Neural Network, a PointNet, or a Transformer architecture.

In some aspects, the techniques described herein relate to a non-transitory computer-readable medium, wherein the method may further include wherein the medical image datasets comprise coronary computed tomography angiography images.

In some aspects, the techniques described herein relate to a non-transitory computer-readable medium, wherein the prediction tasks may include at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts a network system for predicting coronary lesion location and onset, according to some aspects of the current disclosure.

FIG. 2 depicts a flowchart of a method for processing CCTA image data using deep structural causal models, according to some aspects of the current disclosure.

FIG. 3 depicts a flowchart of a method for using CCTA foundation model, according to some aspects of the current disclosure.

FIG. 4 depicts a flowchart of a method for learning geometric priors from processed cases, according to some aspects of the current disclosure.

FIG. 5 depicts a flowchart of a method for generating synthetic outlier training samples, according to some aspects of the current disclosure.

FIG. 6 depicts a flowchart of a method for generating counterfactual medical images without unwanted artifacts, according to some aspects of the current disclosure.

FIG. 7 depicts a flowchart of a method for generating high resolution medical images from low resolution images, according to some aspects of the current disclosure.

FIG. 8 depicts a flowchart of a method for developing a model predicting disease progression and cardiac event risk, according to some aspects of the current disclosure.

FIG. 9 depicts a flowchart of a method for predicting disease progression and cardiac event risk, according to some aspects of the current disclosure.

FIG. 10 depicts a flowchart of a method for simulating interventions and predicting disease progression, according to some aspects of the current disclosure.

FIG. 11 depicts a flowchart of a method for optimizing percutaneous coronary interventions based on CCTA images, according to some aspects of the current disclosure.

FIG. 12 depicts a flowchart of a method for mapping CT or geometric models to clinically meaningful representations, according to some aspects of the current disclosure.

FIG. 13 depicts a flowchart of a method for training and using a multi-modal foundation model, according to some aspects of the current disclosure.

FIG. 14 depicts a flowchart of a method for learning spatial anatomical feature descriptors, according to some aspects of the current disclosure.

FIG. 15 depicts a flowchart of a method for predicting CCTA-derived metrics from lower-cost imaging modalities, according to some aspects of the current disclosure.

FIG. 16 depicts a flowchart of a method for utilizing learned models of cardiac motion, according to some aspects of the current disclosure.

FIG. 17 depicts a flowchart of a method for generating counterfactual images to revert anatomy-altering changes, according to some aspects of the current disclosure.

FIG. 18 depicts a flowchart of a method for generating and using personalized anatomical templates, according to some aspects of the current disclosure.

FIG. 19 depicts a flowchart of a method for generating full CT text reports for CCTA images, according to some aspects of the current disclosure.

FIG. 20 depicts a flowchart of a method for multi-modal report generation for cardiovascular disease, according to some aspects of the current disclosure.

FIG. 21 depicts a flowchart of a method for generating automatic rejection reports for CCTA images, according to some aspects of the current disclosure.

FIG. 22 depicts a flowchart of a method for interactive AI-supported case processing, according to some aspects of the current disclosure.

FIG. 23 depicts a flowchart of a method for implementing a speech or text-controlled medical imaging system, according to some aspects of the current disclosure.

FIG. 24 depicts a flowchart of a method for case retrieval using multi-modal data sources, according to some aspects of the current disclosure.

FIG. 25 depicts a flowchart of a method for using generative models to improve fairness across protected characteristics, according to some aspects of the current disclosure.

FIG. 26 depicts a flowchart of a method for using generative models to assess algorithmic bias, according to some aspects of the current disclosure.

FIG. 27 depicts a flowchart of a method for multi-modal biomarker discovery, according to some aspects of the current disclosure.

FIG. 28 depicts a flowchart of a method for watermarking and identifying generated images, according to some aspects of the current disclosure.

FIG. 29 depicts a flowchart of a method for using generative models to aid in CAD monitoring, according to some aspects of the current disclosure.

FIG. 30 depicts a flowchart of a method for generating and updating a digital twin model, according to some aspects of the current disclosure.

FIG. 31 depicts a flowchart of a method for modality translation and generation, according to some aspects of the current disclosure.

FIG. 32 depicts a flowchart of a method for fine-tuning a generative model, according to some aspects of the current disclosure.

FIG. 33 depicts a block diagram of a computer system, according to some aspects of the current disclosure.

### DETAILED DESCRIPTION

Reference will now be made in detail to the exemplary embodiments of the disclosure, examples of which are illustrated in the accompanying drawings. Techniques of these embodiments may be used interchangeably, as would be appreciated by a person of skill in the art. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flowchart, it should be understood that unless otherwise specified or required by context, any explicit or implicit ordering of steps performed in the execution of a method does not imply that those steps must be performed in the order presented, but instead may be performed in a different order or in parallel.

Techniques described in the current disclosure may utilize systems and methods described in U.S. application Ser. No. 19/255,328, U.S. application Ser. No. 15/975,197, and U.S. application Ser. No. 13/895,893, the disclosures of which are incorporated herein in their entireties.

As used herein, the term “exemplary” is used in the sense of “example,” rather than “ideal.” Moreover, the terms “a” and “an” herein do not denote a limitation of quantity but rather denote the presence of one or more of the referenced items.

Medical images may refer to any digital representation of anatomical structures or physiological functions obtained through various imaging technologies for diagnostic, therapeutic, or research purposes. These images can include two-dimensional slices, three-dimensional volumes, or time-series acquisitions that capture dynamic physiological processes. Medical images may include CCTA (Coronary Computed Tomography Angiography) datasets, which provide detailed visualization of coronary arteries, cardiac chambers, and surrounding structures with high spatial resolution. In some embodiments, the medical images may encompass other cardiac imaging modalities such as echocardiography, cardiac magnetic resonance imaging, nuclear perfusion studies, invasive coronary angiography, or intravascular ultrasound. The system can also process non-cardiac medical images including neurological imaging (brain MRI, CT scans), pulmonary imaging (chest radiographs, lung CT), abdominal imaging (liver ultrasound, abdominal CT), or musculoskeletal imaging (bone radiographs, joint MRI). In certain implementations, the medical images may be acquired using different scanner manufacturers, acquisition protocols, or reconstruction parameters, providing diversity in the training dataset.

Local pieces or sections of image data may refer to extracted subregions or patches from the complete medical image, e.g., that contain or correspond to specific anatomical structures or regions of interest.

Herein, figures may refer to machine learning training and clinical usage steps in a single workflow. However, in practice all of these steps may be performed by different parties at different times. For example, steps to train a machine learning algorithm may be performed by a technology company, and the trained algorithm may be used for research or clinical purposes months or years later by a medical practitioner or hospital network.

The models, systems, and methods described herein in a given modality may be used in part or in whole to implement other embodiments disclosed in this application. In some implementations, components from different embodiments may be combined or adapted to create hybrid systems that leverage multiple approaches simultaneously. For example, the deep structural causal models described for coronary artery analysis may be adapted for use in myocardial tissue analysis, or the generative models trained for artifact removal may be incorporated into disease progression prediction systems. The modular nature of the disclosed systems may enable flexible implementation where specific components can be selected and integrated based on particular clinical requirements or available computational resources. Additionally, the training methodologies and architectural principles described for one application may be extended to related medical imaging tasks, potentially reducing development time and improving performance through transfer learning approaches.

While some models and methods are described using coronary computed tomography angiography (CCTA) or other specific types of medical image data as exemplary implementations, it should be understood that any other types of medical image data may be used without departing from the scope of the disclosed systems and methods. The techniques described herein may be readily adapted for use with various imaging modalities including but not limited to cardiac magnetic resonance imaging (MRI), echocardiography, nuclear perfusion studies, positron emission tomography (PET), single-photon emission computed tomography (SPECT), ultrasound imaging, fluoroscopy, optical coherence tomography (OCT), intravascular ultrasound (IVUS), and other medical imaging technologies. In some embodiments, the systems may be configured to process multi-modal datasets that combine information from different imaging techniques, potentially providing enhanced diagnostic capabilities compared to single-modality approaches. The choice of specific imaging modalities in the examples provided is intended to illustrate the principles and capabilities of the disclosed systems rather than to limit their applicability to particular imaging technologies.

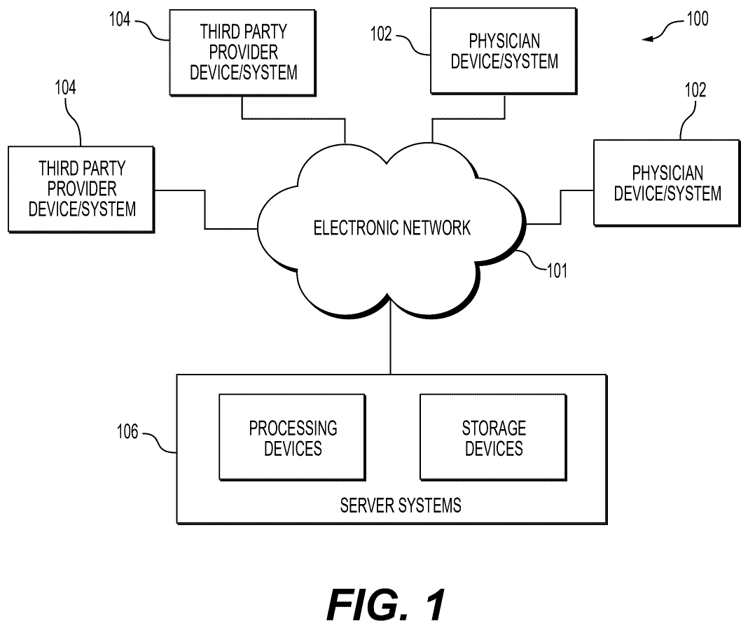

Referring now to the figures, FIG. 1 depicts a block diagram of an exemplary system and network for predicting the location, onset, and/or change of coronary lesions from vessel geometry, physiology, and hemodynamics. Specifically, FIG. 1 depicts a plurality of physician devices or systems 102 and third-party provider devices or systems 104, any of which may be connected to an electronic network 101, such as the Internet, through one or more computers, servers, and/or handheld mobile devices. Physicians and/or third-party providers associated with physician devices or systems 102 and/or third-party provider devices or systems 104, respectively, may create or otherwise obtain images of one or more patients' cardiac and/or vascular systems. The physicians and/or third-party providers may also obtain any combination of patient-specific information, such as age, medical history, blood pressure, blood viscosity, etc. Physicians and/or third-party providers may transmit the cardiac/vascular images and/or patient-specific information to server systems 106 over the electronic network 101. Server systems 106 may include storage devices for storing images and data received from physician devices or systems 102 and/or third-party provider devices or systems 104. Server systems 106 may also include processing devices for processing images and data stored in the storage devices

The following description sets forth exemplary aspects of the present disclosure. It should be recognized, however, that such description is not intended as a limitation on the scope of the present disclosure. Rather, the description also encompasses combinations and modifications to those exemplary aspects described herein.

Medical imaging technologies have become fundamental tools in modern healthcare, particularly for cardiovascular disease diagnosis and treatment planning. Traditional medical imaging systems rely on established computational methods to process and analyze medical image data, but these approaches may face limitations when dealing with complex or rare clinical scenarios. The integration of artificial intelligence (AI) technologies into medical imaging workflows has opened new possibilities for enhancing diagnostic accuracy and expanding the capabilities of medical imaging systems.

Generative artificial intelligence models represent a class of machine learning algorithms that can create new data samples based on patterns learned from training datasets. These models have shown promise in various applications, including the generation of synthetic medical images, the enhancement of existing medical image data, and the creation of counterfactual scenarios for treatment planning. In the context of cardiovascular imaging, generative AI models may be applied to coronary computed tomography angiography (CCTA) data and other cardiac imaging modalities to address challenges such as data scarcity, image quality limitations, and the need for personalized patient assessment.

The application of generative AI in cardiovascular imaging encompasses several technical domains. Synthetic medical image generation may help address the challenge of limited training data for rare clinical conditions or unusual anatomical presentations. Image enhancement and artifact removal techniques may improve the quality of medical images by reducing noise, correcting motion artifacts, or standardizing image appearance across different acquisition protocols. Multi-modal data integration approaches may combine information from different imaging modalities and clinical data sources to create comprehensive patient models that can inform clinical decision-making.

Generative models may also facilitate the development of digital twin technologies for cardiovascular applications. Digital twins represent computational models that simulate patient-specific anatomy and physiology based on available medical data. These models may be updated dynamically as new patient information becomes available, potentially improving the accuracy of diagnostic assessments and treatment recommendations. The integration of generative AI with digital twin technologies may enable more sophisticated modeling of disease progression, treatment outcomes, and patient-specific risk factors.

The technical implementation of generative AI systems for cardiovascular imaging involves various machine learning architectures and training methodologies. Deep structural causal models, variational autoencoders, generative adversarial networks, and diffusion models represent different approaches to generative modeling, each with specific advantages for different applications. These models may be trained on large datasets of medical images and associated clinical information to learn the underlying patterns and relationships that characterize cardiovascular anatomy and pathology. The training process may incorporate various forms of supervision, including labeled medical images, clinical outcomes data, and expert annotations of anatomical structures and disease features.

### Whole Image CCTA Foundation Model Training

Whole image CCTA foundation model training represents a comprehensive approach to learning generic descriptors from large datasets of medical imaging data such as coronary computed tomography angiography images that capture patient-level characteristics including disease state, acquisition parameters, and physiological conditions. The foundation model may generate patient-representation in the form of a vector of fixed length that contains information about patient characteristics, disease state, CT acquisition parameters, patient preparation protocols, and physiological conditions. This descriptor can then be utilized for various downstream machine learning tasks where limited annotated data may be available. The foundation model may serve as a basis for training downstream machine learning models where limited annotated data may be available, providing learned representations that capture fundamental patterns in CCTA data without requiring specific annotations for every potential application.

Traditional machine learning approaches for cardiac imaging analysis face significant challenges due to the requirement for large amounts of annotated data for each specific task, creating bottlenecks in developing robust clinical applications. Additionally, these conventional methods often fail to leverage the rich information contained across different aspects of CCTA images, resulting in siloed analyses that miss important cross-correlations between patient characteristics, imaging parameters, and disease manifestations. The whole image CCTA foundation model addresses these limitations by learning comprehensive representations from large datasets without task-specific annotations, enabling transfer learning to multiple downstream applications with minimal additional training data. This approach may reduce annotation burden, may improve generalization to rare conditions, and may allow for the discovery of novel relationships between imaging features and clinical outcomes that might otherwise remain undetected in traditional task-specific models.

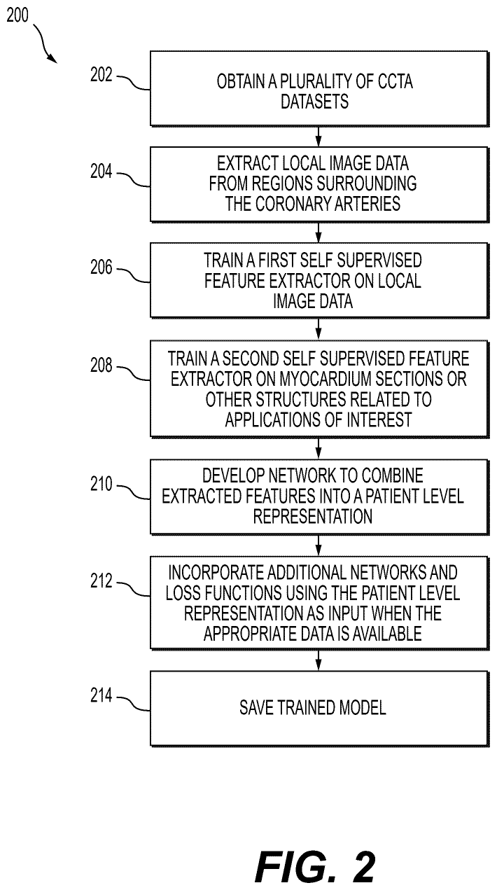

FIG. 2 depicts an exemplary method 200 of training a whole image CCTA foundation model. The training process may begin with, at step 202, obtaining imaging datasets, e.g., a plurality of CCTA datasets. At step 204, local sections of image data may be extracted from the plurality of imaging datasets. The local sections may correspond to a structure or region of interest represented in the imaging datasets. These sections or pieces can include volumetric patches centered on coronary vessels, two-dimensional cross-sections at specific locations, curved multiplanar reformatted segments following vessel centerlines, or other localized regions that capture clinically relevant features. The local sections may vary in size and shape depending on the specific anatomical structure being analyzed and can be extracted using automated algorithms that identify regions of interest based on anatomical landmarks, intensity patterns, or user-defined parameters. These sections can be extracted, for example, as stretches of curved planar reconstruction (CPR) data. In an example, the local sections may be associated with one or more regions surrounding coronary arteries, to myocardium, etc.

One or more causal variables associated with the local sections may be obtained. Examples of causal variables include, for example, anatomical structures, pathological conditions, image quality parameters, and acquisition-related factors. Anatomical structures may include vessel geometry, branching patterns, and spatial relationships between different coronary structures. Pathological conditions may include plaque characteristics, stenosis severity, and various disease manifestations that affect coronary artery appearance. Image quality parameters may include noise levels, contrast characteristics, and various artifacts that may affect image interpretation. Acquisition-related factors may include scanner parameters, reconstruction settings, and patient positioning factors that influence image appearance characteristics. The causal variable framework may enable the model to learn relationships between different factors that influence local image appearance, providing a comprehensive understanding of the factors that contribute to variations in CCTA image characteristics.

In step 206, a first self-supervised model may be trained using local sections of image data from the imaging datasets. For example, if CCTA datasets were used, the model may be trained using regions surrounding coronary arteries. This approach can include various embodiments described throughout the system framework. The model training may incorporate all available causal variables that characterize the local image features.

In step 208, a second self-supervised feature extractor or generative model may be trained on myocardium sections or other structures related to applications of interest, providing additional anatomical context for the foundation model. However, it should be understood that the number of models trained and the particular sections of the image data used to do so may vary in different embodiments, e.g., based on available data, for different applications of interest, etc.

Such a multi-structure approach may enable the foundation model to capture information about cardiac anatomy and pathology beyond the coronary arteries, providing a more complete representation of cardiovascular health status that may be relevant for various clinical prediction tasks.

Different types of self-supervised models may be used for training. In some instances, encoder-decoder type feature extractors may provide comprehensive capabilities for learning representations from medical imaging data through architectures that can both encode input images into latent representations and decode these representations back into image space. Variational Autoencoders (VAEs) may learn probabilistic latent representations that capture uncertainty in the underlying data distribution, potentially enabling robust feature extraction from medical images with varying quality characteristics. Hierarchical Variational Autoencoders (HVAEs) may extend this approach by learning multi-scale representations that can capture both fine-grained anatomical details and broader structural patterns within cardiovascular imaging data. Vector Quantized Variational Autoencoders (VQ-VAE) may provide discrete latent representations that can facilitate more interpretable feature learning, while U-Net architectures may offer specialized capabilities for medical image analysis through their skip connections that preserve spatial information across different resolution levels. Swin-UNETR models may combine the benefits of transformer-based attention mechanisms with U-Net-style architectures, potentially enabling more effective processing of three-dimensional medical imaging volumes such as CCTA datasets.

In other instances, encoder type feature extractors may focus on learning compact representations from input medical images without requiring reconstruction capabilities, potentially offering computational efficiency advantages for downstream prediction tasks. ResNet architectures may provide robust feature extraction through residual connections that enable training of deep networks capable of capturing complex anatomical patterns in cardiovascular imaging data. ConvNeXt models may offer modernized convolutional approaches that incorporate design principles from vision transformers while maintaining the computational efficiency of convolutional operations. Vision Transformer architectures may enable global attention mechanisms that can capture long-range dependencies within medical images, potentially identifying relationships between distant anatomical structures that may be relevant for cardiovascular assessment. Swin Transformers may provide hierarchical attention mechanisms that can process images at multiple scales, while self-supervised approaches such as IJEPA and DINO may enable learning of meaningful representations from unlabeled medical imaging data through predictive and contrastive objectives.

In some instances, training objectives for foundation models may incorporate various loss functions designed to encourage learning of clinically relevant representations from medical imaging data. Masked image modeling approaches may train models to predict missing portions of input images, potentially enabling robust feature learning that can handle artifacts or incomplete data commonly encountered in clinical imaging scenarios. Contrastive learning objectives may encourage the model to learn representations that bring similar anatomical structures closer together in feature space while pushing dissimilar structures apart, potentially improving the discriminative capabilities of learned features for various cardiovascular assessment tasks. Invariant feature learning approaches may train models to extract representations that remain consistent across different imaging conditions, acquisition parameters, or patient positioning variations, potentially improving the generalizability of foundation models across diverse clinical settings. KL-divergence losses for VAE models may regularize the learned latent representations to follow specified probability distributions, potentially enabling controlled generation of synthetic medical images and improved uncertainty quantification in downstream applications.

In other instances, Deep Structural Causal Models (DSCM) s may enable explicit modeling of causal relationships between various factors that influence medical image appearance and clinical outcomes through directed acyclic graph structures that represent dependencies between different variables. These models may incorporate causal variables such as patient demographics, disease characteristics, imaging acquisition parameters, and treatment interventions as explicit components of the generative process, potentially enabling more interpretable and controllable image generation compared to traditional approaches. The causal framework may allow for systematic manipulation of specific variables while maintaining consistency with underlying physiological and pathological processes, potentially supporting counterfactual analysis and intervention simulation applications. Foundation models may also be trained using feature extractors that process only image data without explicit causal variable modeling, potentially offering simpler implementation approaches that can still capture meaningful patterns in medical imaging data through purely data-driven learning objectives that leverage the inherent structure and relationships present in large-scale cardiovascular imaging datasets.

In step 210, the system may add or use an additional network, e.g., a deep neural network, that combines the extracted features of the separate sections (from the one or more self-supervised models) into a patient-level representation. Several network architectures can be suitable for this purpose, including but not limited to: Graph Convolutional Neural Networks (GNNs); PointNet and its variants; and Transformer architectures. GNNs may be employed to process the spatial relationships between different anatomical regions and integrate information from multiple local image sections into coherent patient-level representations. The graph structure may represent the anatomical connectivity between different coronary segments and cardiac structures, enabling the network to learn how local pathological changes in different regions contribute to overall patient risk and disease characteristics. Transformer architectures may provide alternative approaches for combining local image representations into patient-level descriptors. The transformer-based approach may treat each local image section as a token in a sequence, enabling the attention mechanisms within the transformer to learn relationships between different anatomical regions and their relative importance for different clinical applications. The self-attention mechanisms may enable the model to identify complex patterns and interactions between different parts of the cardiac anatomy that may not be captured by traditional spatial relationship modeling approaches. The PointNet architectures and variants may offer additional approaches for aggregating local image representations into patient-level descriptors. The PointNet-based approach may treat each local image section as a point in a high-dimensional feature space, enabling the network to learn permutation-invariant representations that capture patient-level characteristics regardless of the specific ordering or sampling of local image sections. The PointNet approach may be particularly suitable for applications where the number and spatial distribution of local image sections may vary between different patients or imaging protocols.

The training process may then incorporate, in step 212, additional networks and/or loss functions that use the patient-level representation as input. Different networks may then be utilized when appropriate training data is available. These networks may be designed to perform various prediction tasks, such as: Predicting if the patient may experience a cardiovascular event (and potentially when); Identifying whether a patient has conditions such as hypertension, hyperlipidemia, diabetes, or other forms of disease; Recognizing the CT vendor, scanner type, and acquisition method used for the imaging study; Determining patient preparation factors (such as nitrate administration); Estimating microvascular resistance reserve (MRR) values; Predicting demographic characteristics such as the age or sex of the patient; Assessing whether the image quality is sufficient for Fractional Flow Reserve Computed Tomography (FFRct) analysis.

In some embodiments, the patient-level system may also be enhanced with an unsupervised clustering loss function, which can be trained concurrently with other loss functions. The unsupervised clustering loss function may aim to identify meaningful patient groupings based on learned representations. This clustering approach may group patients into clusters with low intra-class variations (where patient-level descriptors within each cluster are similar to each other) and high inter-class variations (where the difference between average descriptors across clusters is substantial). The clustering approach may enable the model to discover relevant patient subgroups and disease phenotypes that may be useful for downstream clinical applications such as risk stratification and treatment planning.

At step 214, the trained foundational model may be saved to memory or other storage.

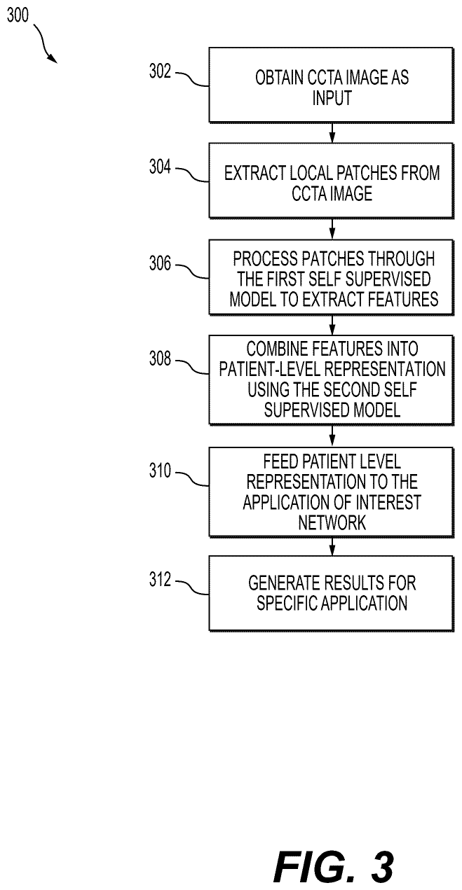

The foundation model described above may be utilized for cardiovascular assessment, disease characterization, and clinical decision support across various healthcare settings. FIG. 3 illustrates exemplary method 300 for using the whole image CCTA foundational model. In step 302, the system may obtain imaging data, e.g., a CCTA image or a different type of image as input. The system can process various types of medical imaging data, including but not limited to CCTA images, cardiac magnetic resonance images, or other cardiovascular imaging modalities.

In step 304, the system may extract local patches from the imaging data for processing. The extraction of local patches may involve identifying regions of interest within the imaging data that contain relevant cardiovascular structures such as coronary arteries, cardiac chambers, or myocardial tissue. These patches may be extracted using various techniques including but not limited to sliding window approaches, anatomical landmark-based selection, or attention-guided sampling methods. The system can extract patches of various sizes and resolutions depending on the specific anatomical structures being analyzed and the computational requirements of subsequent processing steps. In some embodiments, the patch extraction process may incorporate prior knowledge of cardiac anatomy to focus on clinically relevant regions while in other implementations, the system may utilize a more comprehensive sampling approach to capture the full extent of cardiovascular structures.

In step 306, the system may process these patches through one or more self-supervised models to extract features. The model(s) may, for example, analyze each extracted patch to identify and quantify various anatomical and pathological features present in the cardiovascular structures. The extracted features may include information about vessel geometry, plaque characteristics, myocardial texture, chamber morphology, and other clinically relevant attributes. In some implementations, the DSCM network model(s) may incorporate causal reasoning capabilities that enable it to distinguish between different factors influencing the observed imaging patterns, potentially providing more robust and interpretable feature representations compared to conventional neural networks.

In step 308, the system may combine these features into a patient-level representation using a deep learning network. The patient-level representation may encode comprehensive information about the patient's cardiovascular status, including global cardiac structure, coronary artery disease burden, functional parameters, and risk factors derived from the imaging data. In some embodiments, the deep learning network may incorporate attention mechanisms that assign different weights to various patches based on their clinical relevance or diagnostic value, potentially enhancing the system's ability to focus on the most informative regions of the cardiovascular anatomy.

In step 310, the system may feed the patient-level representation through at least one further network or function for an application of interest to generate results. This application-specific network or function may be operable to perform various clinical tasks such as disease classification, risk prediction, treatment planning, or other cardiovascular assessments based on the comprehensive patient-level representation. The network architecture may include fully connected layers, decision trees, or other machine learning components that transform the patient-level features into clinically actionable outputs.

In step 312, the system may generate results for the application of interest. The generated results may include diagnostic classifications, risk scores, treatment recommendations, or other clinical metrics depending on the specific application. In some implementations, the application network may generate confidence scores or uncertainty estimates alongside the primary results, providing clinicians with information about the reliability of the system's assessments for individual patients.

In some embodiments, the networks used to obtain the patient-level representations may be frozen, and additional tasks may be trained using this representation. This transfer learning approach can enable efficient development of new clinical applications without requiring retraining of the entire foundation model. By freezing the weights of the feature extraction and patient-level representation networks, the system can maintain the knowledge learned from large datasets while allowing specialized task-specific networks to be trained using smaller, task-specific datasets. This approach may be used for developing applications for rare conditions or specialized clinical scenarios where limited training data is available. The frozen patient-level representations can serve as input features for various downstream tasks including but not limited to disease subtype classification, treatment response prediction, prognosis estimation, or other specialized clinical assessments that build upon the comprehensive cardiovascular information encoded in the foundation model.

The foundation model may have different downstream applications across various clinical and research contexts. In one embodiment, the system may create digital fingerprints of patients to identify CT datasets in large collections that are from the same patient. These digital fingerprints can be generated using distinctive anatomical features, imaging characteristics, and patient-specific patterns extracted from the foundation model's representation space. The fingerprinting methodology may utilize various feature extraction techniques including geometric landmarks, vascular topology patterns, and tissue density distributions that remain consistent across different imaging sessions for the same individual. The patient identification capability may support longitudinal studies, retrospective analyses, and quality assurance processes by enabling automatic linking of multiple examinations from the same patient even when metadata connections are incomplete or unavailable.

The system may identify if a CT dataset is acquired with a method (e.g., scanner manufacturer/type, reconstruction kernel) not present in the training dataset. This identification capability can utilize statistical analysis of image characteristics, texture patterns, noise distributions, and other technical parameters that differ between various acquisition protocols and equipment configurations. The system may employ unsupervised anomaly detection algorithms, distribution comparison techniques, or specialized classifiers trained to recognize the distinctive signatures of different imaging equipment and reconstruction approaches. In some implementations, the system can categorize datasets according to their acquisition characteristics and provide confidence scores regarding the similarity to known acquisition methods in the training data. The system may potentially use this identification capability to flag incoming datasets that may need additional Quality Control (QC). When datasets with unfamiliar acquisition characteristics are detected, the system may trigger specialized processing pipelines, alert clinical staff, or apply adaptive analysis parameters to accommodate the novel imaging characteristics. The flagging mechanism may incorporate various levels of notification based on the degree of deviation from known acquisition patterns, ranging from informational alerts for minor variations to priority warnings for significant deviations that might affect diagnostic accuracy. In some embodiments, the system may suggest specific quality control procedures tailored to the particular acquisition characteristics identified, potentially improving workflow efficiency by focusing quality assurance efforts on the most relevant aspects of unfamiliar datasets.

In an example, the foundation training model may be used to predict how old a patient's heart or other anatomy appears compared to the actual age of the patient. This biological age assessment can analyze multiple cardiac features, including coronary artery calcification patterns, vessel wall characteristics, myocardial tissue properties, chamber dimensions, and functional parameters that typically change with aging. The biological age prediction may utilize regression models, deep learning approaches, or ensemble methods that have been trained on large populations with diverse age distributions and health statuses. In certain implementations, the system may generate separate age estimates for different cardiac structures or systems, potentially identifying specific aspects of cardiac aging that deviate most significantly from chronological expectations. The system may use this age comparison information for risk prediction purposes across various cardiovascular conditions and outcomes. The difference between biological and chronological age may serve as a comprehensive biomarker that integrates multiple aspects of cardiovascular health into a single interpretable metric. In some embodiments, the system may stratify patients into risk categories based on the magnitude and direction of age discrepancies, with accelerated cardiac aging potentially indicating elevated risk for adverse events. The age comparison data may be incorporated into multivariate risk models alongside traditional clinical factors, potentially improving predictive accuracy by capturing subclinical changes not reflected in conventional risk assessments. Additionally, the system may track changes in biological age estimates over time to evaluate treatment responses or disease progression rates.

The foundation training model may be used to predict severity of conditions such as hypertension, hyperlipidemia, diabetes or other forms of disease beyond merely detecting their presence. These severity assessments may include analysis of imaging biomarkers that correlate with disease progression, including vascular remodeling patterns, tissue density changes, fat distribution characteristics, and functional parameters affected by these conditions. For hypertension severity, the system may evaluate aortic dimensions, left ventricular mass, and coronary artery characteristics that reflect chronic pressure effects. In hyperlipidemia assessment, the system may analyze plaque composition, distribution patterns, and pericoronary fat attenuation indices that correlate with lipid metabolism abnormalities. Diabetes severity estimation may incorporate analysis of microvascular patterns, tissue perfusion characteristics, and myocardial texture features that reflect glycemic control effects on cardiac structures. The system may potentially use these severity predictions for risk assessment across different timeframes and outcome categories. The quantitative severity metrics may provide more granular risk stratification compared to binary disease presence indicators, potentially enabling more personalized treatment planning and monitoring strategies. In some implementations, the system may generate risk trajectories based on different severity levels, illustrating how varying degrees of disease control might affect long-term outcomes. The severity assessments may be combined with other patient-specific factors to create comprehensive risk profiles that account for interactions between multiple conditions and their respective severities. Additionally, the system may monitor changes in predicted severity over time to evaluate treatment efficacy or disease progression rates, potentially supporting clinical decisions regarding therapy adjustments or intervention timing.

The foundation training model may be used to predict microvascular resistance and may use that information to diagnose Coronary Microvascular Dysfunction (CMD) and improve the accuracy of FFRct analysis. The microvascular resistance prediction may utilize various imaging features including myocardial perfusion patterns, coronary flow characteristics, tissue attenuation dynamics, and structural markers that correlate with microcirculatory function. The prediction models may incorporate machine learning algorithms trained on datasets that include invasive physiological measurements, allowing the system to estimate parameters that cannot be directly visualized in CT images. In some embodiments, the system may generate spatial maps of predicted microvascular resistance throughout the myocardium, potentially identifying regional variations in microcirculatory function that may have diagnostic significance. The CMD diagnosis capability may integrate these resistance predictions with other clinical and imaging parameters to classify patients according to established diagnostic criteria or novel data-driven phenotypes of microvascular disease. The system may potentially use this microvascular information for risk prediction across various cardiovascular outcomes and patient populations. Microvascular dysfunction can contribute to adverse events independently of epicardial coronary disease, and incorporating this information may enhance risk assessment particularly for patients with non-obstructive coronary artery disease or atypical symptoms. In some implementations, the system may analyze patterns of microvascular dysfunction in relation to myocardial territories and coronary supply regions to estimate the functional impact on cardiac performance and reserve capacity. The microvascular assessment may be particularly valuable for specific patient subgroups including women, diabetic patients, and those with systemic inflammatory conditions where microvascular pathology often plays a prominent role in cardiovascular manifestations. Additionally, the system can track changes in predicted microvascular function over time to evaluate treatment responses or disease progression patterns, potentially supporting clinical decisions regarding therapy selection or modification.

The foundation training model may be used to automatically evaluate whether an image is suitable for FFRct analysis based on multiple quality parameters and technical characteristics. This suitability assessment may include analysis of image resolution, contrast opacification, motion artifacts, noise levels, anatomical coverage, and other factors that influence the accuracy and reliability of computational fluid dynamics simulations. The evaluation process may utilize specialized algorithms trained to recognize image quality patterns that correlate with successful FFRct analysis outcomes, potentially reducing unnecessary processing attempts for suboptimal datasets. In some embodiments, the system may provide quantitative quality scores for different aspects of image suitability, identifying specific limitations that might be addressed through alternative analysis approaches or acquisition improvements. The suitability determination may incorporate patient-specific anatomical factors alongside technical image parameters, recognizing that certain coronary configurations or disease patterns may present additional challenges for FFRct computation regardless of image quality.

The foundation training model may be used for coronary disease assessment using a CCTA image or for non-coronary disease visible in a CCTA image (including overall cardiac structures, myocardium, lungs, liver, etc.). The comprehensive analysis capabilities may, in embodiments, extend beyond the coronary arteries to evaluate cardiac chambers, valvular structures, pericardium, great vessels, and adjacent thoracic organs captured within the imaging field. For cardiac structure assessment, the system may analyze chamber dimensions, wall thickness patterns, and spatial relationships that can indicate cardiomyopathies, congenital abnormalities, or remodeling processes. Myocardial analysis may include tissue characterization, perfusion assessment, and functional parameter estimation that can identify scarring, inflammation, or infiltrative processes. In some embodiments, the system may evaluate pulmonary structures for signs of hypertension, parenchymal disease, or vascular abnormalities that may relate to cardiopulmonary interactions. The hepatic and other extracardiac tissue analysis may identify incidental findings or systemic conditions that affect cardiovascular health.

In some embodiments, the system may also be applied to other types of medical images including cardiac magnetic resonance, echocardiography, nuclear perfusion studies, or hybrid imaging modalities, potentially leveraging transfer learning approaches to adapt the foundation model capabilities across different imaging techniques while maintaining the comprehensive assessment framework.

Learning Geometric Priors from Processed Cases to Use During Modeling

Learning geometric priors from processed cases may enable the development of machine learning systems that are configured to generate anatomically plausible models for cardiovascular analysis. These systems may leverage existing processed data to learn distributions of anatomical structures and pathological features, potentially improving the accuracy and efficiency of cardiovascular modeling processes. The following paragraphs describe methodologies for generating machine learning systems that are configured to learn and apply geometric priors derived from processed cardiovascular imaging data.

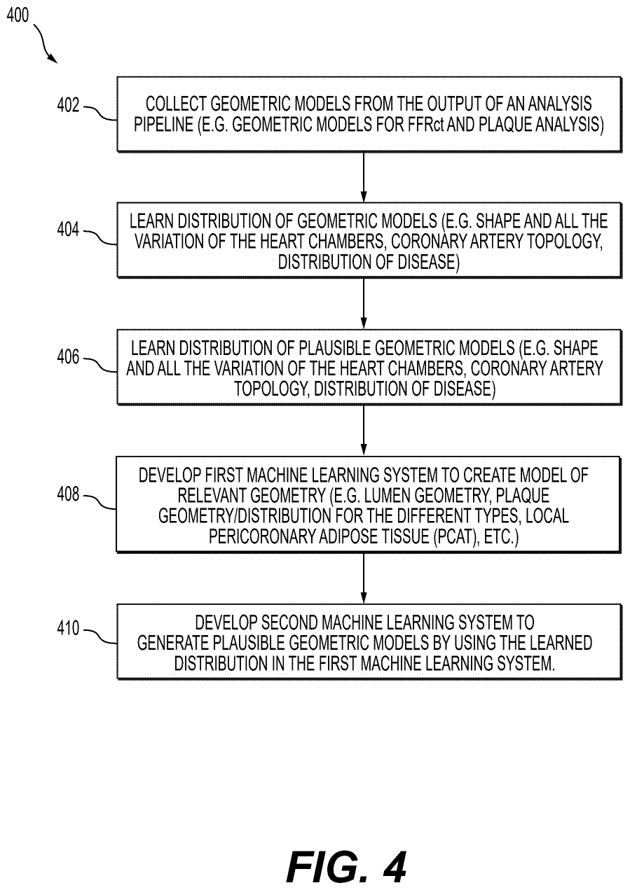

FIG. 4 depicts an exemplary process for training a model and learning geometric priors from processed cases. In some embodiments, the training process may begin with collecting geometric models from the output of an analysis pipeline, as shown in step 402. These geometric models may include various representations such as those generated for Fractional Flow Reserve computed tomography (FFRct) and plaque analysis. The collection process may involve aggregating models from multiple sources, potentially including clinical databases, research repositories, and existing analytical systems. The geometric models may represent various cardiovascular structures with different levels of detail and may serve as the basis for subsequent learning steps in the training process.

The training process may continue with learning the distribution of these collected geometric models in step 404. This learning step may encompass various anatomical and pathological characteristics including the shape and variations of heart chambers, coronary artery topology, distribution patterns of disease, and other relevant cardiovascular features. The distribution learning may involve statistical analysis of geometric variations, identification of common patterns and outliers, and characterization of relationships between different anatomical components. This step may establish a mathematical/statistical representation of the range of normal and pathological variations that can occur in cardiovascular structures across different patient populations.

The training methodology may then utilize a foundation model (e.g. the model described in FIGS. 2 and 3) to learn the distribution of clinically plausible geometric models in step 406. This step may leverage the patient-level representations and feature extraction capabilities of the previously trained one or more DSCMs to identify patterns that characterize anatomically and pathologically plausible cardiovascular structures. The foundation model may provide contextual understanding of how different geometric features relate to patient characteristics, disease states, and clinical outcomes, enabling more sophisticated learning of geometric plausibility compared to approaches that consider geometry in isolation from clinical context.

Using the learned descriptors, the training process may involve developing a decoder that may be trained to create a first machine learning model of the relevant geometry in step 408.

This model may represent various cardiovascular structures including lumen geometry, plaque geometry and distribution for different plaque types, local peri-coronary adipose tissue characteristics, and other anatomical features relevant to cardiovascular assessment. The decoder training may involve learning to generate detailed geometric representations from compact feature descriptors, potentially utilizing various deep learning architectures such as convolutional networks, graph neural networks, or transformer-based models depending on the specific geometric structures being modeled.

The training process may culminate in developing a second machine learning system, in step 410, that may utilize the first model and may generate geometric models constrained by the learned distribution of plausible structures. This system may incorporate various regularization techniques, constraint mechanisms, or adversarial components that encourage the generation of anatomically realistic and clinically plausible geometric models. The second machine learning system may be designed to balance adherence to image evidence with conformity to learned anatomical constraints, potentially enabling more robust geometric modeling in cases where image quality limitations might otherwise compromise extraction accuracy. The resulting system may be configured to generate geometric models that exhibit anatomically realistic characteristics even when processing challenging images affected by noise, artifacts, or limited resolution.

One application of this approach may involve learning “plaque priors” across the entire coronary anatomy to help improve performance in segmentation tasks. The system may utilize contextual information about plaque distribution patterns to enhance segmentation accuracy in challenging imaging regions. For example, isolated plaque findings in distal, noisy vessels may be assigned lower probability scores when they appear without corresponding proximal disease, whereas similar distal findings may be considered more plausible when they occur in patients with extensive proximal plaque and large volumes of diffuse disease. This contextual assessment may enable more accurate plaque detection by incorporating anatomical knowledge about typical disease distribution patterns into the segmentation process. The plaque prior application may be particularly valuable for improving segmentation reliability in image regions affected by noise, motion artifacts, or limited spatial resolution where direct image evidence may be ambiguous.

The system may utilize the second machine learning model to extract geometric shapes from CCTA images through a multi-stage process that leverages learned priors to guide the extraction procedure. The extraction process may begin with initial detection of anatomical structures using image processing techniques or neural network approaches trained for structure localization. The extraction results may include three-dimensional models of coronary lumen geometry, plaque distributions, and/or other anatomical structures relevant for cardiovascular assessment and treatment planning. Following detection, the system may apply the learned geometric priors to refine the initial shape estimates, adjusting boundary positions and surface characteristics to align with plausible anatomical configurations based on the learned distribution. The refinement process may involve iterative optimization procedures that balance adherence to image evidence with conformity to learned shape distributions, potentially enabling more accurate geometric extraction in regions where image quality limitations might otherwise compromise extraction accuracy.

The outputs generated by the system may be more plausible because they incorporate learned distributions of anatomical shapes and pathological patterns derived from large datasets of clinical examples. By constraining the geometric extraction and generation processes to conform to these learned distributions, the system may produce results that exhibit anatomically realistic characteristics even when processing challenging images affected by noise, artifacts, or limited resolution. The plausibility enhancement may be particularly valuable in clinical scenarios where traditional image processing approaches might generate implausible results due to image quality limitations or anatomical ambiguities. The incorporation of learned priors may enable the system to generate complete and anatomically consistent geometric models even when portions of the input data contain limited or ambiguous information, potentially improving the reliability and clinical utility of the extracted geometric representations for various cardiovascular applications including disease assessment and treatment planning.

### Creation and Use of Outlier Training Samples

In medical imaging analysis, the effectiveness of machine learning models may be limited by the uneven distribution of data across different clinical scenarios. Rare anatomical variations, unusual disease presentations, image data from new scanners, and uncommon image artifacts, among other things, are often underrepresented in training datasets, which can lead to suboptimal performance when these situations are encountered in clinical practice. This underrepresentation may result in models that perform well on common cases but fail to accurately analyze edge cases that, while infrequent, may have significant clinical implications. The generation of synthetic outlier images or samples using generative artificial intelligence models may help address this limitation by augmenting training datasets with realistic examples of rare conditions, anatomical variations, and imaging artifacts. By creating additional samples that represent these underrepresented scenarios, machine learning models may be trained on more comprehensive datasets that better reflect the full spectrum of clinical variability, potentially improving their robustness and diagnostic accuracy across diverse patient populations and imaging conditions.

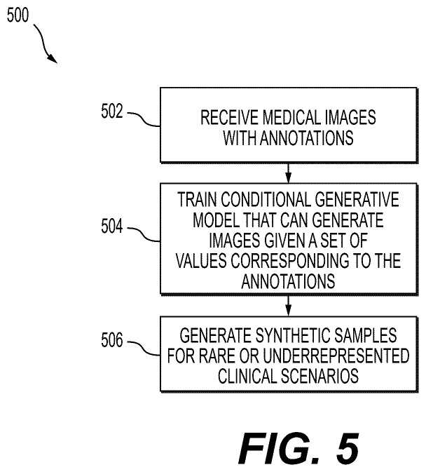

FIG. 5 depicts an exemplary method 500 for creating synthetic outlier images or samples. The method begins with step 502, with receiving medical images with annotation. Medical images may refer to any digital representation of anatomical structures or physiological functions obtained through various imaging technologies for diagnostic, therapeutic, or research purposes. These images may include two-dimensional slices, three-dimensional volumes, or time-series acquisitions that capture dynamic physiological processes. Medical images may include CCTA (Coronary Computed Tomography Angiography) datasets, which provide detailed visualization of coronary arteries, cardiac chambers, and surrounding structures with high spatial resolution. In some embodiments, the medical images may encompass other cardiac imaging modalities such as echocardiography, cardiac magnetic resonance imaging, nuclear perfusion studies, invasive coronary angiography, or intravascular ultrasound. The system, in embodiments, may also process non-cardiac medical images including neurological imaging (brain MRI, CT scans), pulmonary imaging (chest radiographs, lung CT), abdominal imaging (liver ultrasound, abdominal CT), or musculoskeletal imaging (bone radiographs, joint MRI). In certain implementations, the medical images may be acquired using different scanner manufacturers, acquisition protocols, or reconstruction parameters, providing diversity in the training dataset.

Annotations may be included with the medical images at the time of acquisition or may be added during subsequent processing stages. These annotations may be associated with various aspects of the image data. Examples of annotations include: presence, type, and extent of disease, including cardiovascular diseases such as coronary artery stenosis, plaque characteristics, myocardial abnormalities, or valvular pathologies; presence, type, and extent of image artifacts including motion artifacts, blooming artifacts, streak artifacts, or noise patterns that might affect image interpretation; description of the anatomical location in the patient including specific coronary segments, cardiac chambers, or adjacent anatomical structures; quantitative measurements such as vessel diameters, stenosis percentages, calcium scores, or ejection fraction values; image quality assessments that rate factors such as contrast opacification, motion control, or noise levels; technical acquisition parameters including scanner type, reconstruction kernel, or slice thickness; patient-specific factors such as heart rate during acquisition, presence of stents or other implanted devices, or administration of medications like beta-blockers or nitrates; and radiologist observations or diagnostic impressions that may guide subsequent clinical decision-making. In some embodiments, annotations might also include temporal information when comparing current images with prior studies, highlighting changes in disease progression or treatment response. The annotation process may be performed manually by clinical experts, semi-automatically with human verification, or in certain cases, fully automatically using machine learning algorithms trained to identify specific features or conditions.

Referring to FIG. 5, the method continues with training a conditional generative model, in step 504, that is configured to generate images given a set of values corresponding to the annotated features. A conditional generative model may refer to a machine learning system that generates synthetic data samples based on specified input conditions or control parameters. The conditional generative model may be trained to learn to produce outputs that exhibit specific characteristics defined by the conditioning variables, enabling controlled synthesis of data with desired properties. A conditioning process may involve providing the model with additional input information such as class labels, feature vectors, or other descriptive parameters that guide the generation process toward producing outputs with particular attributes. The medical images dataset may undergo pre-processing steps such as intensity and/or spatial normalization, artifact reduction, or quality assessment to enhance the subsequent feature learning process.

The conditional generative model may be implemented as a DSCM that learns relationships between input annotations and corresponding image characteristics. This model architecture may enable the generation of synthetic medical images in the form of counterfactuals that exhibit specific features defined by conditional input parameters, allowing for controlled counterfactual image synthesis based on desired anatomical structures, pathological conditions, or imaging characteristics. The DSCM may incorporate causal relationships between variables, enabling it to understand how different input parameters influence various aspects of the generated images. During training, the model learns to map from a latent space to the image space while conditioning on causal variables, creating a framework that can generate diverse yet realistic medical images that conform to specified conditions. The generation process for a DSCM typically involves selecting a real input image with its associated causal variables, and updating one or more of the causal variable values, where a decoding process transforms the selected input image according to the modified causal variables to produce a counterfactual medical image. An alternative usage of the DSCM is to generate synthetic medical images entirely from sampling the latent space, bypassing the encoder and removing the need for an input image from the training set. These approaches may enable the creation of synthetic training examples with precise control over clinically relevant features, allowing for the generation of rare pathological presentations, unusual anatomical configurations, or specific image quality characteristics that may be underrepresented in available training datasets.

In some embodiments, the training method may include human feedback. The system may incorporate human feedback by presenting generated samples to human raters who evaluate various aspects of image quality, including anatomical plausibility, pathological accuracy, and overall visual realism. The human rating process may involve medical imaging experts such as radiologists or cardiologists who possess domain-specific knowledge necessary to assess the clinical validity of synthetic medical images. In some embodiments, raters might score images on multiple dimensions including anatomical accuracy, pathological representation, image quality characteristics, and artifact presence. These ratings may then be incorporated into the training process as additional loss terms or weighting factors that guide the generative model toward producing more realistic and clinically valid outputs. The system may implement this human-in-the-loop approach for random samples to establish baseline quality assessments or for specific samples that represent challenging cases, rare conditions, or edge scenarios where algorithmic evaluation alone may be insufficient to ensure clinical validity.

In other embodiments, active learning techniques may be used for selecting the specific samples that would benefit most from human evaluation, thereby optimizing the efficiency and effectiveness of human rating efforts. Uncertainty sampling approaches may identify generated images where the model exhibits low confidence or high prediction variance, potentially indicating cases where human feedback would be particularly valuable for model improvement. Diversity sampling methods might select images that represent different anatomical regions, pathological conditions, or image quality characteristics to ensure comprehensive coverage across the range of possible outputs. Query-by-committee techniques may utilize multiple model variants or evaluation metrics to identify samples where different assessment approaches yield inconsistent results, highlighting cases where human judgment could resolve ambiguities. The active learning process may operate iteratively, with each round of human feedback informing model updates that generate new samples for subsequent evaluation. This iterative refinement approach may progressively improve model performance while minimizing the total human rating effort required. In some embodiments, the system might implement adaptive sampling strategies that dynamically adjust selection criteria based on observed model improvements and remaining performance gaps, focusing human evaluation efforts on areas where the model continues to struggle or where clinical accuracy is particularly critical.

Still referring to FIG. 5, in step 506, the trained conditional generative model may be utilized to generate synthetic samples representing outliers, rare, or underrepresented clinical scenarios. In some embodiments, the model may generate images exhibiting specific quality limitations (low image quality) such as motion artifacts, noise patterns, or contrast variations that are infrequently encountered in standard datasets. The system may also produce synthetic images depicting specific anatomical variations including unusual coronary branching patterns, vessel anomalies, or atypical chamber configurations that may be challenging to collect in sufficient quantities through conventional means. Additionally, the model may generate representations of rare pathological conditions such as congenital coronary anomalies, uncommon plaque morphologies, or infrequent disease manifestations that typically comprise a small fraction of clinical datasets. Further, the model may generate synthetic images with uncommon artifacts, image quality issues such as low resolution, missing or corrupted portions, etc.

The generated outlier samples (synthetic images) may serve multiple purposes in clinical and research applications. For example, these synthetic images may be utilized to complement training datasets for various downstream applications such as lumen segmentation, plaque characterization, or vessel centerline extraction algorithms. In scenarios where certain pathological conditions or anatomical variations occur infrequently in available training data, the synthetic outlier samples may provide additional examples that help machine learning models learn more robust representations of these rare cases. This enhanced training may lead to improved algorithm performance when encountering similar rare conditions in clinical practice, potentially reducing diagnostic errors and improving patient care outcomes.

The generation of synthetic outlier samples may function as a form of data augmentation that extends beyond traditional techniques such as rotation, scaling, or intensity adjustments. Unlike conventional augmentation methods that create variations of existing samples, the generative approach may produce entirely new examples that represent clinically plausible scenarios not present in the original dataset. This capability may be particularly valuable for addressing class imbalance issues in medical imaging datasets, where normal anatomical presentations typically outnumber pathological cases. By generating additional examples of underrepresented conditions such as complex coronary anomalies, unusual plaque morphologies, or rare artifacts, the system may enable more balanced training of machine learning models, potentially improving sensitivity for detecting these conditions without requiring extensive collection of real patient data with these characteristics.

In educational contexts, the synthetic outlier samples may provide training resources for radiologists, cardiologists, and other medical professionals learning to identify and interpret rare imaging presentations. These synthetic examples may be incorporated into educational curricula, case libraries, or simulation-based training programs where exposure to uncommon conditions might otherwise be limited by their natural prevalence. The ability to generate multiple variations of rare conditions may allow trainees to develop pattern recognition skills for these presentations without waiting to encounter them in clinical practice. Additionally, synthetic samples with known ground truth characteristics may be used for assessment and certification purposes, enabling standardized evaluation of diagnostic proficiency across a comprehensive range of clinical scenarios including those that occur too infrequently to be reliably included in traditional assessment materials.

### Artifact or Unwanted Feature Removal

Artifact or unwanted feature removal via generative artificial intelligence models may enhance medical image quality and diagnostic utility through automated identification and correction of technical limitations and imaging artifacts. Medical images may contain various artifacts and unwanted features that can interfere with clinical interpretation and automated analysis, including motion artifacts, noise patterns, reconstruction errors, and device-related distortions that may obscure anatomical structures or create false appearances that could lead to misinterpretation. Generating counterfactual images, where artifacts and/or unwanted features have been removed, while preserving clinically relevant anatomical and pathological information may potentially improve both human interpretation accuracy and automated analysis performance across various medical imaging applications.

The counterfactual image generation methodology may involve training generative artificial intelligence models that are configured to process input medical images, determine the most likely values of various image features including both anatomical characteristics and artifact parameters, and then generate modified versions of the images where specific features have been altered according to user specifications. In this context, “counterfactual” refers to synthetic images that represent alternative versions of the original data where certain features or characteristics have been systematically modified while maintaining consistency with the underlying anatomical structures and pathological findings. The counterfactual generation process may enable exploration of “what if” scenarios where imaging artifacts or unwanted features are removed or modified, providing enhanced visualization of the underlying anatomical structures that may be obscured or distorted in the original images.

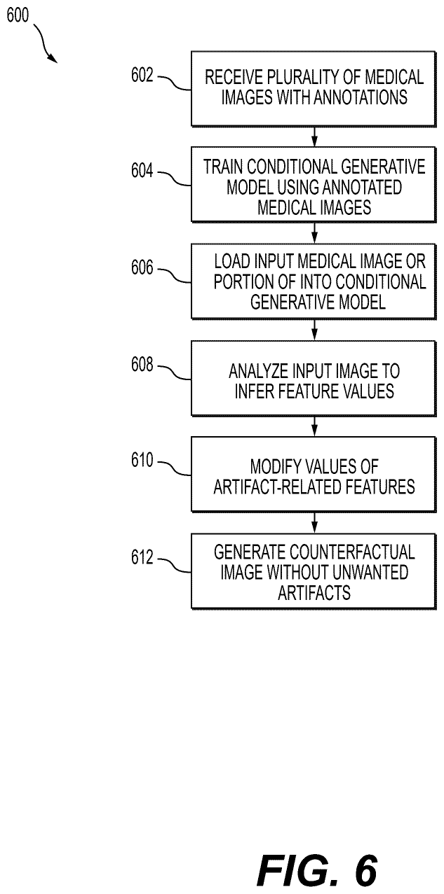

FIG. 6 depicts an exemplary method 600 for counterfactual image generation without unwanted features or artifacts. The method begins with step 602, where the system may receive a plurality of medical images with annotations. Annotations may be included with the medical images at the time of acquisition or may be added during subsequent processing stages. These annotations may be associated with various aspects of the image data. Examples of annotations include: presence, type, and extent of disease, including cardiovascular diseases such as coronary artery stenosis, plaque characteristics, myocardial abnormalities, or valvular pathologies; presence, type, and extent of image artifacts including motion artifacts, blooming artifacts, streak artifacts, or noise patterns that might affect image interpretation; description of the anatomical location in the patient including specific coronary segments, cardiac chambers, or adjacent anatomical structures; quantitative measurements such as vessel diameters, stenosis percentages, calcium scores, or ejection fraction values; image quality assessments that rate factors such as contrast opacification, motion control, or noise levels; technical acquisition parameters including scanner type, reconstruction kernel, or slice thickness; patient-specific factors such as heart rate during acquisition, presence of stents or other implanted devices, or administration of medications like beta-blockers or nitrates; and radiologist observations or diagnostic impressions that may guide subsequent clinical decision-making. In some embodiments, annotations might also include temporal information when comparing current images with prior studies, highlighting changes in disease progression or treatment response. The annotation process may be performed manually by clinical experts, semi-automatically with human verification, or in certain cases, fully automatically using machine learning algorithms trained to identify specific features or conditions.

In step 604, a conditional generative model may be trained using annotated medical images where various artifacts and image features have been systematically documented, enabling the model to learn relationships between image appearances and underlying feature parameters. The training process may involve exposing the model to diverse datasets containing medical images with different types of artifacts, noise patterns, and anatomical variations, along with corresponding annotations that characterize these features. An example of a generative artificial intelligence (AI) model that can be used for this is a DSCM. The DSCM may incorporate causal relationships between different image features, artifacts, and underlying anatomical structures through directed acyclic graph structures. This causal framework may enable the model to distinguish between correlation and causation in observed image patterns, potentially improving the accuracy of artifact identification and removal. The DSCM architecture may include encoder components that transform input images into latent representations capturing both anatomical structures and artifact characteristics, latent space manipulation mechanisms that allow for selective modification of specific feature parameters while preserving others, and decoder components that generate modified images based on the manipulated latent representations. In some implementations, the DSCM may utilize variational inference techniques to capture uncertainty in the relationships between observed image features and underlying causal factors, potentially enhancing the robustness of artifact removal procedures across diverse imaging conditions and patient anatomies.

The training process may involve exposing the model to diverse examples of medical images with various combinations of artifacts and anatomical characteristics, along with corresponding annotations that identify and characterize these features. The model may learn to encode input images into latent representations that capture both anatomical structures and artifact characteristics, enabling subsequent manipulation of specific feature parameters while maintaining overall anatomical consistency.

To remove an artifact from a specific medical image (input image), the medical image or a portion thereof may be loaded into the conditional generative model created in step 604, as shown in step 606. In step 608, the system may analyze the input image to infer feature values that characterize both the anatomical structures and any artifacts or unwanted features present in the image. The feature inference process may utilize the trained generative model to identify parameters such as motion artifact severity, noise levels, reconstruction artifacts, or other technical limitations that might affect image quality. In step 608 the system may identify specific features that could be removed or modified based on automated analysis or user specifications. In step 610, the system may modify the values of artifact-related features while maintaining the values of anatomical and pathological features. This approach may enable generation of a counterfactual image in step 612 that represents the same anatomical structures without the unwanted artifacts or technical limitations. In some embodiments, the system might preserve certain image characteristics while selectively removing others, depending on the specific clinical requirements and image quality considerations.

The artifact removal system may support human analysts by generating artifact-free images that can improve diagnostic accuracy and interpretation confidence. The enhanced visualization capabilities may enable radiologists and other medical professionals to more clearly identify anatomical structures and pathological changes that might be obscured or distorted by artifacts in the original images. The artifact removal process may be particularly valuable for images affected by patient motion, which can create blurring or streaking artifacts that significantly degrade image quality and interpretability. By removing these motion artifacts, the system may reveal underlying anatomical details that were previously difficult to discern, potentially enabling more accurate assessment of coronary artery stenosis, plaque characteristics, and other clinically relevant features.

The artifact removal system may also enhance trust in AI segmentation and quantification methods by providing users with visualizations of the cleaned input data used for automated analysis. By showing the artifact-removed images alongside the original data and the resulting segmentations or quantitative measurements, the system may help users understand how the AI algorithms interpret and process the image data. This transparency may increase user confidence in the automated analysis results by demonstrating that the algorithms are working with enhanced versions of the input data where confounding artifacts have been removed. The visualization of cleaned inputs may be particularly valuable when the original images contain significant artifacts that might raise concerns about the reliability of automated analysis results. By showing how these artifacts are addressed during the analysis process, the system may provide reassurance that the automated measurements and segmentations are based on the underlying anatomical structures rather than being influenced by imaging artifacts or technical limitations.

Another application of the artifact removal system may involve utilizing expert annotations of cleaned images to generate training data for various supervised learning models. In some embodiments, the system may present cleaned images alongside original images that contain artifacts to clinical experts for comparative review of the artifact removal process. This approach may enable the collection of high-quality training labels from expert reviewers who can assess the effectiveness of the artifact removal while providing annotations on the enhanced image data. The expert review process may involve radiologists or other medical imaging specialists evaluating the clinical accuracy and diagnostic utility of the cleaned images compared to the original artifact-affected versions. In certain implementations, the system may incorporate feedback mechanisms that allow experts to indicate areas where artifact removal was successful or where additional refinement might be beneficial, potentially enabling iterative improvement of the artifact removal algorithms based on clinical expertise and domain knowledge.

Pre-processing data before automated analysis may represent another valuable application of the artifact removal system, potentially increasing the robustness and reliability of various analytical algorithms by standardizing image appearance and removing features that are not relevant to specific analytical tasks. The pre-processing approach may address various challenging appearance alterations including slice misregistration artifacts that create discontinuities between adjacent image slices, motion artifacts that cause blurring or streaking, blooming artifacts around high-density structures such as calcified plaques or metallic implants, and device-related artifacts from stents or bypass grafts that can obscure underlying anatomy. By removing these challenging features before applying analytical algorithms, the system may reduce the need for each algorithm to individually handle these complex appearance variations, potentially simplifying algorithm development and improving analytical performance. The counterfactual pre-processing may be particularly valuable for tasks where certain image features such as exact lumen boundaries or true disease characteristics are only secondary to the primary analytical objective. For example, lumen centerline extraction algorithms that aim to capture the connected coronary anatomy and represent it as a centerline tree structure may benefit from artifact removal preprocessing that enhances vessel continuity and reduces confounding features that might interfere with centerline tracking.

Intra-subject and inter-subject image registration applications may also benefit from the counterfactual generation approach. Intra-subject image registration may be used for fusing information from multiple reconstructions of the same patient, where artifacts in one reconstruction may interfere with accurate alignment with other reconstructions. Inter-subject image registration may be used for template-based modeling applications such as vessel labeling, landmark localization, and large structure segmentation. The removal of patient-specific artifacts and technical variations may improve the accuracy of registration algorithms by reducing confounding factors that do not represent true anatomical differences between images or patients.

This intra-subject registration based fusion of information may further be seen as a refinement of the artifact removal based on other, co-registered reconstructed views of the same artifact-degraded CCTA or medical image data. While the generative artifact removal may be learned from a plurality of images and anatomies, registration-based fusion may ensure that the resulting anatomical models match the available intra-scan data.

Image Resolution Adjustments and/or Normalization

Image resolution adjustments and normalization may provide benefits for medical imaging analysis by enabling standardized image characteristics that can improve both human interpretation and automated algorithm performance. The resolution adjustment process may enhance spatial detail in low-resolution images, potentially revealing anatomical structures and pathological features that might be difficult to discern in the original acquisitions. In some embodiments, the system may be configured to generate high-resolution versions of medical images that provide clearer visualization of coronary arteries, plaque boundaries, and other cardiovascular structures that are relevant for clinical assessment and treatment planning.

The normalization capabilities may enable standardization of image appearance characteristics across different acquisition protocols, scanner manufacturers, and reconstruction parameters. This standardization process can potentially reduce variability in image interpretation and may improve the consistency of automated analysis results across diverse imaging conditions. In some cases, the system might normalize images to specific computed tomography reconstruction kernels, which could help make interpretation more standardized and robust for both human analysts and algorithmic processing systems.

The resolution enhancement functionality may be particularly valuable in clinical scenarios where original image acquisition parameters were suboptimal due to patient factors, technical limitations, or emergency conditions that prevented optimal imaging protocols. By generating enhanced resolution versions of these images, the system may enable more accurate diagnostic assessments and may support clinical decision-making processes that would otherwise be limited by image quality constraints. In some embodiments, the system may be configured to provide users with the option to toggle between different reconstruction kernel appearances, such as smooth or sharp visualization modes, potentially providing flexibility in image interpretation approaches based on specific clinical requirements or user preferences.

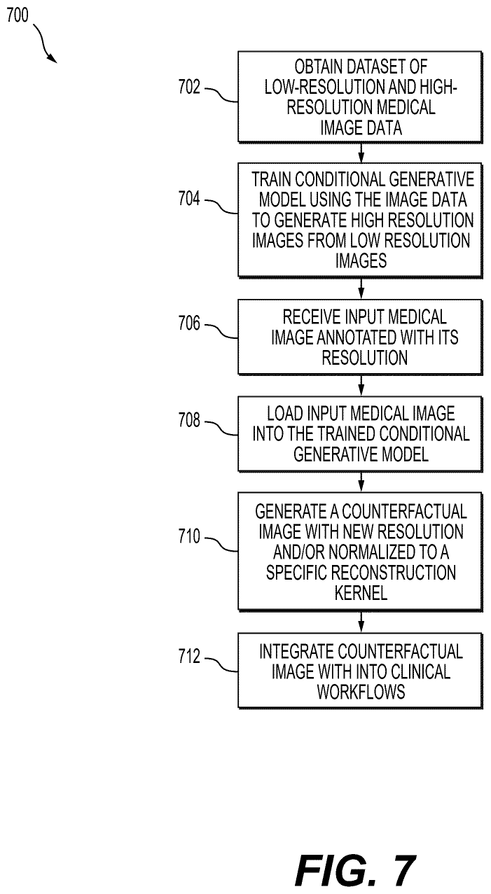

FIG. 7 depicts an exemplary method 700 for training and utilizing a conditional generative model to adjust image resolution and standardize image characteristics. The method may enable the generation of high-resolution versions of medical images from lower-resolution inputs while preserving clinically relevant features and anatomical details.

At step 702, the method may involve obtaining a dataset comprising low-resolution and high-resolution medical images. In some instances, the high and low resolution medical images may be paired. In other instances, the medical images may be unpaired. Image pairs may be created by down-sampling high-quality medical images to create corresponding low-resolution versions, or by collecting images acquired at different resolution settings from the same patients. In some embodiments, the dataset may include resolution metadata that specifies the acquisition parameters and pixel dimensions for each image.

At step 704, the method may involve training a conditional generative model using the image pairs. The conditional generative model, in embodiments, may be implemented as a conditional diffusion model, where the diffusion process gradually transforms noise into a high-resolution image conditioned on the low-resolution input. In some embodiments, the model architecture may incorporate attention mechanisms that help preserve fine anatomical details and structural relationships during the resolution enhancement process.

At step 706, the method may include training the conditional generative model to support reconstruction kernel normalization. This extension may involve incorporating additional conditioning variables that specify the desired reconstruction kernel characteristics, enabling the model to transform images between different kernel appearances. The training process may utilize image pairs that represent the same anatomical structures reconstructed with different kernels to learn the mapping between kernel-specific image appearances.

At step 708, the method may include deploying the validated model for clinical use, where it may be operated to receive a medical image as input with instruction to generate an enhanced version with improved resolution or standardized reconstruction kernel characteristics. The deployed system, in embodiments, may be configured to provide user interface options to specify the desired output resolution parameters or to toggle between different reconstruction kernel appearances such as smooth or sharp visualization modes.

At step 710, the method may generate an enhanced synthetic image in accordance with the specified instructions. The enhanced image can incorporate the desired resolution improvements or kernel normalization characteristics requested by the user. In some embodiments, the system might provide visual comparisons between the original and enhanced images to help users evaluate the improvements in image quality.

At step 712, the method may involve integrating the enhanced images into downstream clinical workflows and analysis pipelines. The high-resolution or kernel-normalized images can be used for various clinical applications including diagnostic assessment, treatment planning, and automated analysis tasks.

Predicting Progression of Disease from a Baseline Computed Tomography (CT) Image

The prediction of disease progression from baseline computed tomography images may enable clinicians to anticipate future pathological changes based on current imaging data. The generative model system may be configured to learn temporal relationships between medical images acquired at different time points, enabling the generation of predicted future disease states from baseline CT acquisitions. The temporal modeling approach may provide insight for treatment planning, risk assessment, and patient monitoring by simulating how cardiovascular pathology may evolve over time under various clinical scenarios.

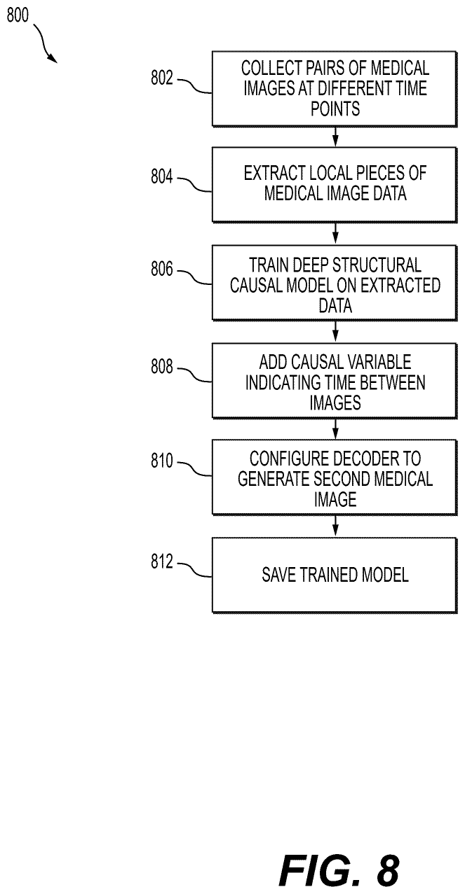

FIG. 8 depicts an exemplary training method 800 for predicting progression of disease from a baseline medical image, e.g., for predicting progression of disease from a baseline medical image. In step 802, the training method may involve collecting pairs of medical images acquired at different time points from the same patients, where the temporal separation between acquisitions provides the foundation for learning progression patterns. The first image in each pair may represent the baseline state of the patient's cardiovascular anatomy and pathology, while the second image may represent the disease state at a later time point. The temporal interval between image acquisitions may vary depending on the clinical context and the specific disease processes being modeled, with intervals ranging from months to years depending on the expected rate of disease progression and the clinical follow-up protocols used in the source dataset.

These medical images may include computed tomography (CT) or coronary computed tomography angiography (CCTA) images that provide detailed visualization of anatomical structures and pathological changes over time. The medical images may be accompanied by various annotations including disease severity classifications, quantitative measurements of anatomical features, identification of specific pathological findings, and clinical parameters associated with disease progression. In some embodiments, the annotations may also include information about treatment interventions administered between imaging time points, patient-specific risk factors, and clinical outcomes that may influence disease progression patterns.

Still referring to FIG. 8, in step 804, the system may extract local pieces of medical image data. These local pieces may include volumetric patches centered on coronary vessels, two-dimensional cross-sections at specific locations, curved multiplanar reformatted segments following vessel centerlines, or other localized regions that capture clinically relevant features. The extraction process may utilize automated algorithms that identify regions of interest based on anatomical landmarks, intensity patterns, or predefined parameters. For coronary artery analysis, the extraction may focus on segments containing stenoses, plaque formations, or bifurcation points that are particularly relevant for disease progression assessment. The extracted local pieces serve as the foundation for subsequent analysis, as they contain the detailed anatomical and pathological information necessary for training the deep structural causal models in the following steps.

In step 806, a deep structural causal model (DSCM) may be trained on the extracted local pieces of the medical image data. In some instances, the DSCM may be trained on local pieces of image data extracted from coronary arteries, such as curved planar reformatted data sections that provide detailed visualization of coronary anatomy and pathology along the vessel centerlines. The DSCM may also incorporate multiple annotated causal variables that influence disease progression, including lumen geometry, plaque morphology characteristics, positive remodeling patterns, stenosis locations, pericoronary adipose tissue features, and various types of imaging artifacts that may affect the assessment of disease progression.

The causal variable framework may enable the model to learn relationships between baseline disease characteristics and future pathological changes. For example, lumen geometry variables may capture the initial state of coronary artery dimensions and shape characteristics that may influence subsequent disease development. In another example, plaque morphology variables may represent the composition, distribution, and structural characteristics of atherosclerotic plaques that may affect progression patterns. In another example, positive remodeling variables may indicate the presence of compensatory vessel wall changes that may influence future plaque development and luminal narrowing. Additionally, stenosis location variables may capture the anatomical distribution of disease that may affect progression patterns in different coronary territories.

After training, in step 808, an additional causal variable may be added which represents a number of days after the first medical image the second medical image was made. The temporal component of the disease progression model may be incorporated through the addition of a time variable that represents the interval between baseline and follow-up imaging acquisitions. The time variable may be expressed as the number of days, months, or years between the first and second medical image acquisitions, depending on the temporal scale appropriate for the specific disease processes being modeled

The model may learn to associate different temporal intervals with corresponding patterns of disease progression, enabling the generation of predicted disease states at specified future time points based on baseline imaging characteristics. In step 810, a decoder component of the DSCM may be trained to generate the second medical image as its target output. The decoder may be the generative portion of the model that transforms encoded representations back into image data. During training, the decoder may learn to reconstruct the follow-up medical image when provided with the encoded representation of the first medical image plus the temporal interval (delta T or time variable) between acquisitions. This training process enables the disease progression model to learn the relationships between initial disease characteristics, temporal progression intervals, and resulting pathological changes. A reconstruction loss function may measure the difference between the decoder's generated output and the actual follow-up image, focusing on features that are clinically relevant for disease assessment and risk stratification, such as changes in lumen dimensions, plaque volume and composition, degree of stenosis, plaque composition, and the development of new stenotic lesions.

The disease progression prediction system may be configured to generate multiple types of outputs depending on the clinical application and user requirements. The system may generate predicted images that visualize the expected appearance of coronary anatomy and pathology at future time points. The predicted images may be presented in various formats, including three-dimensional volume renderings, curved planar reformatted views along coronary centerlines, or cross-sectional images at specific anatomical locations. The system may also generate quantitative predictions of disease state parameters, such as predicted plaque volumes, stenosis severity measurements, or other clinically relevant metrics that characterize disease progression.

In step 812, the trained model is saved to persistent storage. This saved model may then be deployed for clinical use or further refinement as needed. In an example, the trained model may be used to generate a synthetic image that is a prediction of progression from an input image by a period of time corresponding to the time variable. In other words, in embodiments, by learning to generate the second image in a pair from the first, the model may learn to simulate such progression for any input image. A generated synthetic image may be used to predict future disease progression at the specified time in the future. In some instances, the prediction is for future cardiac events. In some instances, the prediction process may account for the natural history of atherosclerotic disease progression, including factors such as plaque growth patterns, luminal narrowing progression, and the development of new lesions in previously unaffected coronary segments.

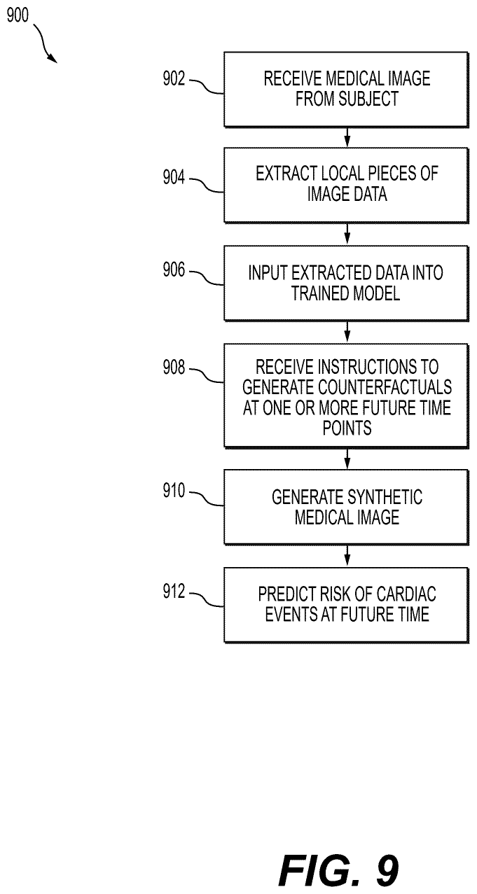

FIG. 9 depicts an exemplary method 900 for predicting disease progression from a baseline medical image. The method 900 provides a systematic approach for generating synthetic representations of future disease states based on current medical imaging data. This predictive methodology may enable clinicians to anticipate potential pathological changes over time, which can be valuable for treatment planning, risk assessment, and patient monitoring activities. The method 900 incorporates various computational techniques that leverage machine learning models trained on longitudinal datasets to project disease development patterns from baseline imaging characteristics.

In step 902, the system may receive at least one medical image from a subject. In some embodiments, the medical image may be a coronary computed tomography angiography (CCTA) image that provides detailed visualization of coronary arteries, cardiac chambers, and surrounding structures. The received medical image may serve as the baseline data from which future disease states will be predicted.

In step 904, the system may extract local pieces of image data from the received medical image. In step 906, the system may input the extracted local pieces of image data into the trained model in FIG. 8. In step 908, the system may receive, instructions to generate counterfactuals/synthetic medical images at one more future timepoint.

In step 910, the system may generate a synthetic medical image representing the predicted disease state at the specified future time point. This synthetic image may visualize the expected progression of pathological changes based on the baseline imaging data and the trained predictive model. The generation process may utilize various generative modeling techniques, including deep structural causal models, generative adversarial networks, or diffusion models that have been trained to produce realistic medical images reflecting disease progression patterns. In some embodiments, the synthetic image might maintain the same format and characteristics as the original medical image, facilitating direct comparison between current and predicted future states. The generated image may, in embodiments, include various visual indicators of disease progression, such as changes in plaque volume, stenosis severity, or the development of new lesions. In certain implementations, the system might also provide confidence estimates or uncertainty visualizations that indicate the reliability of different aspects of the prediction, potentially helping clinicians interpret the predicted disease progression with appropriate caution in areas of higher uncertainty.

In step 912, the system may use the generated synthetic image to predict future disease progression at the specified time in the future. In some instances, the prediction is for future cardiac events. In some instances, the prediction process may account for the natural history of atherosclerotic disease progression, including factors such as plaque growth patterns, luminal narrowing progression, and the development of new lesions in previously unaffected coronary segments.

The predicted disease states and/or the generated synthetic image generated by the system may serve as inputs for downstream clinical applications and risk assessment algorithms. The system may be integrated with risk prediction models that assess the likelihood of future cardiovascular events or other disease events based on predicted disease characteristics. The predicted images and quantitative parameters may enable clinicians to anticipate future disease burden and plan appropriate monitoring intervals and therapeutic interventions. The system may also support treatment planning by enabling clinicians to evaluate the potential impact of different therapeutic strategies on long-term disease progression patterns.

The disease progression prediction approach may incorporate probabilistic modeling of disease progression to provide clinicians with information about the reliability and confidence associated with generated predictions. The system may generate multiple plausible progression scenarios based on the baseline imaging data, reflecting the inherent variability in disease progression patterns observed in clinical populations. The uncertainty estimates may help clinicians interpret the predictions appropriately and make informed decisions about patient management based on the range of possible future disease states rather than relying on single-point predictions that may not capture the full spectrum of progression possibilities.

The trained model developed in FIG. 8 may be utilized to predict disease state and progression based on various therapeutic interventions and treatment modalities. This application may extend the disease progression prediction capabilities by incorporating treatment-specific variables that may influence cardiovascular outcomes over time. The model may be trained using pairs of medical images acquired at different time points, with comprehensive annotations documenting the therapeutic interventions that occurred between the acquisition of the first and second images. These treatment annotations may include detailed information about various intervention categories such as pharmacological therapies including but not limited to statins, antiplatelet agents, ACE inhibitors, beta-blockers, and other cardiovascular medications with specific dosages and adherence patterns; lifestyle modifications encompassing dietary changes, exercise regimens, smoking cessation programs, weight management interventions, and stress reduction techniques; invasive procedures such as Percutaneous Coronary Intervention (PCI) with specifications of stent types, locations, and dimensions, or Coronary Artery Bypass Grafting (CABG) with details of graft configurations and surgical approaches; and other therapeutic modalities that may influence cardiovascular disease progression including cardiac rehabilitation programs, device implantations, or novel therapeutic approaches.

The utilization of the trained model for treatment-based disease progression prediction may involve several systematic steps that enable comprehensive assessment of therapeutic outcomes. The process may begin with obtaining baseline medical imaging data that captures the patient's current cardiovascular status and disease characteristics. Following image acquisition, the system may receive detailed specifications of the prescribed or contemplated treatment regimen, including medication types and dosages, procedural interventions, or lifestyle modification programs. The temporal component may be specified by inputting the desired prediction timeframe, expressed as the number of days, months, or years into the future for which disease progression modeling is requested. The trained model may then generate predictions of the most plausible disease state at the specified future time point, conditioned on the entered treatment parameters. These predictions may include synthetic medical images that visualize the expected anatomical changes, quantitative metrics describing plaque characteristics and distribution, functional parameters such as fractional flow reserve values, and risk assessments for various cardiovascular events. The system may optionally be configured to provide patient-accessible interfaces, potentially implemented as a “Heart Health Assistant” application that enables individuals to interact with generative models adapted to their specific clinical profile, lifestyle factors, medical conditions, and prescribed treatments. This patient-facing system may allow users to simulate the potential effects of various lifestyle changes and treatment adherence scenarios on their cardiovascular health trajectory. The interface may provide educational visualizations and explanations that help patients understand the potential impact of modifying specific variables such as smoking cessation, exercise initiation or intensification, medication adherence, dietary modifications, or other behavioral changes on their coronary artery disease progression and overall cardiac health outcomes.

The model developed in FIG. 8 may be further utilized for optimal treatment selection and personalized therapy planning through comprehensive analysis of treatment outcomes across multiple clinical scenarios. This application may involve modeling disease progression patterns under various treatment alternatives and determining therapeutic approaches that optimize specific clinical objectives such as risk minimization, outcome improvement, quality of life enhancement, cost-effectiveness, or other clinically relevant metrics. The system may be configured with flexible weighting mechanisms that allow users to adjust the relative importance of different optimization criteria, enabling exploration of treatment options under various constraint scenarios such as cost-neutral approaches, maximum efficacy regardless of expense, or balanced approaches that consider multiple factors simultaneously. The treatment optimization capabilities may encompass various therapeutic modalities including pharmacological interventions with patient-specific dose optimization algorithms that account for individual response patterns, comorbidities, and potential drug interactions; percutaneous coronary interventions with detailed modeling of stent placement strategies including optimal number, positioning, length, diameter, and type selection based on vessel characteristics and lesion morphology; coronary artery bypass grafting with analysis of graft configuration options, surgical approach selection, and expected long-term patency outcomes; and combination therapy approaches that integrate multiple treatment modalities for comprehensive cardiovascular risk management. For interventional procedures such as stenting, the system may provide detailed procedural planning recommendations including precise specifications for stent deployment strategies, optimal vessel preparation techniques, and post-procedural management protocols. Similarly, for surgical interventions such as CABG, the system may analyze various graft options, surgical approaches, and expected outcomes to support surgical planning and patient counseling processes.

The implementation of the trained model for optimal treatment prediction may follow a systematic workflow that begins with obtaining comprehensive baseline medical imaging data that characterizes the patient's current cardiovascular status, disease burden, and anatomical features relevant to treatment planning. The system may then be configured to analyze multiple treatment scenarios and determine the optimal therapeutic approach for a specified combination of clinical objectives and constraints. These objectives may include minimization of cardiovascular event risk weighted against treatment costs, maximization of quality-adjusted life years, optimization of functional outcomes, or other clinically meaningful endpoints that reflect patient-specific priorities and clinical circumstances. The optimization process may incorporate various patient-specific factors such as age, comorbidities, lifestyle factors, previous treatment responses, and individual risk profiles to generate personalized treatment recommendations. The system may provide comparative analyses of different treatment options, including expected outcomes, associated risks, cost implications, and quality of life impacts to support shared decision-making between patients and healthcare providers. Additionally, the system may generate confidence intervals or uncertainty estimates for treatment recommendations, helping clinicians understand the reliability of predictions and make informed decisions in cases where multiple treatment options may yield similar expected outcomes.

### Simulating Interventions for Treatment Planning and Disease Progression

Simulating interventions for treatment planning and disease progression may enable clinicians to evaluate the potential effects of various therapeutic approaches on cardiovascular disease development and patient outcomes through systematic modeling of causal relationships between treatment variables and clinical endpoints. While traditional risk scores provide a probability or % risk associated with (or without) an intervention, counterfactuals may allow physicians to simulate the effect of providing a treatment (or not) on the appearance of disease and derived metrics (e.g. % stenosis, plaque volume) for a given patient scan. With enough training data, generative models such as deep structural causal models may be trained to represent the causal relationships between a wide range of patient variables (e.g. medications, interventions, risk factors, appearance of relevant structures and disease in imaging modalities) with outcomes and disease progression.

In some embodiments, a uni- or multi-modal generative model may be trained to model relationships between variables of interest and image data using all available patient data, where changes in a target modality (e.g. CCTA) may be modeled with respect to changes in variables of interest (e.g. interventions). The generative model may be trained to produce realistic counterfactuals from the target modality given changes to the input variables of interest.

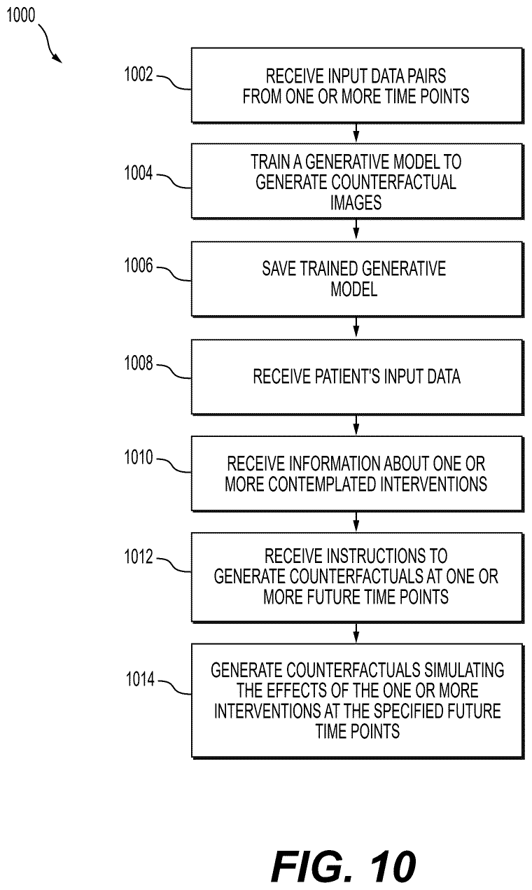

FIG. 10 depicts an exemplary method 1000 of simulating interventions for treatment planning and predicting disease progression. In step 1002, the system may receive input data pairs from one or more time points, which may include data collected before and after medical interventions. The input data for the generative model system may be multi-modal in nature, encompassing various types of medical information that may be processed to generate comprehensive patient representations. Input data for the system may include but not be limited to: imaging data from one or more time points, which may be acquired before and after interventions, including but not limited to: CCTA images providing detailed visualization of coronary arteries and cardiac structures, X-ray angiography showing vessel lumen and potential stenoses, CMR (Cardiac Magnetic Resonance) for tissue characterization and functional assessment, Echocardiography for real-time cardiac function evaluation, PET (Positron Emission Tomography) for metabolic and perfusion assessment, SPECT (Single-Photon Emission Computed Tomography) for myocardial perfusion analysis, Invasive IVUS (Intravascular Ultrasound) or OCT (Optical Coherence Tomography) for detailed vessel wall assessment; EMR (Electronic Medical Record) data, including: structured and unstructured text data with results of clinical tests and measurements from one or more time points, which may include: Blood tests providing lipid levels, inflammatory markers, and other biomarkers, ECG (Electrocardiogram) signals showing cardiac electrical activity, Systolic and diastolic blood pressure measurements over time; Interventions, which may include various therapeutic approaches such as: Prescribed medications and dosage regimens, which may include but are not limited to: Aspirin, statins, anti-hypertensives, lipid-lowering therapies, obesity and diabetes management medications, with information about dosage, frequency, and duration; Surgical procedures, such as percutaneous coronary intervention (PCI) or coronary artery bypass graft (CABG), including details about technique, location, and outcomes, and lifestyle changes including dietary modifications, exercise regimens, smoking cessation programs, weight management interventions, stress reduction techniques, sleep hygiene improvements, and alcohol consumption moderation; wearable device data, including: Heart rate monitoring data; motion/movement monitoring data; sleep patterns; continuous glucose monitoring; and other physiological parameters that may be relevant to cardiovascular health assessment. The model may learn to associate different temporal intervals with corresponding patterns of disease progression, enabling the generation of predicted disease states at specified future time points based on baseline imaging characteristics. In step 1004, a generative model may be trained to learn relationships between variables in the input data and generate counterfactual images a deep structural causal model (DSCM) and/or other suitable generative models such as denoising diffusion probabilistic models (DDPMs), latent diffusion models (LDMs), or Generative adversarial networks (e.g., StyleGAN or conditional GAN) may be trained to generate realistic medical images.

In some embodiments, the DSCM training process may involve feeding the DSCM with multi-modal input data that includes medical imaging data, clinical parameters, treatment information, and patient demographics. During training, the DSCM may learn to identify causal relationships rather than mere correlations between variables, which may enable more robust counterfactual generation. The model architecture may incorporate multiple encoding layers that transform raw input data into latent representations capturing both observed and unobserved variables. In some implementations, the training procedure may utilize both supervised and unsupervised learning approaches, where supervised components may focus on known causal relationships while unsupervised components could discover latent structures in the data. The DSCM may employ various regularization techniques to prevent over-fitting, including but not limited to dropout, weight decay, or early stopping based on validation performance. The training process may involve iterative optimization using gradient-based methods to adjust model parameters in ways that minimize prediction errors while maintaining causal consistency across generated counterfactuals. The effectiveness of a DSCM may be improved by counterfactual fine-tuning with guidance from predictor models, where separately trained classification, regression or segmentation models to predict the causal variables can be used to update the weights of the generative model to enforce relationships between the generative process and the causal variables.

In other embodiments, Generative adversarial networks (e.g., StyleGAN) models may be trained to generate realistic medical images. The StyleGAN architecture may incorporate style-based generator components that separate high-level attributes from stochastic variations, enabling more controlled synthesis of medical images with specific characteristics. The training process may involve progressive growing techniques where resolution increases gradually during training, potentially improving stability and quality of generated outputs. Input data for StyleGAN models may undergo preprocessing steps including resolution standardization, contrast normalization, and artifact removal to create consistent training examples. The adversarial training approach may utilize discriminator networks that learn to distinguish between real and synthetic medical images, providing feedback signals that guide the generator toward producing more realistic outputs with anatomically plausible features.

In some embodiments, longitudinal data including a target modality as well as changes in variables of interest may be used to fine-tune the generative model to more accurately learn the association between the observed changes in the target modality and the changes in the variables of interest. This fine-tuning process may involve temporal alignment of data collected at different time points, which may assist to establish causal relationships between interventions and observed changes in imaging characteristics. In some embodiments, the longitudinal data may include baseline and follow-up CCTA images, along with corresponding clinical parameters such as medication changes, lifestyle modifications, or procedural interventions that occurred between imaging sessions. The fine-tuning methodology may incorporate various temporal modeling approaches, including recurrent neural networks, temporal convolutional networks, or attention-based mechanisms that can capture time-dependent relationships between variables. Additionally, the fine-tuning process may utilize different weighting schemes that prioritize more recent data points or emphasize specific types of interventions based on their expected impact on disease progression or regression patterns.

In other embodiments, self-supervised, semi-supervised and fully supervised losses and models may be used, where appropriate to enable relationships between patient data to be modeled adequately. Self-supervised learning approaches may leverage unlabeled data by creating auxiliary tasks that generate implicit supervision signals, such as predicting masked regions of images, reconstructing corrupted inputs, or learning invariant representations across different data augmentations. These techniques can be particularly valuable when working with large datasets where manual annotations may be limited or expensive to obtain. Semi-supervised learning methods may combine limited labeled data with larger amounts of unlabeled data, potentially using techniques such as consistency regularization, entropy minimization, or pseudo-labeling to leverage information from unlabeled examples. In some implementations, the training process may begin with self-supervised pre-training on large unlabeled datasets, followed by semi-supervised fine-tuning with partially labeled data, and culminating in fully supervised optimization using carefully annotated examples. This progressive training approach may enable more efficient use of available data resources while maintaining model performance. The combination of different supervision paradigms may be implemented through multi-task learning frameworks where different loss functions are weighted based on the reliability and importance of different supervision signals.

In additional embodiments, the model may be trained to predict clinical metrics (e.g. age, sex, hypertension, diabetes, etc.) from imaging modalities (e.g. CCTA) where possible, which may be then used to improve generative models (e.g. DSCM and StyleGAN), while also being used to impute missing information for a patient. These clinical metric predictors may be implemented as specialized neural network architectures designed to extract relevant features from medical imaging data that correlate with specific patient characteristics or conditions. For age prediction, the models may learn to identify imaging biomarkers such as coronary calcification patterns, vessel tortuosity, or myocardial tissue characteristics that change with aging. Sex prediction models may identify subtle anatomical differences in cardiac structure, coronary artery dimensions, or fat distribution patterns that differ between male and female patients. For condition-specific predictors such as hypertension or diabetes, the models may learn to recognize vascular remodeling patterns, myocardial hypertrophy signs, or microvascular changes that are associated with these conditions. In some embodiments, these predictors may be trained using multi-task learning approaches where a shared feature extraction backbone feeds into multiple prediction heads for different clinical metrics, potentially improving generalization by leveraging commonalities between related tasks. The predicted clinical metrics can then serve as conditioning variables for generative models, enabling more accurate synthesis of patient-specific imaging data even when certain clinical information may be missing from the patient record.

In some embodiments, the model may be trained to provide confidence scores and uncertainty estimates for generated samples, which may be interpreted by a user. For example, an ensemble of predictors may be trained to be run on the counterfactual model to provide a measure of uncertainty of a structure of interest in the generated sample. The uncertainty estimation may be implemented through various techniques including Bayesian neural networks that model parameter distributions rather than point estimates, Monte Carlo dropout approaches that approximate Bayesian inference by performing multiple forward passes with randomly deactivated neurons, or deep ensembles that train multiple models with different random initializations or on different data subsets. These uncertainty quantification methods may provide different types of uncertainty measures, including aleatoric uncertainty that captures inherent data variability and epistemic uncertainty that reflects model knowledge limitations. In some implementations, the uncertainty estimates may be visualized through heat maps overlaid on generated images, highlighting regions where the model has lower confidence in its predictions. For derived variables such as plaque volumes or FFRCT values, the uncertainty may be represented as confidence intervals or probability distributions rather than single point estimates. These uncertainty representations may help clinicians make more informed decisions by understanding the reliability of generated counterfactuals and derived metrics, potentially identifying cases where additional clinical information or alternative imaging approaches might be beneficial.

In step 1006, the trained generative model is saved to storage.

The trained generative model may be utilized to produce counterfactuals for a target modality, simulating the effect of different interventions or changes in variables of interest on the appearance of the target modality. These counterfactuals may provide visual representations of potential future states based on different treatment decisions or physiological changes. Optionally, the output of the generative model may be used as input to other models to produce derived variables of interest, for example: counterfactual images of CCTA data may be passed to models which compute an updated geometric model of a patient's coronary tree, as well as updated plaque volumes and physiological parameters derived from the new geometry such as FFRCT.

Still referring to FIG. 10, in step 1008, the system may receive a patient's input data including one or more of image data (such as CCTA volumes, X-ray angiography, echocardiography studies), EMR data (including laboratory values, vital signs, clinical notes), medications (including dosage information, administration schedules, duration of therapy), and other clinical parameters such as demographic information, family history, or lifestyle factors. The system may also receive, in step 1010, information about one or more contemplated interventions, such as surgical interventions (including coronary artery bypass grafting, valve replacement, or stent placement) or non-surgical interventions, such as medications (including statins, antihypertensives, or antiplatelet agents) and/or lifestyle changes (including dietary modifications, exercise regimens, or smoking cessation). In some implementations, the intervention information may include timing parameters, dosage levels, or procedural details that can influence the predicted outcomes.

The system may also receive instructions, in step 1012, to generate counterfactuals of a particular modality (e.g., CCTA images) for a future time point, which may be specified in terms of days, months, or years from the baseline assessment. The time point specification may include single or multiple intervals to enable visualization of disease progression or treatment response over various temporal horizons. In step 1014, the system may generate a counterfactual image simulating the one or more interventions on the desired modality at the specified time point. The generated counterfactual images may include visual indicators of predicted changes in anatomical structures, disease characteristics, or physiological parameters that would likely result from the specified interventions. In some embodiments, the system may generate multiple counterfactual scenarios with varying degrees of intervention intensity or combinations of treatments to enable comparative assessment of different therapeutic approaches.

For example, a patient may have CCTA image data, age, sex, and clinical risk factor data (diabetes, hypertension, lipids, etc.) available for analysis. The patient may present with a severe mid-LAD stenosis, and diffuse non-calcified plaque in their right coronary artery (RCA) and left circumflex artery (LCX). One or more pieces of the available data becomes input data for the trained generator model to generate patient-specific simulations that can inform clinical decision-making regarding potential treatment strategies and their projected outcomes.

Using the generative model, a physician may simulate various clinical scenarios to predict disease progression under different treatment regiments. For instance, the system can generate a simulation showing the effect of administering statins and low dose lipid lowering drugs on disease progression via a generated (3D) CTA image, curved planar reconstruction (CPR) representation, 3D coronary tree mesh, or centerline representation at both 6-month and 12-month follow-up intervals. The system may also generate an alternative simulation demonstrating the combined effect of stenting and medications on disease progression at similar time intervals. These simulations may provide visual representations of plaque regression, changes in stenosis severity, and overall coronary artery health that may result from each intervention strategy, enabling physicians to visualize potential outcomes before implementing treatment plans.

The generative model may enhance clinical decision-making by providing comprehensive visualizations across multiple modalities and metrics. For example, the system may update the appearance of disease not only in the image data but also in derived analytical products such as Fractional Flow Reserve computed tomography (FFRct), RoadMap, and Plaque analyses, as well as in clinical variables such as projected lipid levels following pharmacological intervention.

The physician's interpretation may be further supported by uncertainty estimates provided by the system, or through the generation of multiple plausible samples that illustrate the range of potential outcomes. In some embodiments, the system may incorporate a retrieval mechanism that can identify similar patients from historical data, allowing physicians to examine what treatments were previously administered in comparable cases and how disease progression was modified.

Additionally, the trained predictors may be utilized to impute missing patient information, further informing the selection of optimal treatment options by providing a more complete clinical picture for analysis.

A Method of Optimization of Percutaneous Coronary Intervention from CCTA

During standard clinical Percutaneous Coronary Intervention (PCI), e.g., in a cathlab, interventionalists may aim to optimize several factors for treatment. These may include (i) selecting the best projection angle with which a target lesion should be viewed in a 2D X-ray image, (ii) identifying the appropriate treatment options for the patient, for example in consideration of balloon angioplasty, atherectomy, balloon implantation, lithotripsy, and (iii) the dimensions and type of stent to use, e.g. bare metal stents, drug-eluting stents, bioresorbable vascular scaffold, and drug-eluting balloons.

CT-based planning technologies enable interventionalists to plan a PCI non-invasively, both ahead of the operation and in real-time. This helps interventionalists select the location and length of stents required for the procedure.

Machine learning, in embodiments, may enhance clinical decision making for PCI planning by learning to predict the best course of action from a CCTA scan, and may leverage multiple modalities (e.g. CCTA, IVUS, OCT and X-ray angiography) in the training process, together with clinical decision making and outcomes from PCI.

Generative machine learning models may also help with clinical decision making by generating counterfactuals in relation to an intervention, e.g., to capture nuanced interactions between invasive treatment options and the changes to patient anatomy, disease and risk.

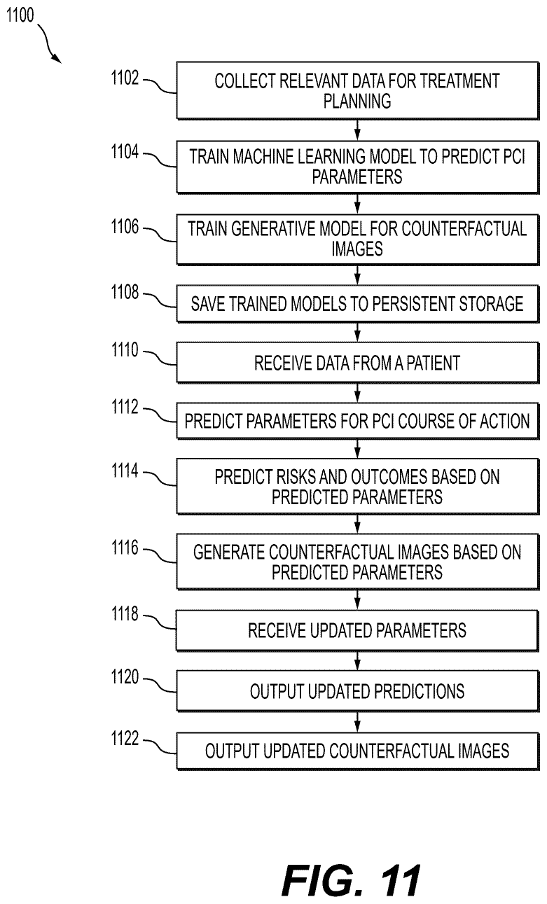

FIG. 11 depicts an exemplary method 1100 for optimizing percutaneous interventions based on imaging data such as CCTA images. The method may begin with step 1102, where relevant data for treatment planning is collected as input. The relevant data may include but is not limited to imaging data, patient risk factors, clinical notes, treatment decisions, medications, measured clinical variables, complications, long term outcomes including outcomes after specific periods of the intervention.

In embodiments, a machine learning model training methodology for percutaneous coronary intervention optimization may involve collecting comprehensive datasets that encompass various types of clinical information relevant to interventional treatment planning and procedural outcomes. CCTA data may provide detailed three-dimensional anatomical information including vessel geometry, plaque characteristics, stenosis morphology, and spatial relationships between coronary segments that affect procedural approaches and treatment outcomes. A coronary computed tomography angiography analysis component may extract various quantitative features including vessel diameter measurements, lesion length assessments, plaque composition characteristics, and geometric parameters that influence stent selection, placement strategies, and procedural complexity considerations.

X-ray angiography data may contribute procedural imaging information that demonstrates optimal visualization angles, contrast enhancement patterns, and real-time procedural guidance that characterizes successful interventional approaches. An X-ray angiography analysis process may identify viewing angles that provide clear visualization of target lesions while minimizing overlap with adjacent anatomical structures, enabling optimal procedural guidance and accurate stent placement procedures. Clinical notes and procedural documentation may provide detailed information about treatment decisions made by interventional cardiologists and heart teams, including rationale for specific procedural approaches, stent selection criteria, and treatment strategy considerations that account for patient-specific factors and clinical guidelines.

Patient risk factor information may encompass various clinical parameters including demographic characteristics, comorbidity profiles, laboratory measurements, and cardiovascular risk assessments that influence treatment selection decisions and procedural outcomes. A risk factor analysis component may process information about smoking status, diabetes mellitus presence, hypertension severity, dyslipidemia characteristics, and other cardiovascular risk factors that affect treatment response patterns and long-term clinical outcomes. Procedural outcome data may include information about immediate procedural success, complications that arose during or following interventional procedures, and longer-term clinical follow-up results that characterize treatment effectiveness and durability.

A treatment decision documentation process may involve systematic collection of clinical reasoning patterns and decision-making approaches used by experienced interventional cardiologists when planning percutaneous coronary intervention procedures. The decision documentation may encompass rationale for selecting specific stent types, dimensions, and placement locations based on lesion characteristics, vessel geometry, and patient-specific factors. Treatment approach documentation may include considerations for adjunctive therapies such as atherectomy procedures, intravascular lithotripsy applications, or balloon angioplasty techniques that may be utilized in conjunction with stent placement procedures to optimize treatment outcomes.

Stent selection criteria documentation may provide detailed information about the factors that influence choice of stent type, including bare metal stents, drug-eluting stents, bioresorbable vascular scaffolds, or drug-eluting balloons based on lesion characteristics, patient factors, and clinical considerations. A stent dimension selection process may account for vessel reference diameter measurements, lesion length assessments, and oversizing considerations that affect stent deployment success and long-term patency rates. Stent placement location optimization may involve considerations of side branch preservation, plaque coverage strategies, and geometric factors that influence procedural success and clinical outcomes.

Measured clinical variables and physiological parameters may provide additional training data that characterizes patient-specific factors affecting treatment outcomes and procedural success rates. Fractional flow reserve measurements may provide functional assessments of stenosis severity that influence treatment selection decisions and procedural planning approaches. Troponin level measurements may indicate myocardial injury patterns that affect procedural timing, treatment approaches, and post-procedural management strategies. The physiological parameter integration may enable the optimization system to account for functional significance assessments and biomarker patterns that influence treatment planning decisions and outcome predictions.

Complication documentation may encompass detailed records of procedural complications including dissection events, side branch occlusion, perforation incidents, or other adverse events that may occur during percutaneous coronary intervention procedures. A complication analysis component may identify anatomical characteristics, procedural factors, and patient-specific variables that are associated with increased complication risks, enabling the optimization system to generate risk assessments and procedural recommendations that minimize adverse event likelihood. Long-term outcome information may include follow-up data regarding target lesion revascularization rates, stent thrombosis events, and cardiovascular outcomes that characterize treatment durability and effectiveness.

Still referring to FIG. 11, in step 1104, a machine learning model may be trained to predict one or more relevant parameters to enhance clinical decision making for PCI. The relevant parameters may include but are not limited to optimal viewing angle(s) of a lesion (as determined from X-ray angiograms), the location, length, caliber and type of stent to place, the use of atherectomy, lithotripsy, or balloon implantation, a risk score associated with the predicted best options for PCI, including risk of: Short-term prognosis and complications (e.g. risk of MI, ACS, or dissection), long-term prognosis and complications (risk of cardiovascular mortality, stroke, ACS, MI), and expected improvement in symptoms. The training process may incorporate various clinical outcomes data, including procedural success rates, complication frequencies, and long-term patency statistics that provide ground truth information for supervised learning approaches. In some embodiments, the training dataset may include comprehensive procedural records that document specific intervention details, patient characteristics, and corresponding clinical outcomes across diverse patient populations and lesion types.

The machine learning model architecture for percutaneous coronary intervention optimization may utilize various computational approaches configured to process three-dimensional imaging data and generate comprehensive procedural recommendations based on learned patterns from training datasets. Deep neural network architectures may be employed to analyze coronary computed tomography angiography images and extract relevant anatomical features that influence treatment planning decisions. Convolutional neural network components may process three-dimensional imaging data to identify lesion characteristics, vessel geometry patterns, and anatomical relationships that affect procedural approaches and stent selection criteria. In some implementations, the model architecture may incorporate attention mechanisms that enable the system to focus on specific anatomical regions or lesion characteristics that are particularly relevant for intervention planning. The model may also utilize transfer learning techniques that leverage pre-trained networks on large medical imaging datasets, which can then be fine-tuned for the specific task of PCI optimization using smaller, specialized datasets of interventional cases.

Co-registration algorithms may be developed to establish spatial correspondence between coronary computed tomography angiography datasets and other imaging modalities. In one embodiment, co-registered CCTA and x-ray angiogram may be used to train a model to learn to predict the correct projection of CCTA data to reproduce X-ray images. This may enable the system to learn relationships between three-dimensional anatomical characteristics and optimal two-dimensional visualization approaches. The co-registration process may involve geometric transformation procedures that align three-dimensional coronary anatomy with corresponding X-ray projection geometries, enabling accurate prediction of optimal viewing angles based on pre-procedural imaging data. The spatial correspondence establishment may account for differences in patient positioning, cardiac phase timing, and imaging geometry between coronary computed tomography angiography and X-ray angiography acquisitions. The co-registration methodology may utilize feature-based approaches that identify corresponding anatomical landmarks across different imaging modalities, intensity-based methods that optimize similarity metrics between transformed images, or hybrid approaches that combine multiple registration strategies to achieve robust alignment across diverse imaging conditions. In some implementations, the registration process may incorporate non-rigid deformations to compensate for differences in cardiac phase, breathing, and patient orientation during acquisition of different images and modalities, potentially improving alignment accuracy. The registration approach may also utilize multi-modal image feature extractors which produce modality-agnostic image features from multiple imaging modalities, such as CCTA and X-ray angiography. These learned image features may be used to enhance the co-registration accuracy.

In some embodiments, the predicted optimal viewing angle may be used in training machine learning models to identify X-ray angiography projection angles that provide clear visualization of target lesions while minimizing anatomical overlap and maximizing procedural guidance quality. A viewing angle optimization process may involve analyzing three-dimensional vessel geometry to identify projections that minimize foreshortening of target lesion segments, reduce overlap with adjacent vessel branches, and provide perpendicular views of stenotic regions that facilitate accurate assessment of lesion severity and morphology. The optimization algorithms may account for various factors including vessel tortuosity, lesion location relative to bifurcations, and presence of calcifications or other features that may affect visualization quality from different projection angles. In certain implementations, the system may generate multiple candidate viewing angles with corresponding quality scores, enabling operators to select from several optimized projections based on specific procedural requirements or preferences.

In other embodiments, a stent specification prediction component may involve training one or more machine learning models to recommend optimal stent characteristics including stent type, diameter, length, and deployment parameters based on lesion morphology, vessel geometry, and patient-specific factors derived from coronary computed tomography angiography analysis. The stent selection algorithms may process quantitative measurements of vessel reference diameter, lesion length, plaque characteristics, and geometric parameters to generate recommendations for stent dimensions that optimize deployment success and long-term patency rates. A stent type recommendation process may account for various factors including lesion complexity, patient risk factors, and clinical guidelines that influence selection between different stent platforms and therapeutic approaches. The stent dimension optimization may incorporate analysis of vessel tapering patterns, reference diameter variations along the target segment, and lesion length measurements to recommend appropriate stent sizes that provide adequate lesion coverage while minimizing risks associated with geographic miss or excessive vessel coverage. In some implementations, the system may analyze plaque composition characteristics to recommend specific stent types that may be better suited for particular lesion morphologies, such as heavily calcified segments, lipid-rich plaques, or lesions with significant thrombus burden. The recommendation engine may also consider patient-specific factors such as bleeding risk, anticipated duration of dual antiplatelet therapy, and comorbidities that might influence the selection between bare metal stents, drug-eluting stents with different drug and polymer combinations, or bioresorbable vascular scaffolds.

Still referring to FIG. 11, in step 1106, a generative machine learning model may be trained to realistically generate the appearance of a target image after an intervention (i.e. generate a counterfactual image), using training data from before and after interventions, including the target image modalities as well as all treatment decisions. Target images may include but are not limited to: the CPR of a target lesion in CCTA, a projection of the CCTA mimicking a X-ray angiogram, and/or a X-ray angiogram, etc. Treatment decisions may include, but are not limited to, location, size, length, and type of stent(s) placed, balloon angioplasty, lithotripsy, and/or atherectomy. The generative model training process may utilize paired datasets of pre-intervention and post-intervention images along with detailed procedural records that document specific intervention parameters and techniques employed during each case. Various generative model architectures may be employed including conditional generative adversarial networks, variational autoencoders, or diffusion models that can learn to transform pre-intervention images into realistic post-intervention representations based on specified treatment parameters. The training methodology may incorporate adversarial components that encourage the generation of realistic post-intervention appearances through competition between generator networks that produce synthetic images and discriminator networks that evaluate image realism and clinical plausibility. The training methodology may also incorporate deep structural causal models that learn the relationship between causal variables and the generation of counterfactual images.

The counterfactual visualization system may generate various types of synthetic images including curved planar reconstruction views that demonstrate stent placement effects along coronary centerlines, cross-sectional images that show vessel geometry changes following treatment, and three-dimensional renderings that illustrate overall anatomical modifications resulting from interventional procedures. The synthetic image generation process may account for various factors including stent expansion characteristics, vessel wall remodeling patterns, and plaque modification effects that may occur following percutaneous coronary intervention procedures. The visualization system may provide multiple representation formats to support different clinical assessment needs, including longitudinal vessel views that demonstrate the full extent of treated segments, cross-sectional images at specific locations of interest such as minimal lumen diameter sites or stent edge regions, and three-dimensional volume renderings that illustrate the spatial relationships between stented segments and adjacent anatomical structures. In some implementations, the system may generate time-series visualizations that illustrate expected vessel healing and remodeling processes over various time intervals following intervention, potentially providing insights into long-term outcomes and identifying patients who might benefit from more intensive monitoring or modified pharmacological regimens.

In some embodiments, side branch interaction analysis may represent a specialized component of the counterfactual generation system that evaluates how proposed stent placement strategies may affect adjacent coronary branches and perfusion territories. A side branch assessment process may analyze the spatial relationships between target lesions and adjacent branch ostia to predict the likelihood of side branch compromise or occlusion following stent deployment. Such side branch protection strategies may be incorporated into treatment recommendations when anatomical analysis indicates elevated risk of branch vessel compromise. The side branch analysis may utilize computational fluid dynamics simulations to predict flow patterns and pressure distributions at bifurcation regions following virtual stent deployment, potentially identifying cases where specific stenting techniques such as provisional stenting, culotte technique, or T-stenting might be preferable based on bifurcation angle, vessel diameter ratios, and plaque distribution patterns. In some implementations, the system may generate visualization overlays that highlight regions with elevated risk of side branch compromise, providing procedural guidance that may inform decisions regarding wire protection strategies, kissing balloon techniques, or dedicated bifurcation stent approaches. The side branch assessment may also incorporate analysis of the functional significance of potentially affected branches, considering factors such as vessel diameter, supplied myocardial territory, and presence of collateral circulation that might influence the clinical impact of branch compromise.

Still referring to FIG. 11, in step 1108, the trained machine learning/generative models are saved to persistent storage. Then, in step 1110, the system may receive relevant patient data, (e.g. CCTA scans, and patient metadata such as risk factors, medications, etc.). Additionally, the system may also receive instructions to predict relevant parameters for PCI to determine the best course of action, including but not limited to the best viewing angle, from which a suitable projection of the CCTA scan can be provided to mimic a X-ray angiogram, the most appropriate treatment options, e.g. atherectomy, lithotripsy, etc., the most appropriate stent or stents to use, including stent type, location and dimensions. In some implementations, the system may incorporate additional clinical information beyond imaging data, such as patient demographics, cardiovascular risk factors, medication history, and prior intervention records that may influence treatment planning recommendations and outcome predictions.

In step 1112, the system may predict the relevant parameters for PCI. In step 1114, using the predicted parameters for a course of action, the system may predict outcomes and risks including: the risk of peri-procedural events or complications, or the long-term risk of MACE (major adverse coronary event).

In step 1116, the system may generate counterfactual images with the specified parameters. The generated counterfactual images, e.g. of the vessels containing the target lesion(s), may enable inspection or analysis of the effect of treatment options on the target vessel(s), e.g., to better inform treatment planning. Several factors provided by the counterfactual images may influence the decision to perform PCI, including: Simulating the effect of stents on side branches, and whether these become excessively blocked/caged, how stents interact with the different types of plaque present within the stented region, for example: Certain (calcified) plaques may prevent a stent from expanding appropriately (e.g. concentric calcification), and may need modification before stenting, certain plaques may be dislodged and cause a minor ACS, and how stents interact with the myocardium in diseased regions where there is myobridging. The counterfactual image generation process may utilize the trained generative models to transform pre-intervention CCTA data into synthetic representations that visualize expected post-intervention appearances based on specified treatment parameters. The generation algorithms may incorporate physics-based modeling components that simulate mechanical interactions between interventional devices and vessel tissues, potentially improving the realism and clinical relevance of generated visualizations. In some implementations, the system may generate multiple counterfactual scenarios representing different potential outcomes based on the same intervention parameters, reflecting the inherent variability in biological responses and procedural results that exists in clinical practice. The visualization system may provide side-by-side comparisons between current anatomy and predicted post-intervention states, potentially facilitating more intuitive assessment of expected treatment effects and identifying regions that might require special attention during intervention planning. The counterfactual visualization may also incorporate temporal components that illustrate expected changes over various time intervals following intervention, potentially highlighting regions that might be susceptible to late complications such as restenosis or stent fracture based on biomechanical stress patterns or other predictive factors identified during model training.

In step 1118, the user may also update the parameters and change the proposed course of action (treatment plan), and the system may provide an updated set of predictions for outcomes and risks. Such an interactive parameter adjustment capability may enable clinicians to explore various treatment scenarios through a user-friendly interface that facilitates modification of intervention parameters such as stent dimensions, deployment locations, or adjunctive treatment approaches. The real-time prediction update process may leverage efficient implementation of the trained machine learning models to provide rapid feedback as treatment parameters are modified, potentially enabling interactive exploration of multiple intervention strategies during clinical planning sessions. In some embodiments, the system may incorporate automated suggestion capabilities that recommend specific parameter adjustments that might improve predicted outcomes based on sensitivity analysis of the current treatment plan. The interactive exploration interface may support various input modalities including touch-screen interactions, mouse-based parameter adjustments, or natural language commands that modify treatment specifications, potentially accommodating different user preferences and clinical workflow environments. In steps 1120 and 1122, the system may output updated predictions and counterfactual images.

Learning to Map Directly from CT or Geometric Models to a Clinically Meaningful Representation

Direct mapping from computed tomography images may enable the generation of diagnostic models and physiological assessments without requiring intermediate geometric reconstruction steps. The direct mapping methodology may involve training machine learning models that can process raw computed tomography image data and produce clinically relevant outputs such as fractional flow reserve computed tomography models, coronary microvascular disease indices, or percent myocardium at risk assessments, etc. The direct mapping approach may provide computational efficiency advantages compared to traditional analysis pipelines that involve multiple sequential processing steps, while potentially improving accuracy by avoiding error propagation that may occur through intermediate processing stages.

In one embodiment, the direct mapping system may be powered by a generative AI model trained using an input including one or more coronary computed tomography angiography (CCTA) datasets. The direct mapping system may output one or more fractional flow reserve computed tomography (FFRct) models that include geometric representations of coronary anatomy and computed physiological parameters such as pressure and flow values distributed throughout the coronary tree. The training process may involve learning relationships between image-based anatomical and pathological features and corresponding physiological assessments that characterize coronary artery function and disease severity.

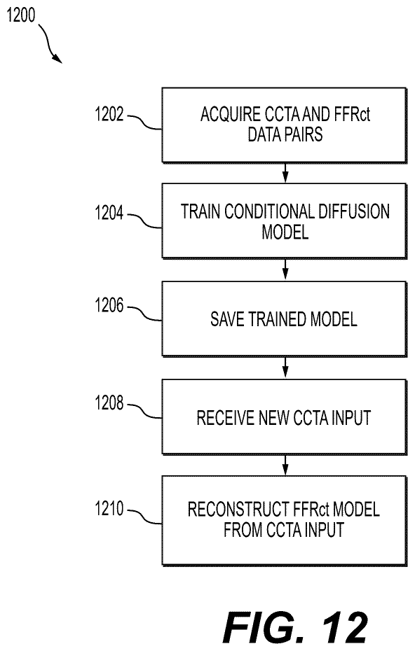

FIG. 12 depicts an exemplary method 1200 for training a generative AI model to map directly from CCTA data to FFRct values. In step 1202, the process may include acquiring pairs of CCTA datasets and corresponding Fractional Flow Reserve computed tomography (FFRct) values. These datasets can be obtained from various clinical sources, including multiple healthcare institutions to ensure diversity in patient demographics and disease presentations. The acquired CCTA datasets may undergo quality assessment procedures to verify suitability for model training, which could include evaluation of image resolution, contrast quality, and anatomical coverage parameters.

Still referring to FIG. 12, in step 1204, the method 1200 may include training a conditional diffusion model on the acquired datasets CCTA and FFRct data pairs, using signed distance maps and FFRct values as the geometric and functional representations of coronary anatomy. The signed distance map approach may provide a mathematical representation of the coronary lumen geometry where each point in the three-dimensional space can be assigned a value corresponding to its distance from the vessel boundary, with negative values inside the lumen and positive values outside. This representation may offer advantages for modeling complex vessel geometries compared to binary segmentation masks, as it can preserve detailed spatial information about vessel dimensions and morphology, including subtle features such as small branch vessels, eccentric stenoses, and complex plaque formations. The FFRct values may be incorporated as additional channels or conditioning variables that provide functional information about hemodynamic significance of coronary stenoses, enabling the conditional diffusion model to learn relationships between anatomical geometry and physiological impact. The conditioning process may involve various technical approaches, including feature concatenation, cross-attention mechanisms, or specialized embedding techniques that allow the diffusion model to generate geometry representations that are consistent with specified functional parameters.

The resulting trained conditional diffusion model may be capable of generating detailed geometric representations of coronary lumen boundaries, plaque distributions, and vessel wall characteristics that affect coronary blood flow patterns. These representations could include high-resolution surface meshes, volumetric models, or other geometric formats suitable for subsequent computational analysis. The physiological components of the generated FFRct models may include pressure and flow values computed at multiple locations throughout the coronary tree, enabling comprehensive assessment of hemodynamic conditions and identification of functionally significant coronary lesions. The conditional diffusion model may also provide uncertainty estimates or confidence scores associated with generated geometries and predicted functional values, allowing clinicians to assess the reliability of model outputs for specific patient cases or anatomical regions.

The direct mapping system may be configured to process either raw CCTA data or pre-extracted geometric models as input, providing flexibility in the analysis pipeline and enabling integration with existing clinical workflows. When processing raw computed tomography images, the system may incorporate image pre-processing capabilities that standardize image characteristics, reduce noise, and enhance relevant anatomical features before applying the direct mapping algorithms. When processing pre-extracted geometric models, the system may utilize existing coronary tree segmentations, geometric models, and/or centerline representations as input, potentially reducing computational requirements while maintaining the ability to generate comprehensive physiological assessments.

In step 1206, the trained model may be saved.

The trained model may be utilized in various clinical applications, including rapid assessment of coronary anatomy, prediction of functional significance without requiring full computational fluid dynamics simulations, and generation of patient-specific anatomical models for treatment planning purposes. Referring to FIG. 12, in step 1208, the method 1200 may include receiving a new CCTA dataset as input for analysis. The new CCTA dataset may undergo pre-processing steps which could include image normalization, noise reduction, and quality assessment to ensure compatibility with the trained model. This pre-processing step may involve extracting relevant features from the CCTA images, generating signed distance maps of coronary anatomy, and applying the conditional diffusion model to predict functional and anatomical parameters.

In step 1210, the method 1200 may include processing the acquired data set through the trained conditional diffusion model in step 1204. The conditional diffusion model may process the dataset in a single pass or through multiple iterative steps depending on the specific implementation of the diffusion process. The processing step may optionally involve generating intermediate representations that capture various aspects of coronary anatomy and pathology, which may be useful for diagnostic purposes or quality control. The processing step may be performed on specialized hardware such as graphics processing units or tensor processing units to accelerate computation, potentially enabling near real-time analysis of complex CCTA datasets. The method 1200 may also incorporate adaptive processing techniques that adjust computational resources based on the complexity of specific anatomical regions or pathological features present in the dataset.

In step 1212, the method 1200 may include reconstructing an FFRct model from the output of the trained conditional diffusion model. This reconstruction process may involve converting the model's output representations into clinically meaningful formats that characterize coronary hemodynamics and functional significance of stenoses. The reconstruction can include generating three-dimensional models of coronary anatomy with color-coded FFRct values mapped onto vessel surfaces, creating curved multiplanar reformations with superimposed pressure gradient information, or producing quantitative metrics such as minimum FFRct values for specific coronary segments or the entire anatomy. The method 1200 may optionally include applying post-processing techniques to enhance visualization quality or to standardize output formats for integration with existing clinical workflows and reporting systems. The reconstructed FFRct model could be presented through various visualization approaches including interactive three-dimensional renderings, standardized two-dimensional views of key anatomical regions, or summary reports that highlight functionally significant lesions requiring clinical attention. The method 1200 may also include providing confidence estimates or uncertainty metrics associated with different regions of the reconstructed model, potentially helping clinicians identify areas where model predictions may be less reliable due to image quality limitations, unusual anatomical configurations, or other factors that could affect prediction accuracy. The reconstructed FFRct model may be used for various clinical applications including assessment of lesion-specific ischemia, treatment planning for revascularization procedures, or longitudinal monitoring of coronary disease progression.

The direct mapping approach, using a generative AI model similar to the one used for FFRct analysis, may be extended to generate various types of clinical indices and assessments beyond fractional flow reserve computed tomography models. Indications of coronary microvascular disease may be generated directly from computed tomography (CT) images by training AI (i.e., machine learning) models to recognize image patterns associated with microvascular dysfunction and impaired coronary flow reserve. The microvascular assessment capability may enable identification of patients with symptoms suggestive of coronary artery disease but without significant epicardial stenoses, providing insights into coronary microvascular function that may not be apparent through traditional anatomical assessments alone.

Assessments of percent-myocardium at risk may be generated through direct mapping approaches, using a generative AI model similar to the one used for FFRct analysis. These percent-myocardium-at-risk assessments analyze computed tomography images to identify coronary territories and assess the myocardial regions that may be affected by coronary artery stenoses. The percent-myocardium-at-risk calculation may involve segmenting myocardial regions, identifying coronary artery territories, and assessing the functional significance of coronary lesions to determine the proportion of myocardium that may be at risk for ischemic events. The direct mapping approach may enable rapid assessment of myocardial risk without requiring separate myocardial segmentation and coronary territory assignment procedures.

Another use of the direct mapping approach described above is the assessment of degree of stenoses may be performed on a per-lesion basis, similar to approaches used for FFRct analysis, or may involve determining maximum percent diameter stenosis (% DS) for the entire image volume. For evaluation of stenosis degree and anatomical location, a direct mapping approach may be implemented to transform CCTA image data into a schematic representation of coronary anatomy, such as a spider diagram or similar visualization format that may be incorporated into clinical reporting systems. This schematic view may highlight locations of luminal narrowing or atherosclerotic plaque deposits to provide clinicians with an immediate overview of disease distribution and severity. The mapping process may optionally include an intermediate step involving construction of a three-dimensional geometric model of the coronary anatomy, or alternatively may generate a two-dimensional schematic representation directly from the imaging data without requiring explicit geometric modeling steps.

In some embodiments, the direct mapping approach described above may be used for direct estimation of minimum FFRct values may be performed without requiring construction of an explicit geometric model of the coronary anatomy. This approach may utilize machine learning algorithms or other computational methods that can analyze CCTA imaging data and derive physiological parameters directly from image features, potentially reducing computational complexity and processing time while maintaining clinical accuracy for fractional flow reserve assessment.

The computational efficiency advantages of direct mapping approaches may enable real-time or near-real-time generation of clinical assessments, potentially supporting point-of-care applications and rapid clinical decision-making scenarios. The direct mapping methodology may reduce the computational time required for clinical assessments by eliminating intermediate processing steps such as detailed geometric reconstruction, mesh generation, and computational fluid dynamics calculations that are typically required in traditional analysis pipelines. The efficiency improvements may enable broader clinical adoption of advanced physiological assessments by reducing the computational resources and processing time required for routine clinical applications.

### Using Multiple Input Types for Predictions

Multi-modal input processing for enhanced prediction may enable the integration of diverse data sources to improve clinical prediction accuracy and expand the scope of cardiovascular assessment capabilities. The multi-modal approach may involve combining information from different imaging modalities, electronic medical records, wearable device signals, and other clinical data sources to create comprehensive patient representations that capture multiple aspects of cardiovascular health and disease. The integration of multiple data types may provide complementary information that enhances the predictive power of machine learning models beyond what can be achieved using single-modality approaches, potentially enabling more accurate risk assessment, disease characterization, and treatment planning capabilities.

Inputs may include various types of data that are commonly available in clinical practice and research settings, such as medical imaging data. Modalities for medical imaging data may include coronary computed tomography angiography (CCTA), cardiac magnetic resonance imaging (CMR), echocardiography, nuclear perfusion imaging, and conventional radiography. Each imaging modality may contribute a different type of information about cardiovascular structure and function. For example, CCTA provides detailed coronary anatomy visualization, magnetic resonance imaging provides comprehensive cardiac morphology and function assessment, and nuclear imaging techniques provides perfusion and metabolic information that may not be available through other modalities.

Inputs may also include data from electronic medical records. Electronic medical record data provides structured and unstructured clinical information relevant to cardiovascular health assessment. Structured electronic medical record data may include laboratory test results, vital sign measurements, medication histories, and diagnostic codes that characterize patient health status and treatment history. Laboratory test results may encompass lipid profiles, inflammatory markers, cardiac biomarkers, and other blood-based measurements that provide insights into cardiovascular risk factors and disease activity. Vital sign measurements may include blood pressure measurements, heart rate patterns, and other physiological parameters that reflect cardiovascular function and may change over time in response to disease progression or treatment interventions. Unstructured electronic medical record data may include clinical notes, radiology reports, and other text-based documentation that contains detailed clinical observations and assessments that may not be captured in structured data fields. Natural language processing techniques may be employed to extract relevant clinical information from unstructured text data, enabling the multi-modal system to incorporate qualitative clinical assessments and detailed patient history information that may influence cardiovascular risk and treatment outcomes. The text processing component may identify mentions of symptoms, clinical findings, family history information, and other narrative clinical data that provide context for quantitative measurements and imaging findings.

Genetic data may represent another category of multi-modal input that may potentially enhance cardiovascular risk assessment and treatment planning capabilities. Genomic information may include various types of genetic markers such as single nucleotide polymorphisms (SNPs), copy number variations, gene expression profiles, or other molecular signatures that may be associated with cardiovascular disease susceptibility, progression patterns, or treatment response characteristics. In some embodiments, the genetic data may encompass information about hereditary conditions, familial risk factors, or pharmacogenomic markers that could influence medication selection and dosing strategies. The integration of genetic information with imaging and clinical data may enable more personalized risk stratification approaches that account for individual genetic predispositions alongside observable clinical parameters. In certain implementations, the system may utilize machine learning approaches to identify novel genetic biomarkers or gene-environment interactions that contribute to cardiovascular outcomes, potentially expanding the understanding of disease mechanisms and therapeutic targets. The genetic data processing may involve various bioinformatics techniques for quality control, variant calling, and pathway analysis to extract clinically relevant information that can be incorporated into the multi-modal analysis framework.

Electrocardiogram (EKG) data may be incorporated into the system to provide additional cardiovascular assessment capabilities. The system may be configured to process both single-lead and 12-lead EKG recordings to extract relevant cardiac rhythm and conduction parameters. In some embodiments, the EKG data may be analyzed in conjunction with imaging modalities to provide comprehensive cardiac evaluation and risk stratification.

Wearable device signals, may provide continuous monitoring data that captures cardiovascular function and activity patterns over extended time periods outside of clinical settings. Heart rate monitoring data from wearable devices may provide insights into cardiac rhythm patterns, exercise capacity, and autonomic nervous system function that may be relevant for cardiovascular risk assessment. Activity monitoring data may capture physical activity levels, sleep patterns, and other behavioral factors that influence cardiovascular health and may affect disease progression patterns. The continuous nature of wearable device data may enable the detection of temporal patterns and trends that may not be apparent from episodic clinical measurements obtained during healthcare encounters.

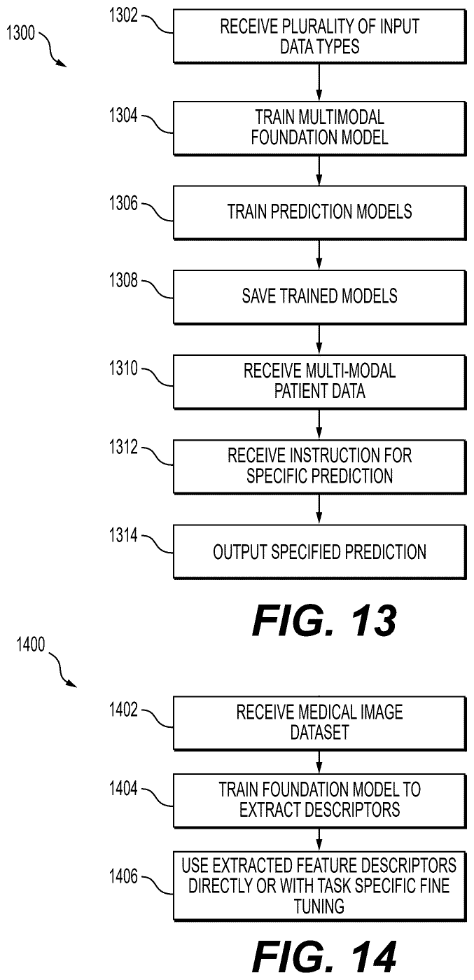

FIG. 13 illustrates an exemplary method 1300 for training and utilizing a multi-modal foundation model to generate a cardiovascular prediction. At step 1302, the method 1300 may include receiving a plurality of multi-modal input data of different modalities, The plurality of multi-modal input data may include data from different modalities, such as medical imaging data, electronic medical record information, wearable device signals, and/or other clinical parameters. Receiving the plurality of multi-modal input data may involve aggregating information from various sources including picture archiving and communication systems for imaging data, electronic health record systems for clinical documentation, and wearable device platforms for continuous monitoring information.

In step 1304, the method 1300 may include training a multi-modal foundation model using the received multi-modal input data. The multi-modal foundation model training methodology may involve developing unified representation learning approaches that can process and integrate information from diverse data sources while preserving the unique characteristics and information content of each modality. Training the multi-modal foundation model may involve extracting meaningful, modality-specific representations from each type of input data using one or more modality-specific encoders, followed by combining the modality-specific representations into a unified multi-modal embedding using one or more fusion approaches or technique.

The one or more modality-specific encoders may include imaging-specific encoders and/or text-specific encoders. Imaging-specific encoders may utilize convolutional neural network architectures or vision transformer models that are optimized for processing medical image data and extracting anatomical and pathological features relevant to cardiovascular assessment. Text-specific encoders may employ natural language processing models such as transformer-based language models that can process clinical text data and extract semantic information relevant to patient health status and clinical context. The modality-specific encoders may perform self-supervised learning techniques that enable the multi-model foundation model to learn meaningful representations from large amounts of unlabeled data without requiring extensive manual annotation of training examples. Self-supervised learning approaches may include contrastive learning methods that train encoders to distinguish between different types of input data while learning to group similar examples together in the learned representation space. Masked reconstruction approaches may involve training encoders to reconstruct missing portions of input data, encouraging the models to learn comprehensive representations that capture the underlying structure and patterns present in each data modality.

The one or more fusion approaches may combine information from different data sources while preserving the complementary information provided by each modality. Early fusion approaches may involve concatenating or combining features from different modalities at early stages of the model architecture, enabling the system to learn joint representations that capture interactions between different types of input data. Late fusion approaches may involve processing each modality separately through modality-specific networks and combining the resulting representations at later stages of the model architecture, potentially preserving modality-specific information while enabling cross-modal interactions. Slow or middle fusion may represent an intermediate approach between early and late fusion strategies, potentially offering balanced advantages for certain multimodal integration scenarios. This intermediate fusion methodology may combine features at various stages of processing, allowing the system to capture both low-level and high-level relationships between different data modalities. For combining certain modalities, late fusion approaches may provide more advantageous characteristics, particularly when the modalities have distinct feature representations or when preserving modality-specific information is important for the specific clinical application.

Attention-based fusion mechanisms may provide flexible approaches for combining multi-modal information by learning to weight the contributions of different modalities based on their relevance to specific prediction tasks or clinical scenarios. The attention mechanisms may enable the model to dynamically adjust the relative importance of different data sources based on the availability and quality of information from each modality for individual patients. Cross-modal attention approaches may enable the model to learn relationships between features from different modalities, potentially identifying complementary patterns that enhance prediction accuracy beyond what can be achieved using individual modalities alone.

In step 1306, the method 1300 may include training one or more prediction models based on the output of the trained multi-modal foundation model. Training the one or more prediction models may involve fine-tuning the foundation model representations for specific clinical applications while preserving the general-purpose capabilities learned during the training of the multi-modal foundation model. The one or more prediction models may be trained to perform tasks including cardiovascular event prediction, disease classification, treatment response assessment, risk stratification, and/or generation of counterfactual images based on the output of the multi-modal foundation model. Generation of counterfactual images may enable the system to produce synthetic medical images that represent alternative clinical scenarios or treatment outcomes based on modifications to specific input parameters while maintaining consistency with the underlying patient characteristics captured in the multi-modal representation.

Cardiovascular event prediction tasks may involve training the model to predict the occurrence of major adverse cardiovascular events such as myocardial infarction, stroke, or cardiovascular death based on the integrated multi-modal input data. The event prediction training may enable the model to learn representations that capture risk factors and disease patterns that are distributed across multiple data modalities, potentially identifying subtle relationships between imaging findings, clinical parameters, and wearable device measurements that contribute to cardiovascular risk.

Disease classification tasks may involve training the model to identify various cardiovascular conditions and comorbidities based on the multi-modal input data. The classification training may enable the model to learn to recognize disease patterns that may be apparent across multiple data sources, such as imaging findings that correlate with specific laboratory abnormalities or wearable device patterns that are associated with particular clinical conditions. The multi-modal disease classification capability may provide more comprehensive and accurate diagnostic assessments compared to single-modality approaches by leveraging complementary information from different data sources.

Treatment response prediction tasks may involve training the model to predict how patients may respond to various therapeutic interventions based on baseline multi-modal characteristics. The treatment response prediction training may enable the model to identify patient characteristics that are predictive of treatment success or failure, potentially enabling more personalized treatment selection and optimization. The multi-modal approach may capture treatment response predictors that span multiple data domains, such as imaging features that interact with genetic factors or wearable device patterns that correlate with medication adherence and treatment effectiveness.

The handling of missing data represents a significant challenge in multi-modal systems where different patients may have different combinations of available data modalities. The multi-modal foundation model may incorporate various strategies for handling missing modalities or incomplete data within modalities. Imputation approaches may involve training the model to predict missing data values based on available information from other modalities, enabling the system to provide predictions even when some data sources are not available for specific patients. The imputation process may utilize the learned relationships between different modalities to generate plausible estimates of missing data values that are consistent with the available information.

Robust prediction approaches may involve training the model to provide accurate predictions across various combinations of available input modalities, enabling the system to adapt to different data availability scenarios without requiring complete data for all patients. The robust prediction training may involve exposing the model to various patterns of missing data during training, encouraging the model to learn representations that can accommodate different data availability patterns. The approach may enable the system to provide predictions with appropriate confidence levels that reflect the amount and quality of available input data for each patient.

The prediction model training for counterfactual image generation may involve specialized architectures that leverage the multi-modal foundation model representations to produce synthetic medical images representing alternative clinical scenarios or treatment outcomes. The counterfactual generation training process may utilize the unified multi-modal embeddings as conditioning variables that guide the synthesis of medical images with specific desired characteristics while maintaining consistency with the underlying patient anatomy and pathology captured in the foundation model representations.

The counterfactual image generation models may be implemented using various generative architectures including conditional generative adversarial networks, variational autoencoders, or diffusion models that have been adapted to work with multi-modal conditioning inputs. The conditioning process may involve feeding the multi-modal foundation model embeddings into the generative model through various mechanisms such as feature concatenation, cross-attention layers, or adaptive normalization techniques that enable the generative model to incorporate information from multiple data modalities when synthesizing counterfactual images.

The training methodology for counterfactual generation may involve collecting paired datasets that include baseline multi-modal patient data along with corresponding medical images that represent different clinical states or intervention outcomes. The paired training data may encompass scenarios such as pre-intervention and post-intervention imaging studies, disease progression sequences, or treatment response examples that provide ground truth targets for the counterfactual generation process. The training process may involve optimizing the generative model to produce synthetic images that accurately reflect the specified counterfactual conditions while maintaining anatomical plausibility and clinical realism.

The loss functions used in counterfactual image generation training may incorporate multiple components that ensure both visual quality and clinical validity of the generated images. Reconstruction losses may measure the similarity between generated counterfactual images and reference target images when available, encouraging the model to produce accurate representations of the desired clinical scenarios. Adversarial losses may be employed through discriminator networks that evaluate the realism of generated images, providing feedback that encourages the generation of visually convincing and anatomically plausible synthetic medical images.

Consistency losses may be incorporated to ensure that generated counterfactual images remain consistent with the patient-specific characteristics encoded in the multi-modal foundation model representations. These consistency constraints may prevent the generation of anatomically implausible scenarios while allowing for clinically meaningful modifications that reflect the specified counterfactual conditions. The consistency enforcement may involve comparing features extracted from generated images with expected feature patterns derived from the multi-modal patient representations.

The training process may incorporate causal reasoning components that enable the counterfactual generation model to understand the relationships between different clinical variables and their effects on medical image appearance. The causal modeling approach may involve learning directed relationships between intervention variables, patient characteristics, and imaging outcomes, enabling the generation of counterfactual images that accurately reflect the expected effects of specific clinical modifications or treatment interventions.

Multi-task learning approaches may be employed during the training of counterfactual generation models to enable simultaneous optimization for multiple types of counterfactual scenarios. The multi-task framework may involve training the model to generate counterfactual images for various clinical applications such as treatment planning, disease progression modeling, or intervention outcome prediction using shared model parameters while maintaining task-specific output layers or conditioning mechanisms.

The training methodology may incorporate uncertainty quantification techniques that enable the counterfactual generation model to provide confidence estimates or uncertainty measures associated with generated synthetic images. Bayesian approaches may be employed to model parameter uncertainty in the generative model, while ensemble methods may provide uncertainty estimates based on variability across multiple model instances trained with different initialization or data sampling strategies.

The multi-modal system may incorporate uncertainty quantification approaches that provide information about the reliability and confidence associated with predictions based on different combinations of input modalities. The uncertainty estimation may account for both the inherent variability in clinical outcomes and the additional uncertainty introduced by missing or incomplete data. The uncertainty quantification may enable clinicians to interpret predictions appropriately and may guide decisions about whether additional data collection may be beneficial for improving prediction accuracy for specific patients.

In one embodiment, the system may train the multi-modal model using comprehensive datasets that include multiple data modalities, and then develop specialized inference techniques that can operate effectively with single modality inputs. This approach may help address some of the limitations associated with missing data scenarios that commonly occur in clinical practice. The single-modality inference capability may leverage the rich cross-modal representations learned during the multimodal training phase, potentially enabling the system to make informed predictions even when only a subset of the originally trained modalities is available. This methodology may exploit principles from multi-view learning, where the model learns to extract complementary information from different data perspectives during training, and then applies this knowledge to make robust inferences from incomplete input data. In some implementations, the system may incorporate attention mechanisms or feature imputation techniques that can compensate for missing modalities by utilizing the learned relationships between different data types. The single-modality inference approach may be particularly valuable in clinical scenarios where certain imaging studies or diagnostic tests may be contraindicated, unavailable, or delayed, allowing the system to provide useful clinical insights based on the available data while maintaining awareness of the limitations associated with incomplete information.

In step 1308, the method 1300 may involve saving the trained multi-modal foundation model and associated prediction models to persistent storage for subsequent clinical deployment.

In step 1310, the method 1300 may include receiving multi-modal patient data for analysis. The patient data may include various combinations of imaging studies, clinical measurements, wearable device recordings, and other relevant information that are available for the specific patient being assessed. The data reception process may involve pre-processing steps that standardize data formats, handle missing modalities, and prepare the input data for processing by the trained system.

In step 1312, the method 1300 may involve receiving instructions for a specific prediction task that should be performed using the multi-modal patient data. The instruction specification may include details about the type of prediction desired, the time horizon for risk assessment, or other parameters that guide the analysis process. For example, the instructions for a specific prediction task may be a request for a cardiovascular event prediction, a disease classification, a treatment response assessment, a risk stratification, and/or generation of counterfactual images.

In step 1314, the method 1300 may include outputting the specified prediction based on the multi-modal patient data and the output of the trained multi-modal foundation model. The prediction output may be in a format such as a quantitative risk score, a classification result, a confidence estimate, and/or any other clinically relevant assessment that can inform clinical decision-making. The output generation process may incorporate one or more uncertainty quantification techniques that provide information about the reliability of predictions based on the available data modalities and their quality characteristics.

The temporal modeling capabilities of multi-modal systems may enable the integration of longitudinal data from different modalities to address challenges including missing data and data collected at different time points. The temporal integration may involve processing sequences of imaging studies, laboratory measurements, and wearable device data to identify trends and patterns that may be predictive of future clinical outcomes. The model may be configured to handle temporal data from different time points, potentially making it more robust and generalizable across diverse clinical scenarios where data availability and timing may vary. The longitudinal multi-modal approach may provide insights into disease progression mechanisms that involve interactions between different physiological systems and may enable more accurate prediction of long-term outcomes compared to cross-sectional single-time-point assessments.

The scalability considerations for multi-modal foundation models may involve developing efficient architectures and training procedures that can handle large-scale datasets with diverse data types and varying data availability patterns. The scalability challenges may include computational requirements for processing multiple data modalities simultaneously, storage requirements for large multi-modal datasets, and training efficiency considerations for models that must learn representations across diverse data domains. Distributed training approaches may be employed to enable efficient training of large multi-modal models using multiple computational resources, potentially enabling the development of foundation models that can leverage extensive multi-modal datasets for improved clinical prediction capabilities.

### Learning Spatial Anatomical Feature Descriptors

Learning spatial anatomical feature descriptors from local coronary image patches may enable the extraction of meaningful representations from coronary computed tomography angiography data. An artificial intelligence model, such as a foundation model, may be trained using large datasets of CCTA images to learn feature descriptors that capture anatomical location information and structural characteristics of coronary arteries. The training process may focus on local coronary image patches extracted from curved planar reconstruction sections or three-dimensional patches sampled from regions near coronary arteries, where each patch represents a localized view of coronary anatomy that contains spatial and morphological information relevant to anatomical characterization.

The foundation model may be trained to assign similar descriptors to patches sampled from similar coronary locations, enabling the system to learn anatomical correspondence patterns across different patients and imaging acquisitions. Similar coronary locations may be defined based on various anatomical classification schemes, including proximal, mid, and distal segments of major coronary vessels, specific coronary artery territories such as left main, left anterior descending, left circumflex artery, and right coronary artery, or standardized segmentation schemes such as Society for Cardiovascular Computed Tomography (SCCT) segments. Alternatively, the topology of a coronary tree model extracted from the CCTA image itself may be used. Tree segments, possibly divided into smaller fixed-length segments, may provide an automatic partitioning of the coronary anatomy without predefined semantic labels. The similarity assignment process may also incorporate distance-based measures such as distance to ostium or relative position along coronary centerlines to provide continuous spatial reference frameworks for anatomical location characterization.

Self-supervised learning techniques may provide the foundation for training the spatial anatomical feature descriptor model without requiring extensive manual annotations of anatomical locations. Contrastive learning approaches may be employed to train the model by learning to distinguish between patches from different anatomical locations while grouping together patches from similar locations. The contrastive learning process may involve creating positive pairs of patches that originate from similar anatomical locations and negative pairs of patches that originate from different anatomical locations. The model may learn to minimize the distance between feature representations of positive pairs while maximizing the distance between feature representations of negative pairs in the learned feature space.

Masked auto-encoder techniques may provide an alternative self-supervised learning approach for spatial anatomical feature descriptor training. The masked auto-encoder methodology may involve randomly masking portions of coronary image patches and training the model to reconstruct the masked regions based on the visible portions of the patches. The reconstruction process may encourage the model to learn meaningful representations of coronary anatomy that capture both local structural details and broader anatomical context information. The learned representations may encode spatial relationships between different parts of coronary structures and may capture anatomical patterns that are consistent across different patients and imaging conditions.

The training process for spatial anatomical feature descriptors may incorporate anatomical location information as part of a causal modeling framework. Anatomical location variables may be included as causal factors that influence the appearance characteristics of coronary image patches, enabling the model to learn the relationships between spatial position and morphological features. The causal modeling approach may help the model learn to disentangle anatomical location information from other factors such as disease state, image quality, and patient-specific variations, resulting in feature descriptors that primarily capture spatial anatomical characteristics rather than confounding factors.

The foundation model training may involve processing coronary image patches at multiple scales and orientations to capture comprehensive anatomical information. Multi-scale processing may enable the model to learn feature descriptors that capture both fine-grained local details and broader anatomical context information. Different patch sizes may provide different levels of anatomical detail, with smaller patches capturing local vessel wall characteristics and larger patches capturing broader anatomical relationships and vessel topology information. Multi-orientation processing may enable the model to learn rotation-invariant feature representations that remain consistent across different viewing angles and patient positioning variations.

FIG. 14 depicts an exemplary method 1400 for extracting and using spatial anatomical feature descriptors based on a medical images dataset. In step 1402, method 1400 may include receiving a medical images dataset. In some embodiments, the medical images dataset may comprise coronary computed tomography angiography (CCTA) images. The medical images dataset may include images from multiple patients, potentially representing various anatomical variations, disease states, and acquisition parameters to ensure comprehensive representation of cardiovascular structures. In certain implementations, the medical images dataset may undergo pre-processing steps such as intensity and/or spatial normalization, artifact reduction, or quality assessment to enhance the subsequent feature learning process.

In step 1404, the method 1400 may include training a foundation model to extract a descriptor from local patches in the medical images dataset. In some instances, where the medical images include CCTA images, the local patches may be 3D patches sampled near coronary arteries, optionally oriented based on local vessel direction, or stacked cross-sectional patches along the vessels as obtained by curved planar reformation (CPR). Patches may be sampled from similar coronary locations (proximal, mid, distal; left main (LM), left anterior descending (LAD), left circumflex artery (LCX), right coronary artery (RCA); Society for Cardiovascular Computed Tomography SCCT segments; distance to ostium). The descriptor extraction process may involve deep neural network architectures specifically designed to capture the spatial and anatomical characteristics of cardiovascular structures. The descriptors may encode various features including vessel geometry, wall thickness, calcification patterns, and surrounding tissue characteristics. The training process may incorporate anatomical knowledge to ensure that the learned descriptors reflect clinically relevant features and maintain consistency across different patients and imaging conditions.

Anatomical location information may be included in a causal model. This integration of spatial context can enable the foundation model to learn location-specific features that may vary across different regions of the coronary anatomy. For example, the model may learn to recognize that certain plaque characteristics or vessel dimensions have different clinical implications depending on their anatomical location. The causal model framework may help distinguish between correlative and causal relationships in the imaging data, potentially improving the interpretability and clinical relevance of the extracted features. In some implementations, the model may incorporate explicit anatomical coordinate systems or reference frames to provide consistent spatial context across different patients with varying cardiac anatomies.

Training the foundation model may involve using self-supervised techniques to learn such feature descriptors (e.g., contrastive learning, masked auto-encoders). These techniques can leverage large amounts of unlabeled medical imaging data, potentially reducing the need for extensive manual annotations. Contrastive learning methods may train the foundation model to recognize that different views or transformations of the same anatomical structure should have similar representations, while distinct structures should have dissimilar representations. Masked auto-encoder approaches may involve randomly masking portions of the input images and training the model to reconstruct the missing regions, encouraging the learning of robust and generalizable features. In certain implementations, the self-supervised training may incorporate domain-specific augmentations that reflect realistic variations in medical imaging, such as contrast changes, motion artifacts, or noise patterns.

The foundation model may be jointly trained with the models described elsewhere in this disclosure. The joint training approach can enable knowledge sharing and feature reuse across different tasks and modalities, potentially improving overall performance and computational efficiency. In some embodiments, the training process may involve multi-task learning objectives that simultaneously optimize for multiple downstream applications, encouraging the model to learn versatile representations that generalize well across different clinical scenarios. The joint training may incorporate various regularization techniques to prevent overfitting and ensure that the learned features remain clinically relevant and interpretable.

Still referring to FIG. 14, in step 1406, the method 1400 may include directly using the extracted feature descriptors or using the extracted feature descriptors with task-specific fine-tuning.

The spatial anatomical descriptors that may be learned through self-supervised learning approaches can provide generic feature representations that may help differentiate between various anatomical locations within cardiovascular structures. Different downstream clinical tasks may exhibit varying degrees of dependence on precise spatial localization capabilities. For example, image registration tasks may demonstrate the highest dependence on spatial accuracy, as the primary objective of registration involves identifying and matching corresponding anatomical locations across different imaging datasets or time points. In contrast, main vessel labeling tasks that distinguish between the right coronary artery (RCA), left anterior descending artery (LAD), and left circumflex artery (LCx) may have relatively lower spatial dependence requirements, as these tasks primarily involve differentiating between left versus right coronary systems and distinguishing LAD from LCx territories, rather than requiring identification or matching of specific anatomical points. Segment labeling according to the Society of Cardiovascular Computed Tomography (SCCT) standardized model may require a level of anatomical spatial localization that falls between these two extremes, as this task involves identifying specific coronary branches and determining the boundaries between proximal, mid, and distal segments within each vessel.

Fine-tuning in this context may refer to the process of transforming the generic spatial descriptors into task-specific descriptors that may be more relevant for particular clinical applications. This transformation process may involve learning the mapping relationships from the initially extracted spatial anatomical descriptors to specialized descriptors that can effectively separate different anatomical categories or clinical features of interest. For example, the fine-tuning process may enable the development of descriptors that can distinguish between right and left coronary systems, or alternatively, may create descriptors that aid in classifying anatomical locations containing high-risk plaque characteristics versus regions with normal or low-risk tissue properties. The fine-tuning methodology may allow the system to adapt the learned spatial representations to optimize performance for specific downstream tasks while potentially maintaining the foundational spatial understanding developed during the initial self-supervised learning phase.

In some instances, the extracted feature descriptors may be used directly or with task-specific fine-tuning given annotated data for supervision for: coronary vessel tree registration; as feature for risk prediction; and/or as feature for vessel labeling; and/or retrieval of similar patches. For coronary vessel tree registration, the descriptors may facilitate alignment of coronary structures across different timepoints or imaging modalities, potentially enabling more accurate and localized assessment of disease progression or treatment response. In risk prediction applications, the descriptors may serve as input features for machine learning models that estimate the likelihood of adverse cardiovascular events based on imaging characteristics. For vessel labeling tasks, the descriptors may help identify and classify different segments of the coronary tree according to standardized anatomical nomenclature. In retrieval applications, the descriptors may enable content-based image retrieval systems that can identify similar anatomical structures or pathological patterns across different patients, potentially supporting case-based reasoning or educational applications in clinical settings.

Coronary vessel tree registration applications may benefit from the spatial anatomical feature descriptors by enabling accurate alignment of coronary structures across different imaging acquisitions or between different patients. The feature descriptors may provide robust correspondence information that can guide registration algorithms in identifying matching anatomical locations between different coronary tree representations. The spatial consistency of the learned descriptors may enable registration algorithms to establish accurate correspondences even in the presence of anatomical variations, imaging artifacts, or differences in acquisition parameters between the images being registered.

Risk prediction applications may leverage the spatial anatomical feature descriptors as input features for machine learning models that assess cardiovascular risk based on coronary anatomy characteristics. The descriptors may capture anatomical patterns and spatial distributions of coronary structures that are associated with different risk profiles. The spatial information encoded in the descriptors may enable risk prediction models to account for the anatomical location of disease or structural abnormalities, which may influence the clinical significance and prognostic implications of observed pathological changes. The standardized nature of the feature descriptors may enable consistent risk assessment across different patients and imaging conditions.

Vessel labeling applications may utilize the spatial anatomical feature descriptors to automatically identify and classify different coronary artery segments based on their anatomical location and structural characteristics. The descriptors may enable automated labeling systems to distinguish between different coronary territories and assign appropriate anatomical labels to coronary segments identified in CCTA images. The spatial consistency of the learned descriptors may improve the accuracy and reliability of automated vessel labeling compared to approaches that rely solely on geometric or topological features without incorporating learned anatomical representations.

Retrieval applications may employ the spatial anatomical feature descriptors to enable similarity-based search and comparison of coronary image patches across large databases of medical images. The descriptors may enable efficient identification of patches that exhibit similar anatomical characteristics or spatial locations, facilitating comparative analysis and case-based reasoning applications. The retrieval capabilities may support clinical decision-making by enabling clinicians to identify similar cases or anatomical presentations from historical data, providing additional context and reference information for current patient assessment and treatment planning.

The joint training approach may enable the spatial anatomical feature descriptor model to be integrated with other generative models and clinical prediction systems described in the broader framework. The shared feature representations learned by the foundation model may provide consistent anatomical encoding across different applications, enabling seamless integration between different components of the comprehensive cardiac imaging analysis system. The joint training methodology may enable the spatial feature descriptors to benefit from the broader clinical context and outcome information available in the integrated system while contributing anatomical location information that enhances the performance of other system components.

Learning to Predict CCTA-derived metrics from Other Modalities

Learning to predict coronary computed tomography angiography-derived metrics (e.g. plaque burden, plaque composition, % diameter stenosis, FFRct) from other modalities, including lower cost modalities (e.g. ECG, echocardiography, stethoscope, or non-contrast computed tomography (NCCT), lung cancer screening CT, abdominal CT), may enable broader access to cardiovascular risk assessment capabilities by utilizing more widely available and economical medical data sources. The cross-modal prediction system may be configured to process various types of lower cost medical data including electrocardiogram recordings, echocardiographic studies, non-contrast computed tomography acquisitions, and other readily available clinical measurements to generate predictions of quantitative parameters that are traditionally derived from coronary computed tomography angiography analysis. The cross-modal prediction approach may provide valuable screening and risk assessment capabilities in clinical settings where coronary computed tomography angiography may not be readily available due to cost constraints, equipment limitations, or patient contraindications.

Patients with lower cost modalities acquired do not always have CCTA scans acquired. Paired data (e.g. CCTA in addition to ECG or echo data) could be processed to provide both CCTA-derived target metrics along with the paired lower-cost modality (/modalities) with which to train a predictive model using the lower-cost modality only as input. While it is possible to acquire paired data for patients, this is also an expensive and sometimes clinically impractical process.

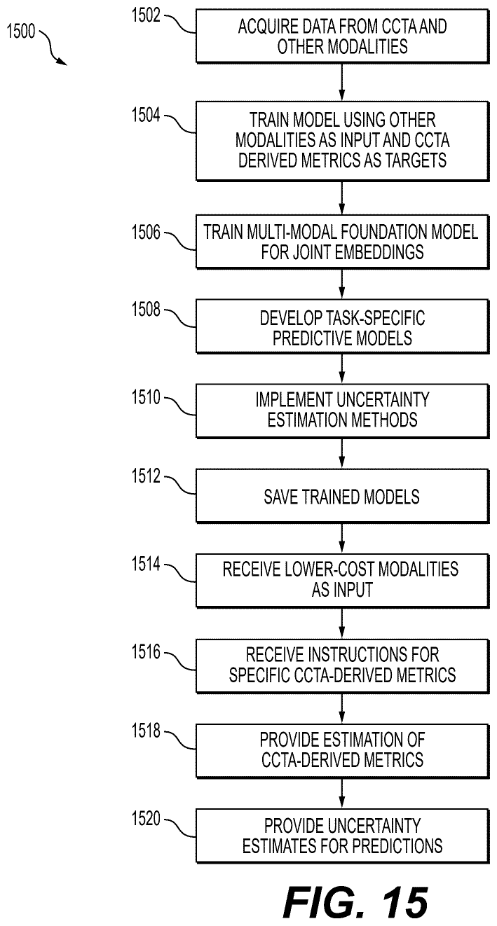

FIG. 15 depicts an exemplary method 1500 for predicting CCTA-derived metrics from lower-cost imaging modalities. In step 1502, method 1500 may include acquiring CCTA data along with paired and optionally unpaired lower-cost modalities. These lower-cost modalities may include echocardiography, electrocardiogram (ECG), non-contrast computed tomography (NCCT), and other more widely available imaging techniques. The acquisition process may involve collecting data from various clinical sources, potentially including multiple healthcare institutions to ensure diversity in patient demographics and disease presentations. In some embodiments, the method 1500 may include implementing data quality assessment procedures to verify the suitability of the acquired images for subsequent model training.

In step 1504, the method 1500 may include training a machine learning model using a lower-cost modality as input and the CCTA-derived metrics as targets for prediction. This training process may involve developing neural network architectures specifically designed to extract relevant features from the lower-cost imaging modalities that correlate with the CCTA-derived metrics of interest. The training process may incorporate various optimization techniques to enhance model performance, including gradient-based methods, regularization approaches, and learning rate scheduling strategies. In some implementations, method 1500 may include applying data augmentation techniques to enhance the diversity of the training dataset and improve model generalization capabilities.

As an extension to the basic training process, method 1500 may leverage unpaired data by training modality-specific foundation models with self-supervised, semi-supervised and supervised learning techniques. The self-supervised learning component may enable the model to learn meaningful representations from unlabeled data by creating auxiliary tasks such as image reconstruction, contrastive learning, or masked feature prediction. These approaches may allow the system to extract valuable information from larger datasets where paired CCTA data may not be available. The semi-supervised learning methods may combine limited labeled data with larger amounts of unlabeled data, potentially using techniques such as consistency regularization, entropy minimization, or pseudo-labeling to leverage information from unlabeled examples.

In step 1506, method 1500 may include training a multi-modal foundation model to learn joint embeddings from pre-trained modality-specific models using paired data. This approach may enable the system to leverage the representations learned from individual modalities while establishing cross-modal relationships that capture complementary information across different imaging techniques. The joint embedding training process may involve various alignment techniques such as contrastive learning across modalities, shared latent space modeling, or attention-based fusion mechanisms that enable effective integration of information from different imaging sources.

Alternatively, method 1500 may include training a multi-modal foundation model from scratch to learn joint embeddings across modalities. This end-to-end training approach may enable more integrated representation learning where cross-modal relationships are established from the beginning of the training process rather than through subsequent alignment of pre-trained models. The from-scratch training methodology may incorporate specialized architectural components designed for multi-modal learning, such as modality-specific encoders followed by fusion networks that combine information across different data sources. In some implementations, the system may employ attention mechanisms that dynamically weight the contributions of different modalities based on their relevance to specific prediction tasks.

In step 1508, method 1500 may include developing one or more task-specific predictive models from the lower-cost inputs and the CCTA-derived metrics as targets, by fine-tuning the pre-trained multi-modal model(s) on this predictive task. The fine-tuning process may involve adapting the general representations learned during foundation model training to the specific task of predicting CCTA-derived metrics from lower-cost imaging modalities. This approach may enable more efficient training compared to developing task-specific models from scratch, as the foundation model may have already learned relevant feature representations that capture important anatomical and pathological patterns. The fine-tuning methodology may incorporate various transfer learning techniques, including layer freezing strategies, learning rate differentiation across model components, and specialized loss functions tailored to the specific CCTA-derived metrics being predicted.

Alternatively, method 1500 may include training a fully-supervised predictive model from scratch using the lower-cost modality as model input and CCTA-derived metrics as targets from paired data only. This approach may be suitable when sufficient paired data is available and when the specific prediction task may benefit from specialized architectural designs that differ from the foundation model structure. The fully-supervised training process may involve direct optimization of model parameters to minimize prediction errors on the CCTA-derived metrics, potentially incorporating domain-specific knowledge about cardiovascular anatomy and pathology into the model architecture and training objectives.

As another alternative, method 1500 may include using semi-supervised learning to simultaneously train a predictive model using a supervised loss while updating the weights of the same models using unsupervised or semi-supervised losses using a larger set of paired and unpaired images from each modality. This hybrid approach may enable the system to leverage both labeled and unlabeled data effectively, potentially improving model performance when paired data is limited. The semi-supervised training methodology may incorporate consistency regularization techniques that encourage the model to produce similar predictions for perturbed versions of the same input, entropy minimization approaches that promote confident predictions on unlabeled data, or pseudo-labeling methods that generate targets for unlabeled examples based on model predictions.

In step 1510, method 1500 may include implementing uncertainty estimation techniques to provide uncertainty estimates for the model predictions. These uncertainty estimation techniques may include Bayesian neural networks that model parameter distributions rather than point estimates, ensemble methods that combine predictions from multiple models trained with different initializations or on different data subsets, Gaussian mixture models (GMMs) that can represent complex output distributions, or test-time augmentation approaches that assess prediction variability across different transformations of the input data. The uncertainty estimation capabilities may enable the system to provide confidence levels associated with predictions, potentially helping clinicians interpret the reliability of the predicted CCTA-derived metrics for individual patients and specific clinical scenarios.

In step 1512, method 1500 may include saving the trained models to persistent storage. This storage process may involve preserving model architectures, learned parameters, normalization statistics, and other components necessary for subsequent deployment and inference. The saved models may be formatted for efficient loading and execution in clinical environments, potentially incorporating optimization techniques such as quantization, pruning, or compilation that enhance inference speed while maintaining prediction accuracy.

In step 1514, method 1500 may include receiving data from other modalities as input to the fine-tuned (or fully supervised) model to predict CCTA-derived metrics. This inference process may involve pre-processing the input images to ensure compatibility with the trained models, including normalization, resampling, or other transformations that align the input data with the characteristics of the training dataset.

In step 1516, method 1500 may include receiving instructions to predict specific CCTA-derived metrics. These instructions may specify which cardiovascular parameters should be estimated from the lower-cost imaging data, potentially including options for different types of metrics or different analysis approaches depending on the clinical requirements. The instruction specification may include details about the desired output format, confidence thresholds, or other parameters that guide the prediction process.

In step 1518, method 1500 may include outputting an estimation of one or more CCTA-derived metrics. These metrics may include plaque volume measurements that quantify the extent of atherosclerotic disease, plaque composition assessments that characterize the material properties of identified plaques, minimum Fractional Flow Reserve computed tomography (FFRct) values that indicate the hemodynamic significance of coronary stenoses, percentage diameter stenosis measurements that quantify the degree of luminal narrowing, and other parameters traditionally derived from CCTA analysis. The predicted metrics may be presented in formats consistent with clinical standards, potentially including numerical values, visual representations, or comparative references that facilitate interpretation in clinical contexts.

In step 1520, method 1500 may include providing one or more uncertainty estimates representing the estimated error associated with model predictions. These uncertainty representations may include confidence intervals, prediction ranges, probability distributions, or other statistical measures that characterize the reliability of the generated estimates. The uncertainty information may be presented alongside the predicted metrics, potentially using visual encodings such as error bars, color gradients, or other graphical elements that facilitate intuitive interpretation of prediction confidence. In some implementations, the system may provide different levels of uncertainty for different metrics or different anatomical regions, reflecting variations in prediction reliability across different aspects of the analysis.

Utilizing Learned Models of Cardiac Motion/Temporal Super-Resolution (Cf. Multi-Frame)

Cardiac motion modeling and temporal super-resolution may enable enhanced temporal characterization of cardiovascular anatomy and improved registration accuracy for cardiac imaging datasets acquired across different cardiac phases. The temporal modeling system may be configured to incorporate cardiac phase percentage information as a conditioning variable within generative model architectures, enabling the system to learn relationships between cardiac phase timing and corresponding anatomical configurations throughout the cardiac cycle. The cardiac phase conditioning approach may provide capabilities for generating synthetic cardiac images at specified temporal positions within the cardiac cycle, potentially enabling interpolation between acquired cardiac phases and enhancement of temporal resolution beyond the native acquisition parameters of the imaging system.

The generative model architecture for cardiac motion modeling may incorporate temporal conditioning mechanisms that enable the system to process cardiac phase percentage information alongside spatial image data to learn phase-specific anatomical patterns. The cardiac phase percentage may represent the temporal position within the cardiac cycle, typically expressed as a value between zero and one hundred percent, where zero percent corresponds to end-diastole and subsequent percentages represent progressive positions through systole and diastole phases. The temporal conditioning process may involve encoding cardiac phase information using embedding networks that convert phase percentage values into high-dimensional representations that can be integrated with image feature representations within the generative model architecture.

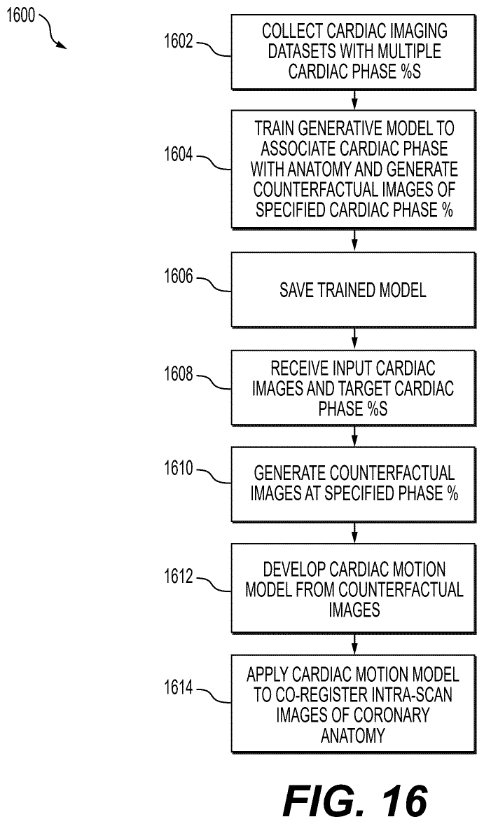

FIG. 16 depicts an exemplary method 1600 for utilizing learned models of cardiac motion. The method may begin in step 1602 with receiving cardiac imaging training datasets including multiple cardiac phases acquired during the same imaging session, providing temporal sequences that characterize cardiac motion patterns throughout complete cardiac cycles. The training datasets may encompass various cardiac imaging modalities including cardiac computed tomography angiography (CCTA) datasets acquired using retrospective electrocardiogram gating techniques that provide multiple cardiac phase reconstructions from the same acquisition. The temporal training datasets may include phase percentage annotations that specify the cardiac timing associated with each image reconstruction, enabling the generative model to learn associations between specific cardiac phases and corresponding anatomical configurations.

The cardiac phase annotation process may involve analyzing electrocardiogram signals recorded during image acquisition to determine the cardiac timing associated with each image reconstruction. The phase percentage calculation may account for variations in cardiac cycle length and may normalize temporal positions to enable consistent phase representation across different patients and heart rate conditions. The normalized phase representation may enable the generative model to learn cardiac motion patterns that are generalizable across different cardiac cycle durations and patient populations, potentially improving the accuracy of motion modeling for patients with varying heart rate characteristics.

In step 1604, the method 1600 may include training a generative AI model to associate specific cardiac phase percentages with corresponding anatomical configurations observed in the temporal training datasets. The model may learn to recognize cardiac motion patterns including ventricular wall motion, coronary artery displacement, and cardiac chamber volume changes that occur throughout the cardiac cycle. The motion pattern learning process may capture both global cardiac motion characteristics that affect overall heart position and orientation, as well as local motion patterns that affect specific anatomical structures such as coronary artery segments or myocardial regions.

The temporal super-resolution capability may enable the generation of cardiac (counterfactual) images at cardiac phase percentages that were not directly acquired during the original imaging session or received for analysis. The super-resolution process may involve specifying desired cardiac phase percentages as input to the trained generative model, which may then produce synthetic images that represent the predicted anatomical configuration at the specified temporal positions. The temporal interpolation approach may enable the creation of high-temporal-resolution cardiac image sequences that provide smoother visualization of cardiac motion patterns compared to the discrete cardiac phases available in the original acquisition.

The cardiac phase inference component of the system may be configured to analyze input cardiac images and automatically determine the cardiac phase percentage associated with observed anatomical configurations. The phase inference process may involve analyzing various anatomical indicators including ventricular chamber dimensions, coronary artery positions, and myocardial wall configurations that change predictably throughout the cardiac cycle. The automatic phase determination capability may enable the system to process cardiac images without requiring explicit cardiac phase annotations, potentially expanding the applicability of the motion modeling approach to datasets where phase information may not be readily available.

In step 1606, the method 1600 may include saving the trained model, in accordance with techniques discussed herein.

In step 1608, the method 1600 may include receiving one or more input cardiac images along with a specified/desired target cardiac phase percentage. The trained model may analyze the input image to infer the current cardiac phase and anatomical configuration, then apply learned motion patterns to generate synthetic images that represent the predicted anatomical appearance at the target cardiac phase. The phase-specific generation process may account for the temporal displacement between the input phase and target phase, applying appropriate motion transformations to produce anatomically consistent results.

In step 1610, the method 1600 may include generating a counterfactual image with the specified cardiac phase percentage.

In step 1612, the method 1600 may include developing an explicit cardiac motion model based on the generated counterfactual image. In some instances, the generative super-resolution model may output deformation with respect to one of the input images.

Developing the cardiac motion model may involve analyzing the generated temporal super-resolution images to extract comprehensive motion patterns that characterize cardiac anatomy displacement throughout the cardiac cycle. Extracting comprehensive motion patterns may involve comparing anatomical positions across different cardiac phases to quantify displacement vectors, deformation patterns, and temporal motion trajectories for various cardiac structures. The extracted motion models may provide detailed characterization of cardiac motion patterns that can be applied to various clinical and technical applications requiring accurate understanding of cardiac anatomy displacement.

In step 1614, the method 1600 may include applying the generated cardiac motion model to co-register intra-scan images of coronary anatomy. Intra-scan co-registration applications may utilize the learned motion models to establish accurate spatial correspondence between cardiac images acquired at different cardiac phases within the same imaging session. The co-registration process may account for cardiac motion patterns to align anatomical structures across different temporal positions, potentially improving the accuracy of temporal analysis and motion assessment procedures.

The intra-scan co-registration methodology may involve applying the learned motion models to transform anatomical coordinates between different cardiac phases, enabling accurate alignment of cardiac structures despite temporal motion effects. The motion-compensated registration process may utilize the motion model predictions to establish correspondence between anatomical landmarks across different cardiac phases, potentially improving registration accuracy compared to approaches that do not account for cardiac motion patterns. The enhanced registration accuracy may enable more reliable temporal analysis of cardiac function and may support applications that require precise tracking of anatomical structures throughout the cardiac cycle.

The motion model validation process may involve comparing predicted motion patterns with observed anatomical displacements in validation datasets to assess the accuracy and reliability of learned motion characteristics. The validation methodology may include quantitative assessments of motion prediction accuracy using metrics such as displacement error measurements, anatomical landmark tracking accuracy, and temporal consistency evaluations. The validation process may also include qualitative assessments of motion model realism through expert review of generated cardiac motion sequences and comparison with expected physiological motion patterns.

The temporal consistency enforcement mechanisms may ensure that generated cardiac images maintain anatomically plausible motion patterns and avoid temporal artifacts that could affect clinical interpretation or analysis accuracy. The consistency enforcement process may involve applying constraints during image generation that ensure smooth temporal transitions between adjacent cardiac phases, maintain physiological motion characteristics throughout generated cardiac cycles, and preserve anatomical characteristics and relative locality of disease patterns. The temporal constraint mechanisms may prevent the generation of implausible motion patterns or anatomical configurations that deviate from expected cardiac physiology.

The multi-scale motion modeling approach may capture cardiac motion patterns at various spatial scales ranging from global heart motion to local myocardial deformation patterns. The multi-scale approach may involve learning motion models that characterize overall cardiac translation and rotation patterns, as well as detailed local motion patterns that affect specific anatomical regions such as coronary artery segments or myocardial territories. The comprehensive motion characterization may enable accurate motion compensation across different spatial scales and anatomical structures within the cardiac anatomy.

The patient-specific motion model adaptation capabilities may enable customization of learned motion patterns based on individual patient characteristics and cardiac function parameters. The adaptation process may involve fine-tuning generic motion models using patient-specific cardiac imaging data to capture individual variations in cardiac motion patterns that may result from differences in cardiac function, anatomical variations, or pathological conditions. The patient-specific adaptation approach may improve motion model accuracy for individual patients while maintaining the benefits of population-based motion pattern learning.

The clinical integration considerations for cardiac motion modeling systems may involve developing interfaces and workflows that enable seamless incorporation of motion-compensated analysis capabilities into existing cardiac imaging analysis procedures. The integration process may include mechanisms for automatic cardiac phase detection, motion model application, and quality control assessment that ensure appropriate utilization of motion modeling capabilities within clinical workflows. The clinical integration approach may provide enhanced analysis capabilities while maintaining compatibility with existing analysis procedures and clinical documentation requirements.

The computational efficiency optimization for cardiac motion modeling may involve developing efficient algorithms and data structures that enable real-time or near-real-time application of motion models during clinical analysis procedures. The efficiency optimization process may include techniques for reducing computational requirements while maintaining motion model accuracy, potentially enabling broader clinical adoption of motion-compensated analysis approaches. The optimized implementation may support interactive clinical applications where rapid motion model application may enhance workflow efficiency and clinical decision-making capabilities.

The uncertainty quantification mechanisms for cardiac motion modeling may provide information about the reliability and confidence associated with predicted motion patterns and generated cardiac images. The uncertainty estimation process may account for various sources of variability including patient-specific motion pattern variations, image quality limitations, and model prediction uncertainty that may affect motion model accuracy. The uncertainty information may guide clinical interpretation of motion-compensated analysis results and may inform decisions about the appropriateness of motion model application for specific clinical scenarios.

The longitudinal motion analysis capabilities may enable tracking of cardiac motion pattern changes over time through comparison of motion models derived from imaging studies acquired at different time points. The longitudinal analysis approach may provide insights into cardiac function changes, disease progression effects, and treatment response patterns that affect cardiac motion characteristics. The cardiac phase prediction described herein may normalize the temporal motion. Comparing the predicted phase to the actual cardiac phase may be used as a biomarker of cardiac function. The temporal motion analysis may support clinical applications including cardiac treatment response assessment, and disease progression evaluation that benefit from detailed characterization of cardiac motion pattern evolution.

### Reverting Anatomy-Altering Changes

Reverting anatomy-altering changes represents an advanced application of generative artificial intelligence models that may enable virtual removal or simulation of clinical interventions such as stenting and coronary artery bypass grafting to facilitate accurate image registration, e.g., for longitudinal disease progression tracking between medical imaging studies acquired at different time points. The anatomy-altering change reversion system may be configured to process medical images that contain evidence of interventional procedures and generate modified versions where the anatomical effects of these interventions have been computationally reversed or simulated. The virtual intervention approach may provide capabilities for establishing spatial correspondences between baseline and follow-up imaging studies where anatomical modifications introduced by clinical procedures would otherwise prevent accurate registration and comparative analysis.

The generative model architecture for anatomy-altering change reversion may be implemented using approaches similar to counterfactual image generation systems.

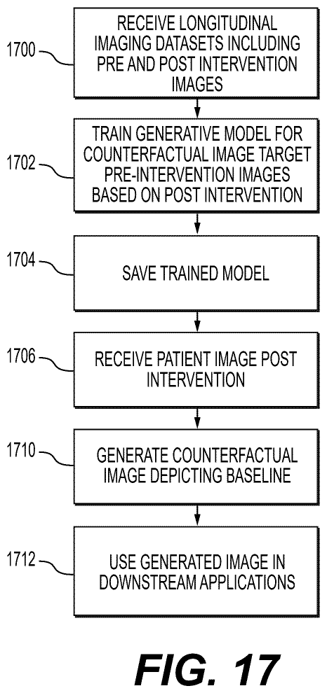

FIG. 17 depicts an exemplary method 1700 for training and generating counterfactual images with reverted anatomy altering changes. In step 1702, the method 1700 may involve receiving one or more longitudinal imaging training datasets that include pre-intervention and post-intervention medical images from patients who have undergone various types of cardiovascular interventions. The training datasets may encompass coronary computed tomography angiography studies acquired before and after percutaneous coronary intervention procedures, coronary artery bypass grafting operations, and other interventional treatments that introduce anatomical changes affecting coronary tree topology and cardiac anatomy.

In step 1704, method 1700 may include training a generative AI model to generate one or more modified (counterfactual) images that represent baseline anatomy before intervention, based on post-intervention image inputs. These modified images may help maintain underlying spatial correspondences between the images, except in regions where information was altered due to the actual intervention.

The virtual stent removal process may involve training a generative AI model to recognize the characteristic appearance of coronary stents in computed tomography images and generate modified (counterfactual) images where stent-related anatomical changes have been computationally reversed. Coronary stents may introduce various types of anatomical modifications including local vessel geometry changes, alterations in coronary tree connectivity patterns, and modifications to vessel wall characteristics that affect the spatial relationships between different coronary segments. The stent removal modeling approach may learn to identify these intervention-related changes and generate counterfactual images that represent the predicted anatomical appearance in the absence of stent placement.

The coronary artery bypass grafting reversion methodology may involve more complex anatomical modifications due to the substantial changes in coronary tree topology that result from surgical bypass procedures. Bypass grafting procedures may introduce new vascular connections between the aorta and coronary arteries, modify existing coronary flow patterns, and alter the spatial relationships between different cardiac structures. The bypass reversion modeling process may learn to recognize bypass graft configurations and generate modified images where the surgical modifications have been computationally removed while preserving the underlying native coronary anatomy that existed prior to surgical intervention.

In step 1706, method 1700 may include saving the trained model to persistent storage, in accordance with techniques presented herein.

In step 1708, method 1700 may include receiving an input image, wherein the input image is a pre- or post-intervention medical image. The system may receive one or more medical images that contain evidence of clinical interventions such as coronary stent placement, bypass grafting, or other anatomical modifications resulting from therapeutic procedures. These medical images may be acquired during follow-up imaging studies performed after interventional procedures and may exhibit various intervention-related features including metallic artifacts from stent materials, altered vessel geometry due to stent expansion, or modified coronary tree topology resulting from bypass grafting procedures. The system may process these post-intervention images through specialized preprocessing steps that identify and characterize intervention-related features to facilitate subsequent counterfactual generation processes.

In step 1710, method 1700 may include generating one or more counterfactual images depicting baseline based on the post-intervention medical image. Generating the one or more counterfactual images depicting baseline may involve applying the trained generative AI model to transform the post-intervention image into a synthetic representation that depicts the predicted anatomical appearance prior to intervention. This transformation may involve computational removal of stent-related features, restoration of pre-intervention vessel geometry, or reversal of bypass graft-related modifications while preserving the underlying native coronary anatomy. The generative AI model may selectively modify intervention-affected regions while maintaining anatomical consistency with unaffected regions, potentially enabling more accurate comparison between pre-intervention and post-intervention anatomical states. The counterfactual generation process may incorporate uncertainty estimation techniques that provide confidence measures associated with different regions of the generated baseline image, potentially helping clinicians identify areas where the model predictions may be more or less reliable based on the complexity of intervention-related changes and image quality factors.

In step 1712, method 1700 may include using one or more counterfactual images depicting baseline in downstream applications. These downstream applications may include longitudinal disease tracking where the counterfactual baseline images enable more accurate assessment of disease progression by establishing spatial correspondence between pre-intervention and post-intervention anatomical states. The counterfactual images may support quantitative analysis of disease changes in vessel segments that would otherwise be obscured by intervention-related modifications (e.g., segments distal to the intervention), potentially enabling more comprehensive evaluation of disease progression patterns throughout the coronary tree. The generated images may also facilitate treatment planning for subsequent interventions by providing visualization of native coronary anatomy that may be partially obscured by existing interventions in the original follow-up images. Additionally, the counterfactual images may support research applications including retrospective analysis of intervention outcomes, comparative effectiveness studies of different intervention approaches, and development of improved intervention planning tools that account for both pre-intervention anatomy and post-intervention modifications.

In one embodiment, the one or more counterfactual images depicting baseline may match or represent the anatomy at a baseline scan by computationally removing interventional modifications such as stents and vessel tree topology changes introduced by bypass grafting procedures. The one or more counterfactual images may serve as intermediate representations that facilitate training of learning-based intra-subject, inter-scan image registration models specifically designed for tracking disease progression over time in patients who have undergone interventional procedures. The registration process may utilize the generated counterfactual images to establish spatial correspondences between baseline and follow-up anatomical states without directly incorporating the generative model during the registration inference phase. This approach may enable more efficient registration processing while benefiting from the anatomical consistency provided by the counterfactual generation process during the model training phase. The generated images may be used primarily to establish spatial correspondences rather than for direct measurement of disease parameters, maintaining a clear separation between the correspondence establishment process and subsequent quantitative disease assessment procedures. The system may also identify image regions with missing correspondences between time points, either through analysis of the generative model's uncertainty estimates or by computing difference images between original and counterfactual representations, potentially highlighting areas where registration accuracy may be limited due to substantial intervention-related modifications or other factors affecting image comparability.

In another embodiment, method 1700 may include using the one or more counterfactual images as direct inputs to the spatial alignment process that registers follow-up images with baseline images. The alignment procedure may involve optimization of image similarity metrics between the counterfactual representation and the baseline image, potentially enabling more accurate registration compared to approaches that attempt to directly align post-intervention images with pre-intervention baselines. The counterfactual transformation may serve as a preprocessing step that enhances the compatibility between images acquired before and after interventional procedures, potentially improving the performance of both conventional intensity-based registration algorithms and learning-based registration models. The registration process may incorporate the counterfactual images as additional input channels or conditioning variables that guide the alignment procedure, providing anatomical context that helps establish more accurate spatial correspondence in regions affected by interventional modifications. This approach may be particularly valuable for complex cases involving multiple interventions or substantial anatomical modifications where direct registration between original images may be challenging due to significant appearance differences. The system may implement various registration methodologies including diffeomorphic transformations, feature-based alignment approaches, or deep learning registration networks that can leverage the anatomical consistency provided by the counterfactual representations to achieve more robust alignment results across diverse clinical scenarios.

### Personalized Anatomical Templates

Personalized anatomical templates may enable standardized spatial reference frameworks for medical image analysis and anatomical correspondence establishment. The personalized template generation system may be configured to learn comprehensive shape spaces that characterize the statistical variations in coronary artery configurations across diverse patient populations, enabling the creation of customized anatomical models that reflect individual patient characteristics while maintaining compatibility with standardized coordinate systems and vessel labeling conventions. The template generation methodology may involve analyzing large collections of coronary anatomy data to extract fundamental patterns of anatomical variation, then utilizing these learned patterns to generate patient-specific templates that provide spatial reference frameworks for various clinical and technical applications.

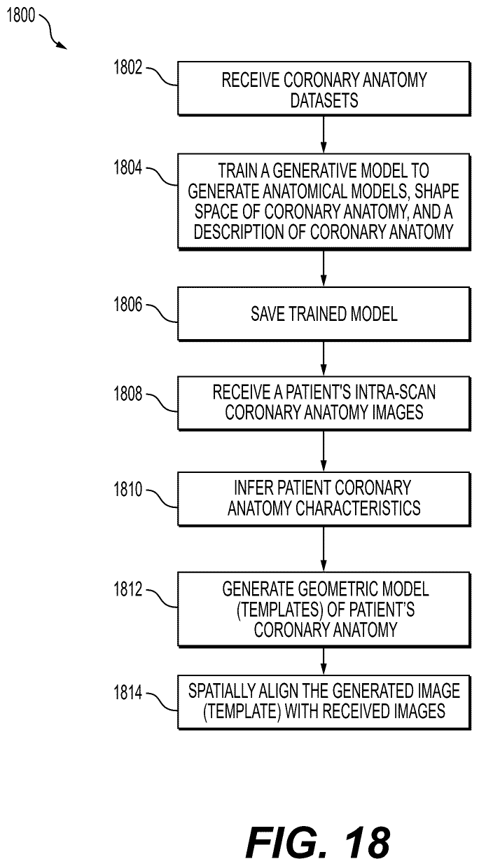

FIG. 18 depicts an exemplary method 1800 to generate and use personalized anatomical templates. In step 1802, the method 1800 may include receiving one or more training datasets of coronary anatomy from multiple sources, including CCTA scans, angiography images, and annotated vessel trees. These training datasets may include various anatomical variations, disease states, and patient demographics to ensure comprehensive representation of coronary anatomical diversity.

In step 1804, the method 1800 may include training a generative AI model to generate anatomical models, shape spaces of coronary anatomies, and/or description of coronary anatomy. The training process may utilize these training datasets to develop a generative model capable of producing anatomical models (geometry, segmentation, synthetic images) of coronary arteries from descriptive parameters. The generative model may be implemented using various machine learning architectures, such as variational autoencoders, generative adversarial networks, or diffusion models, each offering different advantages for anatomical modeling tasks. The training methodology may incorporate both supervised learning approaches using annotated vessel trees and self-supervised techniques that leverage the inherent structure of coronary anatomy data. In some embodiments, the training process may employ curriculum learning strategies where the model initially learns basic vessel structures before progressing to more complex anatomical configurations with multiple branches and variations. The generative process may utilize conditional inputs that specify desired anatomical characteristics, enabling the creation of personalized templates tailored to individual patient parameters while maintaining anatomical plausibility.

The system may learn a shape space of coronary anatomies by analyzing statistical variations in vessel topology, branching patterns, and dimensional characteristics across the population. This shape space may be represented using principal component analysis, non-linear manifold learning techniques, or latent variable models that capture the primary modes of anatomical variation observed in clinical populations. The learning process may involve decomposing coronary tree structures into hierarchical components, potentially including main vessel trajectories, branch insertion points, bifurcation angles, vessel tapering patterns, and tortuosity characteristics. The statistical analysis may identify correlations between different anatomical features, such as relationships between vessel dominance patterns and specific branch configurations or associations between vessel dimensions at different anatomical locations. In some implementations, the shape space may incorporate both global topological features and local geometric characteristics, enabling multi-scale representation of coronary anatomical variations that can be used for template generation and correspondence establishment.

Additionally, the system may develop a standardized descriptive framework for coronary anatomy that captures key features such as dominance patterns, branch presence, and bifurcation relationships. This descriptive framework may incorporate established anatomical classification systems such as the American Heart Association coronary segment numbering scheme, the SYNTAX score anatomical parameters, or the Society for Cardiovascular Computed Tomography (SCCT) segment definitions, while extending these approaches with quantitative parameters that enable more precise characterization of individual variations. The framework may include continuous parameters that describe vessel trajectories using spline representations or other mathematical curve models, as well as discrete parameters that characterize topological features such as the presence or absence of specific branch vessels. The standardized description may also incorporate relative positioning information that characterizes spatial relationships between different coronary structures, potentially using reference coordinate systems based on cardiac landmarks or standardized anatomical planes. In some embodiments, the descriptive framework may be hierarchically organized to represent coronary anatomy at multiple levels of detail, from major vessel territories to specific branch segments, enabling flexible template generation at varying levels of anatomical specificity.

In step 1806, the method 1800 may include saving the trained model to persistent storage, in accordance with techniques presented herein.

In step 1808, the method 1800 may include receiving one or more images of a patient's coronary anatomy (i.e., images of the same anatomy from a single time point). These images may be acquired at different cardiac phases or using different imaging modalities or protocols, optionally providing multiple views of the same coronary anatomy for more robust analysis.

In step 1810, the method 1800 may include inferring characteristics of the patient's coronary anatomy from the one or more images. These characteristics may include coronary dominance patterns (left-dominant, right-dominant, or co-dominant), presence or absence of specific branch vessels (such as ramus intermedius, diagonal branches, or marginal branches), and the relative locations and ordering of bifurcation points with respect to a canonical coordinate system. The inference process may utilize machine learning algorithms trained to recognize these anatomical features from imaging data, potentially incorporating both local feature detection and global context analysis to ensure accurate characterization.

In step 1812, the method 1800 may include generating a geometric model (patient specific template) of the patient's coronary anatomy based on the inferred anatomical characteristics. This personalized template may provide a standardized representation that captures the patient's unique anatomical configuration while maintaining compatibility with population-based reference frameworks. The generated template may establish correspondences between different images of the same anatomy implicitly through the stereotaxic anatomical framework. The template may also include vessel labeling information that identifies different coronary segments according to standard nomenclature, potentially facilitating communication and comparison across different clinical and research contexts.

In step 1814, the method 1800 may include spatially aligning the generated geometric model (patient-specific template) with the obtained images to establish precise anatomical correspondence. This alignment process may utilize registration algorithms that optimize the spatial transformation between the template and image data while preserving the topological characteristics captured in the template generation process. The features used to generate the anatomical model may be distinct from those used for spatial alignment, maintaining separation between anatomical characterization and spatial registration processes. The system may also provide cardiac phase-specific spatial pre-alignment of the template with each input image as a secondary output, potentially enhancing registration accuracy by accounting for cardiac motion effects on coronary anatomy positioning.

### Generating Full CT Text Report for CCTA

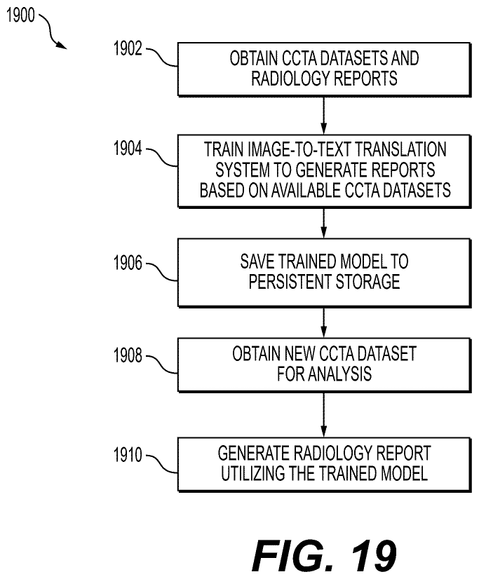

FIG. 19 depicts an exemplary method 1900 for generating full CT text reports for coronary computed tomography angiography (CCTA) images. In step 1902, where the method 1900 may include obtaining a set of CCTA datasets and corresponding radiology reports. The radiology reports may contain comprehensive documentation of all coronary findings, including the presence, extent, and severity of coronary artery disease, as well as detailed information about non-coronary findings visible in the CCTA images. Step 1902 may involve aggregating data from various clinical sources, potentially including multiple healthcare institutions to ensure diversity in reporting styles, patient demographics, and disease presentations. The datasets may undergo quality assessment procedures to verify the suitability of both images and reports for subsequent model training, which could include evaluation of report completeness, standardization of terminology, and verification of image-report correspondence.

In step 1904, the method 1900 may include training an image-to-text translation system capable of generating appropriate radiology reports for CCTA images. This training process may involve developing neural network architectures specifically designed to extract relevant features from CCTA volumes and generate structured textual descriptions that conform to radiological reporting standards. The system may include an image encoder to extract features from the CCTA, as well as a text decoder to generate the report based on that representation. In some embodiments, the image encoder may be a convolutional neural network (CNN), a transformer-based architecture, or a hybrid architecture designed for processing CCTA volumes. The text decoder may be a recurrent neural network (RNN) or a transformer-based architecture. The system may further incorporate attention mechanisms, such as cross-attention, to enable the text encoder to focus on specific image regions when generating corresponding textual descriptions. Several distinct training methodologies may be utilized to optimize the system.

One approach for training the image-to-text translation system may involve first training a multi-modal foundation model as described earlier in the “Whole image CCTA foundation model training” and “Using multiple input types for predictions” sections. This foundation model may learn comprehensive representations of CCTA images that capture both anatomical structures and pathological findings. The patient-level descriptors generated by this foundation model may then serve as input to a specialized text generation component that produces structured radiology reports based on the encoded image features. This two-stage approach may leverage the robust feature extraction capabilities of the foundation model while enabling specialized training of the text generation component to ensure adherence to radiological reporting conventions. The foundation model may provide a rich intermediate representation that captures clinically relevant features from the CCTA images, potentially including coronary anatomy characteristics, plaque distribution patterns, stenosis severity assessments, and non-coronary findings that should be documented in comprehensive radiology reports.

These two models, the foundation model and the text generation model, may also be trained jointly in an end-to-end fashion. The joint training approach may involve simultaneous optimization of both image feature extraction and text generation components using combined loss functions that assess both the quality of intermediate representations and the accuracy of generated reports. This end-to-end training methodology may enable more integrated learning where the feature extraction process is directly influenced by the requirements of the report generation task, potentially improving overall system performance. The joint training process may incorporate various optimization techniques including gradient-based methods with appropriate regularization, learning rate scheduling strategies, and specialized loss functions that address both the semantic content and structural formatting of generated reports. In some implementations, the system may employ teacher forcing during training, where ground truth report segments are provided as input during training to stabilize the learning process and improve convergence.

To create a semantically embedding space, the foundation model may be pre-trained using a contrastive learning framework. In this variant, pairs of CCTA image and report may be treated as positive examples. The model is trained to maximize the similarity score between an image and its corresponding report while minimizing the similarity to other reports in a given batch. The learned pre-trained representation can be fine-tuned for the final report generation task.

To better align the reports with the preferences of clinicians in terms of accuracy, style, and clarity, the system may be fine-tune using techniques like Reinforcement Learning from Human Feedback (RLHF). In this process, a trained generative model creates several report candidates for a given CCTA scan. Experts rank these candidate reports, and their feedback is used to train a reward model. The report generation model is then further optimized using this reward model in order to produce outputs that are clinically valuable and acceptable.

In step 1906, the method 1900 may involve saving the trained model to persistent storage. This storage process may preserve the complete model architecture, learned parameters, vocabulary mappings, and other components necessary for subsequent deployment and inference. The saved model may be formatted for efficient loading and execution in clinical environments, potentially incorporating optimization techniques such as quantization, pruning, or compilation that enhance inference speed while maintaining report generation accuracy. The storage process may also include version control information, training dataset characteristics, and performance metrics that document the model's capabilities and limitations for future reference and quality assurance purposes.

In step 1908, the method 1900 may include obtaining a new input CCTA dataset for analysis. This input dataset may undergo pre-processing steps similar to those applied during model training, which could include image normalization, quality assessment, and formatting to ensure compatibility with the trained model's input requirements. The pre-processing may also involve extraction of metadata such as patient demographics, acquisition parameters, or clinical indications that might influence the content and structure of the generated report. In some implementations, the system may perform automated quality checks on the input CCTA data to identify potential limitations such as motion artifacts, poor contrast opacification, or limited anatomical coverage that should be noted in the generated report.

In 1910, the method 1900 may include using the trained model to generate a radiology report based on the input CCTA dataset. The report generation process may involve multiple stages including feature extraction from the CCTA volume, encoding of these features into intermediate representations, and decoding of these representations into structured textual content. The generated report may include standardized sections such as a technique description detailing the acquisition parameters, findings sections that document coronary anatomy, plaque characteristics, stenosis assessments, and non-coronary observations, and an impression section that summarizes key clinical implications. The system may incorporate uncertainty estimation techniques that modulate the confidence and specificity of language used in the report based on image quality factors and feature clarity. In some implementations, the system may generate multiple report versions tailored to different audiences (e.g., referring physicians, radiologists, patients) from the same underlying analysis, potentially enhancing communication efficiency across the care continuum. The generated reports may be presented in formats consistent with clinical documentation standards, potentially including structured data elements that facilitate integration with electronic health record systems and enable downstream analytics.

### Multi-modal Report Generation for Cardiovascular Disease

The multi-modal report generation methodology described herein builds upon the approach outlined in the “Generating full CT text report for CCTA” section, while extending the capabilities to accommodate multiple types of medical imaging data and incorporating additional methodological refinements. This enhanced approach may enable more comprehensive reporting across diverse imaging modalities and clinical contexts.

A machine learning system may be trained to generate a multi-modal report that synthesizes and presents critical information from various medical images in an integrated format. The multi-modal report may incorporate textual descriptions, annotated images, and dynamic visualizations such as videos or interactive elements, providing clinicians with a comprehensive overview of the patient's cardiovascular condition. The textual component may include detailed assessments of disease status, quantitative measurements of anatomical and pathological features, evaluation of treatment options with potential benefits and risks, and prognostic information regarding potential outcomes. The visual elements may be derived from multiple imaging modalities available in the patient record, potentially including coronary computed tomography angiography (CCTA), non-contrast computed tomography (NCCT), invasive angiography, echocardiography, magnetic resonance imaging, or nuclear medicine studies. The integration of these diverse data sources may enable more comprehensive assessment than would be possible with any single imaging modality.

The multi-modal report generation system may be configured to adapt the report content, structure, and presentation according to user-specified requirements and preferences. Users may have the option to request inclusion or exclusion of specific information categories such as detailed quantitative measurements, comparative analyses with prior studies, or specific types of visualization. The system may also accommodate preferences regarding report format, organization, terminology, and stylistic elements to align with institutional standards, specialty-specific conventions, or individual clinician preferences. This customization capability may enhance the clinical utility of the generated reports by ensuring that the information is presented in a manner that aligns with established workflows and communication patterns.

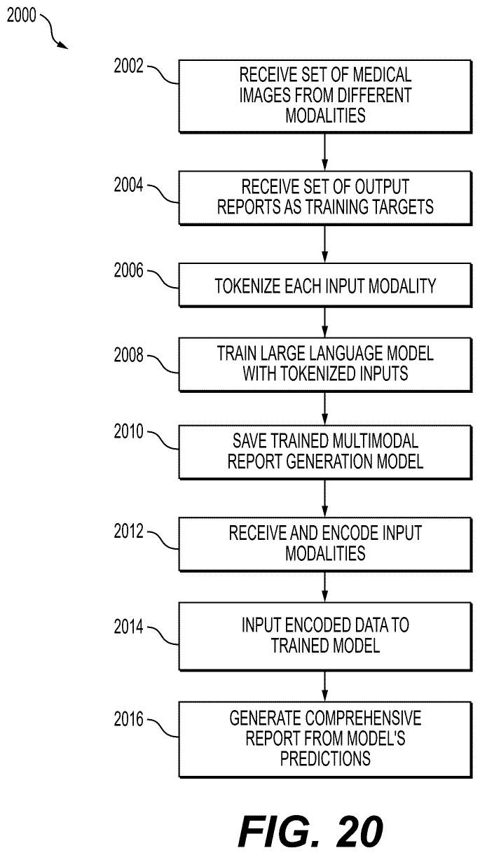

FIG. 20 depicts an exemplary method 2000 for multi-modal report generation for cardiovascular disease. The method 2000 provides a systematic approach for developing and implementing a system that can integrate information from multiple imaging modalities and clinical data sources to produce comprehensive cardiovascular assessment reports.

In step 2002, where the method 2000 may include receiving a set of medical images, including medical images from different imaging modalities. The medical images may be from various cardiovascular imaging studies such as CCTA volumes providing detailed visualization of coronary arteries and cardiac structures, conventional angiography showing vessel lumens and potential stenoses, echocardiography for cardiac function assessment, and other modalities that provide complementary information about cardiovascular anatomy and physiology. Step 2002 may involve aggregating data from various clinical sources, potentially including multiple healthcare institutions to ensure diversity in imaging protocols, patient demographics, and disease presentations. Additionally, step 2002 may involve receiving any derived data such as annotated vessel trees, lumen geometry, plaque segmentations, FFRct, etc.

The method may optionally include obtaining patient information about disease status, treatment options, or potential outcomes. This supplementary clinical data may include laboratory values, vital signs, medication histories, prior interventions, risk factors, and other relevant clinical parameters that provide context for interpreting the imaging findings. The integration of this clinical information with imaging data may enable more comprehensive assessment and reporting that considers both anatomical findings and their clinical implications in the context of the patient's overall health status.

The method may further include obtaining textual information about the case, such as clinical notes, specialist comments, medical background information, or summary statistics derived from similar cases within the same healthcare institution or network. This contextual information may provide valuable insights regarding typical disease patterns, treatment approaches, and outcomes observed in comparable patient populations, potentially enhancing the clinical relevance and interpretability of the generated reports.

In step 2004, the method 2000 may include receiving a set of output reports as training targets for training the multi-modal report generation system. These target reports may be expert-generated clinical documents that exemplify high-quality cardiovascular assessment reporting, incorporating both textual descriptions and visual elements that effectively communicate relevant findings and their clinical significance. The collection of target reports may span various reporting styles, levels of detail, and clinical scenarios to ensure that the trained system can generate appropriate reports across diverse use cases.

In step 2006, the method 2000 may include tokenizing each input modality to prepare the data for processing by the multi-modal language model. The tokenization process may involve different approaches for different data types: text inputs may be tokenized using standard natural language processing techniques, while imaging data may be processed through specialized vision encoders that transform visual information into token sequences that can be processed alongside text tokens. This unified tokenization approach may enable the model to process and integrate information across different modalities within a common representational framework.

In step 2008, the method 2000 may include training a large language model (LLM) that processes tokens from each modality along with a task description provided as a prompt. The model may be trained to predict a structured representation of a report that captures both content and formatting elements. This representation may take the form of program instructions or markup language that can be compiled into a complete report with appropriate textual and visual components. The training process may utilize various techniques including supervised learning with paired input-output examples, reinforcement learning from human feedback to refine report quality, and contrastive learning approaches that help the model distinguish between more and less informative reporting elements.

In step 2010, the method 2000 may include saving the trained model to persistent storage. This storage process may preserve the complete model architecture, learned parameters, tokenization mappings, and other components necessary for subsequent deployment and inference. The saved model may be formatted for efficient loading and execution in clinical environments, potentially incorporating optimization techniques that enhance inference speed while maintaining report generation quality.

In step 2012, the method 2000 may include receiving and encoding a subset of available input modalities, which may include medical images, patient information, and textual data. This encoding process may transform the diverse input data into a unified representation format that can be processed by the trained multi-modal system. The encoding may involve specialized components for different data types, such as vision encoders for imaging data and text encoders for clinical documentation, with the outputs of these components aligned to enable integrated processing of the multi-modal information.

In step 2014, the method 2000 may include inputting the encoded input data to the trained model. This process may involve providing the encoded data along with appropriate prompts or instructions that specify the desired report characteristics, such as the level of detail, specific elements to include or emphasize, or formatting preferences. The system may process these inputs through its trained neural network architecture to generate internal representations that capture the relevant information and relationships across the different input modalities.

In step 2016, the method 2000 may include generating a comprehensive report based on the internal representations generated by the trained model. This generation process may involve decoding the model's output representations into structured report content, potentially including textual descriptions, annotated images, quantitative measurements, and other elements that communicate the relevant cardiovascular findings and their clinical significance. The report generation may incorporate various post-processing steps to ensure consistency, accuracy, and adherence to specified formatting requirements. The resulting comprehensive report may provide an integrated view of the patient's cardiovascular status based on the available imaging and clinical data, potentially enhancing clinical decision-making through comprehensive and accessible information presentation.

### Generating CT Rejection Report

Generating a computed topography (CT) rejection report represents a specialized application of image-to-text translation systems that may enable automated production of detailed technical documentation for medical images that do not meet quality standards for specific clinical analysis applications. The rejection report generation system may be configured to analyze computed tomography angiography datasets and produce comprehensive rejection reports that identify specific image quality issues, technical limitations, and scanner-specific recommendations for improving image acquisition or reconstruction parameters. The rejection report approach may provide standardized documentation that ensures consistent communication of technical issues while providing actionable guidance for addressing image quality problems that prevent successful clinical analysis. The image-to-text translation systems may be similar or the same as those described in the “Generating full CT text report for CCTA” section, but specifically focused on generating detailed technical documentation for coronary computed tomography angiography (CCTA) datasets that do not meet quality standards for clinical analysis. This specialized application may enable the automated production of comprehensive rejection reports that identify specific image quality issues, technical limitations, and scanner-specific recommendations for improving image acquisition or reconstruction parameters.

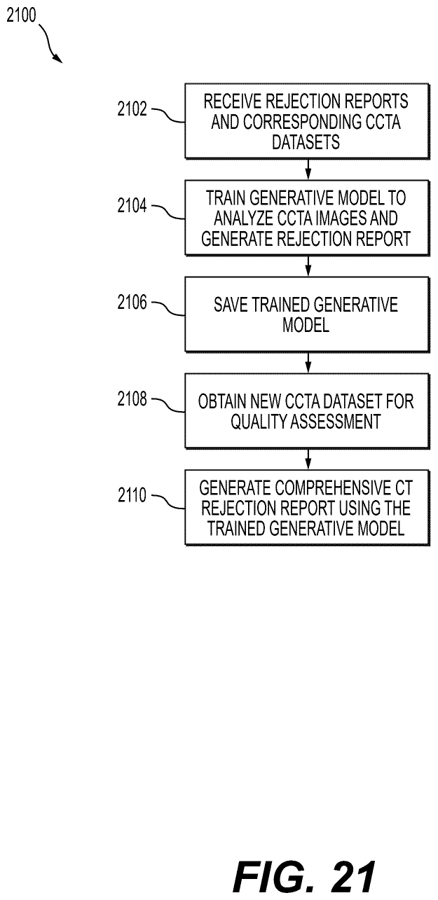

FIG. 21 depicts an exemplary method 2100 for generating automatic rejection reports for CCTA images. The method 2100 provides a systematic approach for developing and implementing a system that can analyze CCTA datasets, identify quality issues that may prevent successful clinical analysis, and generate detailed technical reports with specific recommendations for addressing identified problems.

In step 2102, the system may receive a plurality of rejection reports that have been sent to customers for rejected CCTA images, along with the corresponding training datasets (medical images or derived data) that triggered these rejections. These rejection reports may contain detailed documentation of specific image quality issues that prevented successful analysis, including technical parameters, artifact descriptions, and specific recommendations for addressing identified problems. The collection process may involve aggregating reports from multiple clinical analysis workflows to ensure comprehensive representation of rejection criteria, technical terminology, and recommendation approaches used across different analysis applications.

In step 2104, the method 2100 may include training a generative AI model to analyze CCTA images and generate appropriate rejection reports when quality issues are detected. The training process may involve developing neural network architectures specifically designed to extract relevant features from CCTA volumes and generate structured textual reports that identify quality limitations and provide technical recommendations. The system may incorporate various deep learning approaches including convolutional neural networks for image feature extraction, transformer-based architectures for text generation, and attention mechanisms that enable the model to focus on specific image regions when generating corresponding textual descriptions of quality issues.

The generative AI model may be configured to produce different types of rejection reports tailored to specific clinical analysis products, each with distinct image quality requirements and technical specifications. For example, Fractional Flow Reserve computed tomography (FFRct) analysis may have different quality requirements compared to plaque assessment or anatomical modeling applications. The product-specific training process may involve collecting rejection reports that are tailored to specific analysis applications, each of which may have distinct image quality requirements and technical specifications. The model may learn to recognize quality issues that specifically affect particular analysis types and generate recommendations that address the unique requirements of each application.

The generated rejection reports may be designed to closely resemble the format, content, and technical specificity of historical reports used in clinical practice. These reports may include detailed descriptions of CT rejection reasons with scanner-specific recommendations to improve image quality or modify reconstruction parameters. The scanner-specific recommendation component may be particularly valuable, as it may provide actionable guidance tailored to the specific scanner manufacturer, model, and software version used for image acquisition. For example, the system may recommend specific protocol modifications for different scanner platforms, such as adjusting tube voltage and current settings, modifying scan timing parameters, implementing cardiac gating techniques, or optimizing contrast agent administration protocols to address identified image quality issues.

In step 2106, the method 2100 may include saving the trained generative AI model to persistent storage. This storage process may preserve the complete model architecture, learned parameters, vocabulary mappings, and other components necessary for subsequent deployment and inference. The saved model may be formatted for efficient loading and execution in clinical environments, potentially incorporating optimization techniques such as quantization, pruning, or compilation that enhance inference speed while maintaining report generation accuracy. The storage process may also include version control information, training dataset characteristics, and performance metrics that document the model's capabilities and limitations for future reference and quality assurance purposes.

In step 2108, the method 2100 may include obtaining a new CCTA dataset for quality assessment and potential rejection report generation. This input dataset may undergo preprocessing steps similar to those applied during model training, which could include image normalization, quality assessment, and formatting to ensure compatibility with the trained model's input requirements. The preprocessing may also involve extraction of metadata such as scanner information, acquisition parameters, or reconstruction settings that might influence the content and specificity of the generated rejection report.

In the final step 2110, the method 2100 may conclude with using the trained system to generate a comprehensive CT rejection report for the specific product of choice. The report generation process may involve multiple stages including feature extraction from the CCTA volume, quality assessment against product-specific criteria, identification of specific technical limitations, and generation of structured textual content with appropriate recommendations. The generated report may include standardized sections such as image quality assessment results, specific technical issue identification, scanner-specific parameter recommendations, and alternative acquisition protocol suggestions that provide comprehensive guidance for improving image quality in subsequent acquisitions. The system may incorporate uncertainty estimation techniques that modulate the confidence and specificity of recommendations based on image quality factors and feature clarity. The generated reports may be presented in formats consistent with clinical documentation standards, potentially including structured data elements that facilitate integration with quality control systems and enable downstream analytics for systematic quality improvement initiatives.

### Interactive AI-Supported Case Processing

Interactive artificial intelligence-supported case processing may improve medical image analysis workflows through automated generation of customized working instructions and comprehensive textual summaries that guide analysts through complex case evaluation procedures. The interactive case processing system may be configured to analyze medical imaging datasets and generate tailored guidance documentation that highlights relevant procedural considerations, identifies potential challenges, and provides contextual information that supports efficient and accurate case analysis. The system may utilize image-to-text translation models that have been trained on collections of unstructured case notes and analyst documentation to learn patterns of procedural guidance and case-specific considerations that are relevant for different types of medical imaging studies.

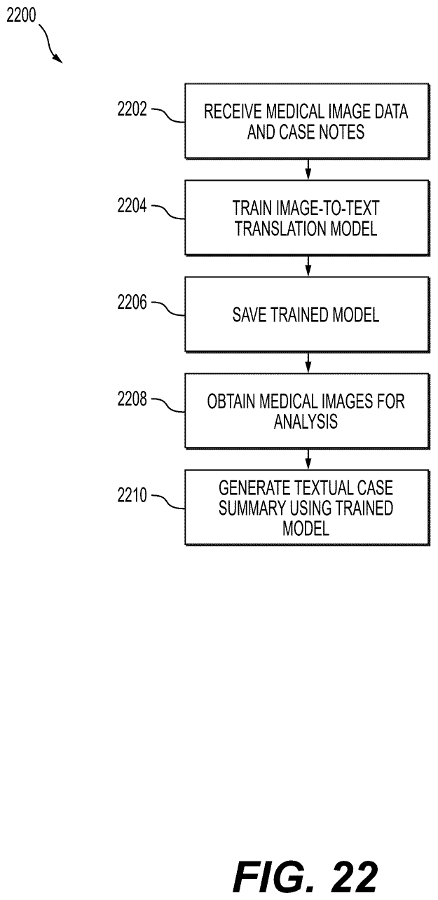

FIG. 22 depicts an exemplary method 2200 for interactive AI-supported case processing. In step 2202, method 2200 may include receiving training medical image data and corresponding unstructured case notes taken by analysts during routine medical image analysis workflows. These unstructured case notes may include procedural guidance, technical parameter recommendations, analytical approach suggestions, and other documentation created by experienced analysts who have developed expertise in recognizing case-specific factors that affect analysis accuracy and efficiency. The medical image data may encompass various imaging modalities including coronary computed tomography angiography, cardiac magnetic resonance imaging, echocardiography, or other cardiovascular imaging techniques that provide visualization of cardiac anatomy and pathology. The collection process may involve aggregating data from multiple clinical sources to ensure diversity in case types, analyst expertise levels, and documentation approaches.

In step 2204, method 2200 may include training an image-to-text translation model to generate a textual case summary based on the training medical image data and unstructured case notes. This training process may involve developing neural network architectures specifically designed to extract relevant features from medical images and generate structured textual summaries that highlight important procedural considerations, identify potential challenges, and provide contextual information to support efficient case analysis. The training methodology may include an image encoder to extract features from the CCTA, as well as a text decoder to generate the report based on that representation. In some embodiments, the image encoder may be a convolutional neural network (CNN), a transformer-based architecture, or a hybrid architecture designed for processing CCTA volumes. The text decoder may be a recurrent neural network (RNN) or a transformer-based architecture. To fuse information between the learned image and language representations, convolutional neural networks or transformer-based architectures for image feature extraction, transformer-based architectures for text generation, and a The system may further incorporate attention mechanisms, such as cross-attention, that to enable the model text encoder to focus on specific image regions when generating corresponding textual descriptions. The system may learn to identify patterns in the unstructured case notes that correlate with specific imaging characteristics, potentially enabling the generation of appropriate guidance for new cases based on observed image features and technical parameters.

The training methodology for interactive case processing systems may involve collecting comprehensive datasets of analyst case notes, procedural documentation, and working instructions that have been generated during routine medical image analysis workflows. The training data may encompass various types of procedural guidance including case-specific working instructions that highlight particular anatomical considerations, technical parameter recommendations that address image quality issues, and analytical approach suggestions that account for specific pathological presentations or imaging artifacts. The case note collection process may involve aggregating documentation from experienced analysts and imaging specialists who have developed expertise in recognizing case-specific factors that affect analysis accuracy and efficiency.

The unstructured case note analysis process may involve natural language processing techniques that extract relevant procedural patterns and guidance principles from narrative documentation created during routine case processing activities. The text analysis algorithms may identify common themes and procedural considerations that are associated with different types of imaging studies, pathological presentations, and technical challenges that arise during medical image analysis. The pattern recognition process may learn to associate specific imaging characteristics with corresponding procedural recommendations, enabling the system to generate appropriate guidance for new cases based on observed image features and technical parameters.

In step 2206, the method 2200 may include saving the trained model to persistent storage. This storage process may preserve the complete model architecture, learned parameters, vocabulary mappings, and other components necessary for subsequent deployment and inference. The saved model may be formatted for efficient loading and execution in clinical environments, potentially incorporating optimization techniques such as quantization, pruning, or compilation that enhance inference speed while maintaining generation accuracy.

In step 2208, the method 2200 may include obtaining medical images for analysis. These input images may undergo pre-processing steps similar to those applied during model training, which could include image normalization, quality assessment, and formatting to ensure compatibility with the trained model's input requirements. The pre-processing may also involve extraction of metadata such as acquisition parameters, anatomical regions, or technical specifications that might influence the content and structure of the generated case summary.

In step 2210, the method 2200 may include generating, using the trained model, a textual case summary based on the medical images. The generation process may involve multiple stages including feature extraction from the medical images, encoding of these features into intermediate representations, and decoding of these representations into structured textual content. The generated summary may include standardized sections such as a technical assessment detailing the image quality parameters, findings sections that document anatomical structures, pathological characteristics, and artifact observations, and recommendation sections that provide guidance for optimal case processing.

The system may identify and mark working instructions that are not relevant for the specific case as non-relevant, potentially using visual indicators such as strikethrough formatting, color coding, or explicit labeling. This relevance assessment may be based on various case-specific factors including anatomical characteristics, pathological findings, image quality parameters, and technical acquisition details. The non-relevant instruction identification may help analysts focus their attention on procedural steps that are most applicable to the current case, potentially improving workflow efficiency and reducing cognitive load during case processing.

The system may emphasize and highlight important working instructions that are particularly applicable to the current case, potentially using visual enhancement techniques such as bold formatting, increased font size, color highlighting, or explicit priority indicators. The importance assessment may consider factors such as critical anatomical regions, challenging pathological presentations, potential technical difficulties, or quality limitations that require special attention during analysis. The highlighting mechanism may help ensure that analysts are aware of case-specific considerations that could significantly impact analysis accuracy or efficiency.

The textual summary may specifically highlight aspects of the case that require particular care or attention during review, potentially including complex anatomical variations, ambiguous pathological presentations, image quality limitations, or technical challenges that could affect interpretation accuracy. The system may provide detailed explanations of why these aspects require special consideration, potentially referencing similar cases, established guidelines, or specific technical factors that contribute to the increased complexity. This focused guidance may help analysts allocate appropriate time and attention to challenging aspects of the case while maintaining efficient processing of more straightforward components.

The system may generate a comprehensive textual summary that identifies and characterizes imaging artifacts, regions of uninterpretability (ROUs), and the presence, location, and degree of disease findings. The artifact description may include information about motion effects, noise patterns, reconstruction artifacts, or other technical limitations that affect image quality in specific regions. The ROU identification may specify anatomical areas where image quality is insufficient for reliable interpretation, potentially including quantitative assessments of the extent and severity of interpretability limitations. The disease characterization may include detailed descriptions of pathological findings including location information using standardized anatomical reference systems, severity assessments using established classification schemes, and morphological descriptions that capture relevant characteristics for subsequent analysis and reporting.

A textual summary may be more efficient for human processing compared to navigating through a three-dimensional volume, potentially enabling trained analysts to rapidly develop an accurate mental model of the anatomy being evaluated. The textual format may allow for quick scanning and identification of key information, while the structured organization may facilitate systematic review of relevant case characteristics. For experienced analysts familiar with standard anatomical terminology and pathological classifications, the textual description may provide sufficient information to form a comprehensive understanding of the case before engaging in detailed visual analysis, potentially improving workflow efficiency and reducing the time required for initial case orientation.

The textual summary may be enhanced with embedded or linked images that visually depict the specific anatomical structures, pathological findings, or technical issues being described in the text. These visual elements may include annotated cross-sectional views, three-dimensional renderings, curved multiplanar reformations, or other visualization techniques that effectively illustrate the textual descriptions. The integration of targeted visual examples with corresponding textual explanations may provide a more comprehensive and intuitive understanding of complex anatomical relationships or subtle pathological findings compared to either modality alone. The system may selectively include images for aspects of the case that are particularly complex or challenging to describe using text alone, ensuring that the visual elements enhance rather than duplicate the textual information.

The textual summary generation system may be designed to complement and augment visual inspection systems, providing a multi-modal approach to case analysis that leverages the strengths of both textual and visual information presentation. The combined approach may enable more holistic case assessment by providing structured textual guidance that directs visual attention to relevant anatomical regions and highlights specific features that require careful evaluation. The integration of textual summaries with interactive visual systems may create a more comprehensive analytical environment that supports both systematic review processes and detailed exploration of specific anatomical structures or pathological findings.

The system may be extended to support interactive interrogation capabilities that enable analysts to engage in dialogue with the system during case processing, potentially requesting additional information, clarification, or guidance about specific aspects of the case. This interactive functionality may allow analysts to query the system about findings in other available image series or alternative imaging modalities that may provide complementary information relevant to the current analysis task. The system may function as a consulting analyst by providing context-aware responses that incorporate information from multiple data sources, reference relevant guidelines or best practices, and suggest appropriate analytical approaches based on the specific characteristics of the current case. The interactive capabilities may be implemented using natural language processing techniques that enable analysts to pose questions in conversational language and receive informative responses that address their specific inquiries while maintaining the context of the overall case analysis.

### Speech or Text-Controlled Medical Imaging System for Enhanced Diagnosis and Treatment Efficiency

Medical imaging applications serve as essential diagnostic and treatment tools for healthcare professionals across various medical specialties. These applications may enable physicians to visualize internal anatomical structures, identify pathological changes, and monitor disease progression through non-invasive means. However, conventional interaction methods relying on keyboard and mouse inputs may present significant operational challenges in clinical environments. The manual navigation through complex user interfaces can be particularly cumbersome and time-consuming, especially when physicians need to review multiple imaging series or compare longitudinal studies acquired at different time points. Additionally, the substantial volume and complexity of information displayed in medical images, including anatomical structures, pathological findings, and quantitative measurements, can create cognitive overload for clinicians attempting to rapidly identify clinically relevant information during time-constrained patient consultations or procedural planning sessions.

One approach to address these challenges may involve the integration of artificial intelligence agents into medical imaging applications to enhance both the efficiency and diagnostic accuracy of disease assessment and treatment planning workflows. These AI agents may be trained to recognize and interpret natural language inputs in the form of voice commands or textual instructions, thereby enabling physicians to perform various user actions through speech or text rather than relying exclusively on conventional keyboard and mouse interactions. This multi-modal interaction capability may allow healthcare professionals to navigate through imaging studies more intuitively, rapidly access specific anatomical regions of interest, automatically extract quantitative measurements, and generate comparative visualizations across different time points or imaging modalities. By reducing the cognitive and physical burden associated with complex user interface navigation, these AI-enhanced systems may enable physicians to dedicate more attention to clinical interpretation and decision-making processes, potentially leading to more comprehensive patient evaluations and better-informed treatment strategies.

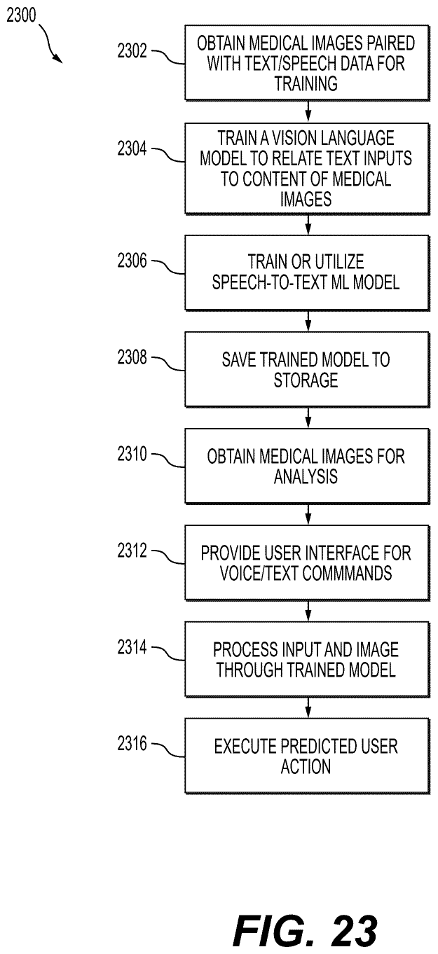

FIG. 23 depicts an exemplary method 2300 for implementing a speech or text-controlled medical imaging system designed to enhance diagnostic and treatment efficiency.

In step 2302, method 2300 may include obtaining a set of medical images, paired with text inputs in the form of commands or questions, for training purposes. These medical images may encompass various imaging modalities relevant to cardiovascular assessment, including but not limited to coronary computed tomography angiography (CCTA), cardiac magnetic resonance imaging (MRI), echocardiography, nuclear perfusion studies, and conventional coronary angiography. The training dataset may include images representing diverse patient demographics, disease presentations, anatomical variations, and image quality characteristics to ensure robust model performance across different clinical scenarios. The images may be collected from multiple clinical sites and may include appropriate de-identification procedures to ensure patient privacy while maintaining clinically relevant information necessary for model training. In other embodiments, these medical images may not be related to cardiovascular assessment. In some instances, a collection of text labels may be paired with associated annotations in the image data. For example, the location and characteristics of lesions in an image, and a text description of the location and characteristics (e.g. “There is a 70% stenosis in the proximal LAD with a FFRct of 0.68”, paired with an indicator in the image such as a landmark or mask at the location of the stenosis).

In step 2304, a vision-language model may be trained using the image-text pairs to establish joint representations that can facilitate cross-modal understanding and translation capabilities. The vision-language model may be configured to learn unified embeddings that capture semantic relationships between visual content and textual descriptions, potentially enabling the system to process and correlate information across different data modalities. This model may be implemented through various training approaches, including end-to-end training methodologies such as CLIP (Contrastive Language-Image Pre-training) that simultaneously optimize both vision and language components, or alternatively through approaches that combine separately pre-trained vision and language models that can be adapted together to learn joint embeddings. In some embodiments, the adaptation process may involve the use of specialized adaptation heads or fusion layers that enable effective integration of features from different modalities while preserving the learned representations from the individual pre-trained components. The training process may incorporate various loss functions designed to encourage alignment between corresponding image and text representations, potentially including contrastive losses, reconstruction losses, or other objectives that promote meaningful cross-modal associations. Alternatively, a pre-trained vision model may be used.

In step 2306, method 2300 may include training a speech-to-text machine learning model or alternatively utilize a pre-trained machine learning model adapted for medical terminology recognition. The training methodology for a speech-to-text model may involve supervised learning approaches using paired audio recordings and corresponding transcriptions of medical commands and queries. The training process may incorporate domain-specific medical vocabulary, anatomical terminology, procedural nomenclature, and common clinical abbreviations to enhance recognition accuracy for healthcare-specific language. Transfer learning techniques may be employed to adapt general-purpose speech recognition models to the specialized medical domain, potentially reducing the volume of domain-specific training data required while maintaining high recognition accuracy. The training process may include data augmentation techniques such as varying speech rates, accents, background noise levels, and microphone characteristics to improve model robustness across different speaking styles and acoustic environments commonly encountered in clinical settings.

For supporting speech-based interaction, the system may utilize the output of the speech-to-text machine learning model in conjunction with the vision-language model, where the transcribed text and medical images are the inputs to the vision-language model to predict appropriate user actions for the medical imaging system. This multi-modal processing approach may involve analyzing both the transcribed command and the current imaging context to determine the most appropriate system response. The prediction model may be trained using supervised learning techniques with examples of voice commands paired with corresponding user interface actions across various imaging scenarios. The training methodology may incorporate reinforcement learning components where the model receives feedback on the appropriateness of predicted actions, enabling continuous improvement through interaction. Contextual understanding capabilities may be developed to interpret commands that reference relative positions, anatomical landmarks, or previous actions, enhancing the natural flow of the interaction.

For a text-based interaction system, the method may involve using the textual input and the medical image(s) as combined inputs to predict appropriate user actions for the medical imaging system. The text-based approach may offer advantages in environments with significant ambient noise or when precise terminology is required. The prediction model for text commands may be trained using similar methodologies as the speech-based system but may incorporate additional natural language processing techniques specifically optimized for written medical language. These techniques may include medical entity recognition, relationship extraction, and semantic parsing to accurately interpret complex textual instructions that may include multiple clauses or conditional statements. The text-based system may also support more structured query formats that enable precise specification of measurement parameters, visualization settings, or analysis criteria that might be challenging to communicate through speech alone.

In step 2308, the method 2300 may include saving the trained model to persistent storage for subsequent deployment and utilization. The storage process may preserve the complete model architecture, learned parameters, vocabulary mappings, and other components necessary for inference. The saved model may be formatted for efficient loading and execution in clinical environments, potentially incorporating optimization techniques such as quantization, pruning, or compilation that enhance inference speed while maintaining recognition accuracy. The storage process may also include version control information, training dataset characteristics, and performance metrics that document the model's capabilities and limitations for future reference and quality assurance purposes.

In step 2310, the method 2300 may include obtaining a medical image for analysis in a clinical setting. This step represents the transition from the training phase to the operational deployment of the speech or text-controlled system. The medical image may be loaded from a picture archiving and communication system (PACS), electronic health record (EHR), or other clinical data repository. The image loading process may include appropriate preprocessing steps such as anonymization, format conversion, or quality assessment to ensure compatibility with the trained model and downstream analysis tools. In some implementations, the system may automatically extract and present relevant metadata such as acquisition parameters, patient demographics, or clinical indications to provide context for the subsequent analysis.

In step 2312, the method 2300 may include providing a user interface module specifically designed for steering the interactive application using text or voice commands. This interface may include visual indicators of system listening status, transcription feedback displays, command recognition confirmations, and suggested command templates to guide users. The interface may be designed with principles of human-computer interaction in mind, providing clear affordances for initiating voice commands, visual feedback during processing, and transparent presentation of system interpretations before actions are executed. The user interface may incorporate adaptive elements that learn from individual user patterns and preferences, potentially customizing command recognition thresholds, feedback verbosity, or suggestion relevance based on usage patterns. In some implementations, the interface may include multi-modal input capabilities that allow seamless transitions between voice commands, text input, and conventional mouse/keyboard interactions based on task requirements and environmental conditions.

In step 2314, the method 2300 may include processing, using the trained model, both the natural language input (either from speech-to-text conversion or direct text entry) and the current medical image context to generate an appropriate user action. This processing step represents the core functionality of the system, where the trained models analyze the multi-modal inputs to determine the user's intent and translate it into specific application commands or workflows. The processing may involve multiple stages including command classification, parameter extraction, context integration, and action prediction. The system may employ attention mechanisms to focus on relevant regions of the medical image based on the content of the command, enabling more accurate interpretation of location-specific instructions. In some implementations, the system may generate multiple candidate actions with associated confidence scores, allowing for disambiguation through user confirmation when uncertainty exists.

In step 2316, the method 2300 may include executing the predicted user action, either automatically or following manual approval depending on system configuration and the nature of the action. For lower-risk actions such as navigation, zooming, or basic measurements, the system may implement automatic execution to maximize efficiency. For higher-impact actions such as diagnostic annotations, report generation, or treatment planning modifications, the system may present a confirmation prompt before execution. The execution process may include appropriate error handling mechanisms to address cases where actions cannot be completed due to technical limitations, data constraints, or logical inconsistencies. The system may provide clear feedback about the executed action through visual cues, status messages, or synthesized voice responses, ensuring that users maintain awareness of system state changes resulting from their commands.

Additionally, each user action may be recorded to build a comprehensive workflow for storing sequences of user interactions, which may subsequently be applied to future cases with similar characteristics. This workflow capture capability may enable the creation of standardized protocols for common diagnostic or analytical tasks, potentially improving consistency across different users and reducing the time required for routine procedures. The recorded workflows may be edited, annotated, and shared among clinical teams, facilitating standardization of best practices and training of new personnel. In some implementations, the system may analyze patterns across multiple recorded workflows to identify optimization opportunities or suggest alternative approaches that might improve efficiency or diagnostic yield. The workflow recording functionality may also support quality assurance processes by enabling retrospective review of analysis procedures and decision-making pathways.

In a practical clinical scenario, a physician may be reviewing a medical image of a patient with suspected cardiovascular disease. When the physician wishes to compare the current image with previous studies to evaluate disease progression, rather than navigating through complex menu structures or executing multiple mouse operations, the physician may simply issue natural language commands such as “compare to previous images” or “show disease progression over time.” The AI agent may then interpret these commands within the current clinical context and translate them into the appropriate sequence of system actions, potentially including retrieval of prior studies, temporal alignment of images, side-by-side display configuration, or generation of change analysis visualizations. This natural interaction approach may significantly reduce the cognitive and operational burden associated with complex comparison tasks, allowing the physician to focus more directly on clinical interpretation and decision-making rather than interface navigation.

The machine learning system may be trained to recognize and interpret voice and text commands related to specific regions of interest within medical images, enabling precise anatomical navigation and focused analysis. For example, when a physician needs to examine a particular anatomical structure, they may issue commands such as “show heart chambers,” “highlight proximal left anterior descending artery,” or “measure stenosis in mid-right coronary artery.” The AI agent may then process these anatomically-specific instructions to automatically identify the referenced structures, adjust the visualization parameters appropriately, and perform requested measurements or annotations. The system's ability to understand anatomical terminology and spatial relationships may enable more intuitive and efficient interaction compared to conventional approaches that might require manual segmentation, multiple menu selections, or precise cursor positioning. This capability may be particularly valuable for complex vascular structures where conventional navigation can be time-consuming and may require specialized expertise in identifying specific vessels or branches.

The speech or text-controlled system may also provide responses to clinical questions that would typically require consultation with more experienced colleagues, specialized customer support personnel, or subject matter experts. Users may pose questions such as “Why is this vessel excluded from the analysis?” or “Why does this vessel not show a positive FFRct value despite having a significant stenosis?” The system may analyze the current image context, apply relevant clinical knowledge, and generate informative responses that explain the underlying methodological considerations, technical limitations, or physiological principles. Additionally, the system may support professional development by responding to queries such as “What diagnostic test should I consider next for this presentation?” or “Can you recommend training resources for interpreting cases with similar characteristics?” These educational and decision-support capabilities may extend the system's utility beyond basic image manipulation, potentially serving as a virtual consultant that combines procedural guidance with clinical knowledge sharing to enhance both operational efficiency and diagnostic accuracy.

Case Retrieval-Finding Relevant Information and Similar Samples from Multi-Modal Data Sources

Digital information retrieval, or search, may be a pivotal technology enabled and continuously improved by advances in machine learning developments. Retrieval algorithms may be widely used for a range of digital media, including text, image, video and audio content.

The retrieval system may enable physicians to enhance their decision making in a clinical setting by retrieving samples from a database for comparison and diagnostic purposes. Clinical personal health information may often be stored in a standardized format, and can easily be queried. However, more complex signals from clinically relevant modalities, such as 2D-, 3D- and 4D-medical imaging, electrocardiograms, continuous glucose monitoring, or any other signals may require more sophisticated search mechanisms. Given any combination of modalities and test results for a patient, the retrieval system may be able to search a database, using one or more search mechanisms, for similar samples, which may be used to enhance clinical decision making for the patient.

One mechanism for search with complex signals may be the use of machine learning models, where embeddings may be learned, for example by training a generative model or a self-supervised feature extractor, which given an input sample, may be used to search for similar samples from the embeddings of other samples in a database. With regards to medical image data, similarity may for example be in terms of learned embeddings from image representations at one or more levels, including at the level of the whole image, of an organ, or a particular anatomical structure or substructure; generative models may also be trained to learn representations that may allow similarity of tree or mesh structures, for example of the coronary tree in the form of a (centerline) graph or image representation, along with derived features projected onto these representations, such as different plaque types or computed flow and pressure. The system may allow search to be conducted not just on overall similarity of a signal, but also on one or more specific parts of the input signal, e.g. anatomical sub-structures may also be used as searchable, e.g. for analysis of the coronary tree in CCTA, similar samples may also be queried on the level of the coronary territory-, vessel- or lesion-level.

One application may be to use retrieved cases or samples to inform decision making on a current case. For example, a user conducting an annotation task of a medical image may want to find other similar previously annotated samples of a particular structure, to help inform the current annotation task. Another example may be a physician who may want to use the retrieval system to better inform diagnosis and treatment planning of a current patient—the physician may use the system to find similar patients who match in all important respects; information about previous patients may be provided by the system to inform decision making, including for example any patient reports, what course of treatment was selected, and how the patient has fared in follow-up. The system may also use foundation models trained to interpret different modalities, and any retrieved data for a patient may be summarized or explained, for example to contextualize the retrieved samples in relation to the current patient to inform decision making. The system may also be able to explain its own confidence and uncertainty in the use of other samples, and highlight relevant similarities as well as dissimilarities that may be relevant to the users' objectives.

The use of retrieved samples from a database to inform decision making may provide a form of personalization for the evaluation of the sample at hand; in the context of patient treatment by a physician, the retrieval system may provide additional value for assessment of the individual, where otherwise information for example from clinical studies, not necessarily tailored to the individual, may be more heavily weighted in the physician's decision making.

The retrieval system may also be used to query other knowledge banks for relevant information, not only databases of samples with similar data structures to a case at hand, which may be queried as described above. For example, the retrieval system may query the existing medical literature for relevant information pertaining to a patient at hand to enhance clinical decision making. This may be achieved for example through a multi-modal foundation model that may have shared learned representations across text, imaging, and all other relevant signals, that may query a source of data, whether a closed database system like a PACS or publicly available sources such as the internet.

Availability of any additional clinical information for retrieved samples may further enhance decision making. For example, in the case of a physician's decision-making for a patient, knowledge of comorbidities, test results for risk factors, genetic information, interventions, medications, follow-up test results following initial treatments, and outcomes may be provided and summarized for a physician using the retrieval system.

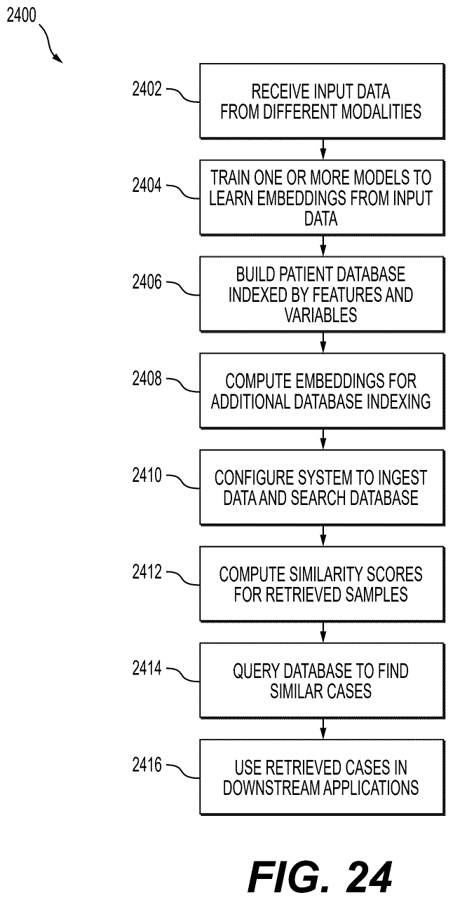

FIG. 24 depicts an exemplary method 2400 for case retrieval using multi-modal data sources to find relevant information and similar samples.

In step 2402, method 2400 may involve receiving input data from relevant modalities for which a learned embedding would aid retrieval. The input data may encompass a wide range of medical imaging formats and derived models. Two-dimensional images may include cross-sections of volumetric imaging data such as computed tomography scans, curvilinear planar representation (CPR) images that may show longitudinal cross-sections of coronary vessels or specific lesion segments, and standard still-frame images from modalities such as ultrasound and cardiac magnetic resonance imaging. Three-dimensional representations may include complete 3D image volumes from computed tomography, 3D cropped patches of image volumes centered on the heart or other regions of interest, 3D volumes constructed from CPR images, and one-dimensional centerline trees with associated properties such as FFRCT values, plaque characteristics, and measurements of lumen and outer wall diameter. The system may also process 3D mesh representations of coronary trees and cardiac chambers that may capture the geometric structure of these anatomical features. Additionally, the input data may include segmentation masks or signed distance field (SDF) representations that may delineate the boundaries of anatomical structures in any of the previously mentioned image representations, such as masks of the coronary lumen and plaque distributions. This diverse range of input representations may enable the system to capture different aspects of patient anatomy and pathology, potentially improving the relevance of retrieved cases for various clinical applications.

In step 2404, the method may involve training one or more models to learn embeddings from the input data collected in step 2402. The embedding learning process may utilize various machine learning architectures designed to capture meaningful representations from different data modalities while preserving clinically relevant relationships between patient cases. The machine learning models for learning these embeddings may include auto-encoder-like models such as traditional autoencoders that may learn compressed representations of input data, variational autoencoders that may learn probabilistic latent representations, hierarchical autoencoders that may capture information at multiple levels of abstraction, and masked autoencoders that may learn to reconstruct partially obscured inputs. The system may also utilize pre-trained encoder-like models, including vision transformer encoders that may process images as sequences of patches, or convolutional neural network encoders that may extract spatial features through hierarchical filtering operations. These models may be trained using self-supervised learning approaches such as contrastive learning, where the model may learn to distinguish between similar and dissimilar examples, or other semi-supervised techniques that may leverage both labeled and unlabeled data to learn meaningful representations. The embedding computation process may create a high-dimensional feature space where similar patients may be positioned closer together, potentially enabling more nuanced similarity assessments than would be possible with explicit feature matching alone.

For imaging data, the system may employ convolutional neural networks or vision transformers that can extract spatial features from medical images, potentially including architectures such as ResNet, DenseNet, or specialized medical imaging networks that have been adapted for cardiovascular applications. For physiological signals such as ECG traces, the training process may utilize recurrent neural networks, temporal convolutional networks, or transformer-based approaches that can capture sequential patterns and temporal dependencies in the signal data. The system may implement multi-modal embedding approaches that can process different data types simultaneously, potentially using techniques such as cross-modal attention mechanisms, shared latent spaces, or modality-specific encoders followed by fusion layers. The training methodology may incorporate contrastive learning objectives that encourage similar patient cases to have similar embeddings while pushing dissimilar cases apart in the embedding space. In some embodiments, the system may utilize self-supervised learning techniques that can leverage unlabeled data to learn meaningful representations, potentially including masked reconstruction tasks, temporal prediction objectives, or cross-modal prediction challenges. The embedding models may be trained using various optimization strategies including gradient descent variants, learning rate scheduling, and regularization techniques to prevent overfitting and improve generalization across diverse patient populations and clinical scenarios.

In step 2406, the method 2400 may involve building a database of patients that may be indexed by a combination of derived features and measured clinical variables. These may include coronary-derived features such as total plaque burden, maximum delta FFRct values, number of lesions, vascular volume, percentage of myocardium affected (% Myo), fat attenuation index, and other quantitative metrics that may characterize coronary health. The database may also incorporate gross-anatomy-derived features including left ventricular mass, end-diastolic or systolic volume, left atrial volume, aortic diameter, epicardial adipose tissue volume, and other anatomical measurements that may provide context for cardiovascular assessment. Additionally, the database may include known patient characteristics such as age, sex, and various risk factors including but not limited to hypertension status, diabetes status, smoking history, and family history of cardiovascular disease. This multi-faceted indexing approach may enable more precise matching of cases based on clinically relevant parameters.

In step 2408, the method 2400 may include additional indexing of the patient database through computation of embeddings using the one or more trained models from step 2404.

In step 2410, the method 2400 may involve configuring the system to ingest one or more of the above representations, measured clinical variables, or derived features as input, and to search a database of existing samples for similar cases. The ingestion process may involve preprocessing steps to standardize the input data, extract relevant features, and compute embeddings using the trained models described in step 2404. The search functionality may utilize various similarity metrics and indexing structures to efficiently identify potentially relevant cases from the database. The system may implement approximate nearest neighbor search algorithms, locality-sensitive hashing, or other techniques that may enable rapid retrieval of similar cases even from large databases. In some implementations, the system may employ a hierarchical search approach that may first identify candidate matches based on high-level features before refining the results using more detailed similarity assessments.

In step 2412, the method 2400 may include computing a similarity score for each retrieved sample relative to each input sample with respect to each of the input representations, measured clinical variables, and derived features. The similarity scoring process may involve various distance metrics such as Euclidean distance, cosine similarity, or Mahalanobis distance, depending on the nature of the features being compared. For embedding-based comparisons, the system may compute distances in the learned latent space, potentially capturing complex relationships that might not be apparent from explicit feature comparisons. The system may provide a detailed similarity score and ranking for each retrieved sample, broken down by each input representation, clinical variable, or derived feature. This multi-dimensional similarity assessment may enable users to understand precisely how and why certain cases were deemed similar to the input case, potentially enhancing the interpretability and clinical utility of the retrieval results. The similarity scores may be normalized or weighted according to clinical relevance, with greater emphasis placed on features that may be most important for the specific clinical context or question being addressed.

In step 2414, the method 2400 may involve querying the searchable database to find samples which may be similar to an input case using one or more of the derived features, measured clinical variables, or computed embeddings from their respective input data representations. The query process may allow for flexible specification of which features or representations should be prioritized in the similarity assessment, potentially enabling users to tailor the search to their specific clinical questions or concerns. For example, a user interested in finding patients with similar coronary anatomy might emphasize centerline tree embeddings and coronary-derived features, while a user focused on overall cardiac function might prioritize chamber volume measurements and myocardial characteristics. The query interface may support both simple searches based on a few key parameters and complex multi-criteria searches that may consider numerous features simultaneously. In some implementations, the system may provide interactive query refinement capabilities, allowing users to adjust search parameters based on initial results to progressively narrow down to the most relevant cases.

In step 2416, the method 2400 may include utilizing the retrieved cases in various downstream applications that may enhance clinical decision-making and patient care. These applications may include supporting diagnostic assessments by providing examples of similar cases with confirmed diagnoses, informing treatment planning by showing outcomes of different interventions in patients with similar characteristics, facilitating prognostic evaluation by illustrating disease progression patterns in comparable cases, and enhancing medical education by providing relevant examples for training and reference. The retrieved cases may also support quality improvement initiatives by enabling comparison of current practices with similar historical cases, and may contribute to research activities by identifying cohorts of similar patients for retrospective analysis. The system may present the retrieved cases along with relevant clinical information, imaging data, treatment decisions, and outcomes, potentially providing a comprehensive resource for clinicians seeking to leverage past experience to inform current decision-making. In some implementations, the system may also generate summaries or analyses of the retrieved cases, highlighting common patterns, notable differences, or other insights that might be relevant for the current case under consideration.

In some instances, a user may search for other patients who may have a similar lesion severity and plaque burden, as well as similar clinical risk factors (e.g. similar age range, same sex, similar risk factors). The search system may allow the user to specify which features they would like to use in the search query, and determine which model embeddings and derived features to use for finding similar cases (or optionally the system may recommend which features to find matches for, based on relevance for the case at hand).

In other instances, a user may want to find cases with similar gross cardiac anatomy, for example when interpreting a patient scan with abnormal LV shape, for which they may specify the use of a whole image embedding model or a LV mesh or segmentation embedding model, which may have learned representations of variations in LV geometry, together with a LV mass parameter to search for similar cases.

In some instances, a user may want to find previous scans of the same patient who may have had a recent scan, where metadata may be lacking to match the patient to previous scans.

Embeddings from deep learning (generative) models may be used to find the closest matching samples from an existing database from which matches may be determined.

The resulting retrieved cases may be used for a range of downstream tasks. In some embodiments, the retrieved cases may be used for annotation tasks which may be challenging. In some cases, a user may find similar samples to help inform decision making by drawing on the decisions of previous annotators. This may for example be in the annotation of the lumen boundary for lesions with a particular presentation of plaque, and/or artifact, and/or image quality, which may be difficult to interpret. Inspecting annotations of similar samples may help inform how a current sample should be annotated.

In other embodiments, the retrieved cases may be used for treatment planning. For example, when faced with a challenging case with borderline stenosis severity (e.g. FFRCT close to 0.8), and various clinical risk factors and diffuse plaque, a user (e.g. physician) may use the search system to find previous patients with a similar presentation to determine a more informed treatment pathway. Where case notes may be available, they may draw on previous decision making for similar patients to inform current decision making. Similarly, previous outcomes given the selected treatment pathway may be used to inform current decision making (e.g. longer-term effect of stenting, or prescription of certain medications).

In a further embodiment, a user may want to find similar samples both in terms of image characteristics as well as in terms of segmentation quality with respect to the underlying image. To achieve this, the system may leverage the embeddings of multiple input representations, including embeddings from segmentation masks and embeddings from corresponding images, to search for similar samples with respect to both of these embeddings.

In some instances, the system may be used to find similar samples to corner cases of a training set on which a downstream prediction or segmentation model may have poor performance. Retrieved samples may be used to augment the training dataset for the downstream model for improved model performance.

In some embodiments, a user may provide multiple input samples to the system with which to search for other samples. The user may specify a weighting of the importance of each provided sample, to find other samples that may be more or less similar to each provided sample.

In other embodiments, a user may want to find previous scans from the same patient, and may do so using the retrieval system to identify the most similar samples from a database. This for example may use metadata such as age and sex, as well as embeddings from a model that may encode the coronary tree centerlines or the mesh geometry, or the anatomical features in the image data.

### Using Generative Models to Improve Fairness Across Protected Characteristics and in Minority Patient Groups

Improving fairness across protected characteristics in medical imaging artificial intelligence systems represents an advanced methodology for addressing algorithmic bias and ensuring equitable performance across diverse patient populations. The fairness improvement system may be configured to identify and mitigate various forms of bias that may affect the accuracy and reliability of medical imaging analysis algorithms when applied to different demographic groups, clinical populations, and protected characteristic categories. The bias mitigation approach may involve systematic assessment of algorithm performance across different patient subgroups, identification of performance disparities that may indicate the presence of algorithmic bias, and implementation of various technical strategies to reduce bias effects and improve equitable performance across diverse clinical populations.

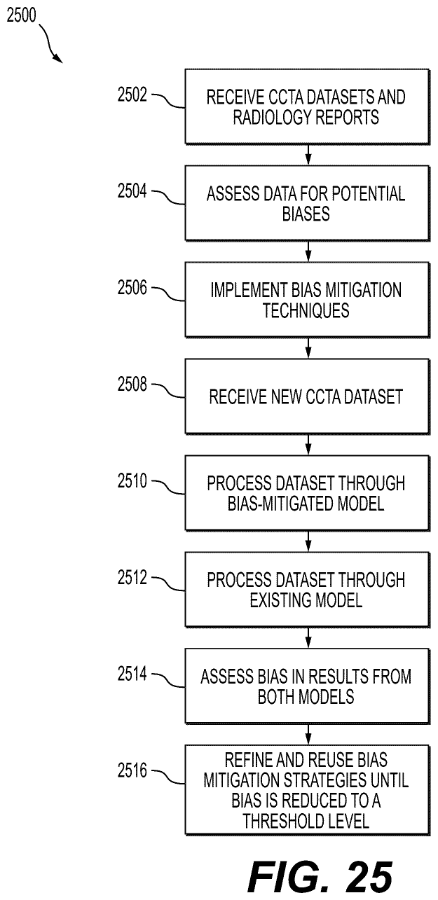

FIG. 25 depicts an exemplary method 2500 for assessing and reducing bias. In step 2502, the method 2500 may include receiving a set of CCTA datasets and radiology reports for these images. The radiology reports may also include patient information (e.g. protect characteristics) such as gender, age and ethnicity, and any other relevant protect characteristics that we want to assess for bias.

In step 2504, method 2500 may include assessing the received data for the presence of bias in the current analysis algorithms. The bias assessment methodology may involve collecting datasets of medical imaging studies that include detailed demographic information and protected characteristic annotations for patients represented in the training and validation datasets. Protected characteristic information may encompass various demographic categories including gender, age, ethnicity, race, socioeconomic status, geographic location, and other patient characteristics that may be associated with systematic differences in disease presentation, imaging characteristics, or clinical outcomes. The demographic data collection process may involve aggregating information from electronic medical records, clinical databases, and other sources that provide comprehensive characterization of patient populations represented in medical imaging datasets. The collected data may also include scanner information.

The algorithmic bias evaluation process may involve systematic analysis of algorithm performance across different demographic subgroups to identify performance disparities that may indicate the presence of unfair or discriminatory algorithmic behavior. The bias assessment methodology may include various performance metrics including sensitivity, specificity, positive predictive value, negative predictive value, and overall accuracy measurements that are computed separately for different demographic groups. The comparative performance analysis may identify situations where algorithms exhibit systematically different performance characteristics for different patient populations, potentially indicating the presence of bias that may affect clinical utility and equitable healthcare delivery.

In step 2506, if bias is detected for any minority patient group or protected characteristic category, the method 2500 may include implementing various bias mitigation strategies to address the identified disparities. These strategies may include, but are not limited to, adversarial training approaches that explicitly penalize the model for making predictions correlated with protected characteristics, domain generalization techniques that improve model performance across different demographic groups without requiring explicit protected characteristic information, and retraining the current analysis model to incorporate synthetic data generated from generative artificial intelligence (GenAI) models. The synthetic data generation approach may help address dataset imbalances by creating additional training examples that represent minority patient groups or rare clinical presentations that may be underrepresented in original training datasets, potentially reducing bias effects that may result from unequal representation of different patient populations. This step 2506 may lead to the development of a trained, bias-mitigated model.

In step 2508, the method 2500 may include receiving a new CCTA dataset for analysis. This dataset may be obtained from clinical sources and may include various patient demographics and protected characteristic information that enables comprehensive bias assessment.

In step 2510, the method 2500 may include, using the trained bias-mitigated model, processing the CCTA dataset. The processing may involve feature extraction, patient-level representation generation, and prediction tasks that were identified as exhibiting bias in the original model. The bias-mitigated model may incorporate architectural modifications, training adjustments, or data augmentation approaches that specifically address the bias patterns identified during the assessment phase. The processing results may include various clinical predictions, risk assessments, or anatomical analyses that can be compared with results from the original model to evaluate bias reduction effectiveness.

In step 2512, the method 2500 may include, using the original trained model not mitigated for bias (i.e., the current/existing model prior to bias mitigation efforts), to process the CCTA dataset in parallel to step 2510. This parallel processing approach may enable direct comparison between the original and bias-mitigated models to quantify improvements in fairness metrics while ensuring that overall clinical performance is maintained. The existing model may generate predictions using its original parameters and processing pipeline, providing a baseline for evaluating the effectiveness of bias mitigation strategies.

In step 2514, the method 2500 may include assessing the results from the original model and the results from the bias-mitigated model for bias. This assessment may involve computing various fairness metrics that quantify performance disparities across different demographic groups and protected characteristic categories. The bias evaluation may include statistical analyses of sensitivity, specificity, positive predictive value, and overall accuracy measurements calculated separately for different patient subgroups. The comparative analysis may focus on performance differences across demographic groups and protected characteristic categories to assess whether bias patterns have been successfully addressed. The comparative analysis may also identify whether performance disparities have been reduced following the implementation of bias mitigation strategies while ensuring that overall clinical utility has been maintained or improved across all patient populations.

Bias evaluation may also encompass multiple quantitative metrics designed to assess fairness across different demographic groups and protected characteristics in medical AI systems. The evaluation methodology may include skew error rate, which measures the difference in error rates between different demographic groups, potentially revealing systematic biases in model performance. Demographic parity assessment may evaluate whether the positive prediction rates are similar across different protected groups, ensuring that the system does not systematically favor or discriminate against specific populations. Equalized odds evaluation may examine whether the true positive rates and false positive rates are consistent across different demographic groups, providing a more nuanced assessment of fairness that considers both sensitivity and specificity. Additional fairness metrics may include equalized opportunity, which focuses specifically on true positive rate parity across groups, and calibration metrics that assess whether predicted probabilities correspond accurately to actual outcomes across different populations. The bias evaluation framework may also incorporate intersectionality analysis to examine how multiple protected characteristics interact and potentially compound bias effects. Statistical significance testing may be employed to determine whether observed differences in performance metrics across groups exceed what would be expected due to random variation. The evaluation process may utilize both aggregate population-level metrics and individual-level fairness assessments to provide comprehensive bias characterization across different scales of analysis.

In step 2516, the method 2500 may include using and refining bias mitigation strategies until bias is reduced to acceptable levels across all demographic groups and protected characteristic categories. This iterative improvement process may involve adjusting the parameters of adversarial training approaches, enhancing the synthetic data generation capabilities of generative models, or implementing additional domain generalization techniques based on the results of ongoing bias assessments. The iterative refinement may continue until fairness metrics indicate that performance disparities have been minimized while maintaining or improving overall clinical accuracy and utility. The system may implement a continuous monitoring framework that periodically reassesses bias patterns as new data becomes available, enabling ongoing refinement of bias mitigation strategies to address evolving fairness considerations in clinical applications.

Generative artificial intelligence models may provide various approaches for addressing identified algorithmic bias through synthetic dataset generation and bias mitigation training strategies. The synthetic dataset generation approach may involve training generative models to produce additional training examples that represent underrepresented demographic groups or clinical presentations that may be associated with biased algorithm performance. The synthetic data augmentation process may help address dataset imbalances that may contribute to algorithmic bias by providing additional training examples that enable algorithms to learn more representative patterns across diverse patient populations.

The adversarial training methodology may represent one approach for reducing algorithmic bias through training procedures that explicitly penalize algorithms for making predictions that are correlated with protected characteristic information. The adversarial training process may involve training machine learning models using dual optimization objectives that simultaneously optimize primary prediction accuracy while minimizing the ability of auxiliary discriminator networks to predict protected characteristics based on learned feature representations. The adversarial approach may encourage algorithms to learn feature representations that are predictive of clinical outcomes while being less sensitive to demographic characteristics that may be associated with biased performance.

The adversarial training architecture may involve primary prediction networks that process medical imaging data to generate clinical predictions such as disease classification, risk assessment, or treatment recommendations. The primary networks may be trained using standard supervised learning approaches that optimize prediction accuracy based on available clinical outcome labels. The adversarial component may involve secondary discriminator networks that attempt to predict protected characteristic information based on the internal feature representations learned by the primary prediction networks. The adversarial training process may involve optimizing the primary networks to minimize both prediction error and the ability of discriminator networks to accurately predict protected characteristics.

The adversarial loss function formulation may involve balancing terms that encourage accurate clinical predictions while discouraging the learning of feature representations that are predictive of protected characteristics. The loss function balancing may involve weighting parameters that control the relative importance of prediction accuracy and bias reduction objectives during the training process. The adversarial training optimization may involve iterative procedures where primary prediction networks and discriminator networks are trained alternately, with primary networks learning to generate feature representations that are less predictive of protected characteristics while maintaining clinical prediction accuracy.

Domain generalization techniques may provide alternative approaches for improving algorithmic fairness by training models that can perform consistently across different demographic groups and clinical populations without requiring explicit protected characteristic information during training. The domain generalization methodology may involve treating different demographic groups as separate domains and training algorithms that can generalize effectively across these different domains. The domain-invariant feature learning approach may encourage algorithms to learn feature representations that capture clinically relevant information while being robust to domain-specific variations that may be associated with demographic differences.

The domain generalization training process may involve various techniques including domain adversarial training approaches that encourage feature representations to be indistinguishable across different demographic domains, meta-learning approaches that train algorithms to adapt quickly to new demographic groups, and regularization techniques that encourage learning of domain-invariant feature representations. The domain generalization approach may enable algorithms to maintain consistent performance across different patient populations without requiring explicit demographic information or protected characteristic labels during the training process.

The synthetic dataset generation methodology for bias mitigation may involve training generative models that can produce realistic medical imaging data representing underrepresented demographic groups or clinical presentations that may be associated with biased algorithm performance. The synthetic data generation process may help address dataset imbalances by creating additional training examples that represent minority patient groups or rare clinical presentations that may be underrepresented in original training datasets. The synthetic data augmentation approach may enable a more balanced representation of different demographic groups during algorithm training, potentially reducing bias effects that may result from unequal representation of different patient populations.

The generative model training for bias mitigation may involve conditional generation approaches that can produce synthetic medical images with specified demographic characteristics or clinical presentations. The conditional generation process may involve training generative models using demographic labels or clinical characteristic annotations that enable controlled generation of synthetic data representing specific patient subgroups. The controlled synthetic data generation may enable targeted augmentation of training datasets to address specific bias issues or demographic imbalances that may affect algorithm performance.

### Using Generative Models (Counterfactual Fairness/Ensembles) to Assess Algorithmic Bias

Assessing algorithmic bias using counterfactual fairness approaches may aid in ensuring equitable performance of medical imaging artificial intelligence systems across diverse patient populations and protected characteristic categories. The counterfactual fairness assessment system may be configured to identify situations where algorithmic predictions may be influenced by sensitive demographic attributes in ways that could lead to discriminatory outcomes or unequal treatment recommendations across different patient groups. The counterfactual fairness evaluation approach may involve generating synthetic scenarios where patient demographic characteristics are systematically modified while maintaining other clinically relevant factors, enabling direct assessment of how demographic variations affect algorithmic decision-making processes and clinical recommendations.

The theoretical foundation of counterfactual fairness assessment may be based on causal inference principles that distinguish between legitimate clinical factors that should influence medical predictions and sensitive demographic attributes that should not affect clinical decision-making in equitable healthcare systems. Counterfactual fairness may be achieved when an algorithmic prediction for an individual patient remains consistent even in hypothetical scenarios where the patient's sensitive demographic attributes are different while all other causally relevant factors remain unchanged. The counterfactual fairness framework may provide a rigorous mathematical foundation for evaluating algorithmic equity by enabling systematic comparison of predictions across different demographic scenarios while controlling for clinically relevant confounding factors.

The generative adversarial network-based approach for counterfactual fairness assessment may involve training specialized generative models that can produce realistic counterfactual scenarios representing alternative demographic characteristics for individual patients. The generative adversarial network architecture may include generator networks that may learn to produce synthetic patient data with modified demographic attributes while preserving clinically relevant characteristics, and discriminator networks that may ensure the realism and clinical plausibility of generated counterfactual scenarios. The adversarial training process may enable the system to learn complex relationships between demographic attributes and clinical presentations while maintaining the ability to generate realistic counterfactual scenarios that preserve causal relationships between clinical factors and health outcomes.

The mediator counterfactual generation process may involve identifying and modeling intermediate variables that may mediate the relationships between demographic attributes and clinical outcomes in ways that could introduce bias into algorithmic predictions. Mediator variables may include factors such as socioeconomic status, healthcare access patterns, lifestyle factors, or environmental exposures that may be correlated with demographic characteristics while also affecting health outcomes and disease presentations. The mediator modeling approach may enable the system to generate counterfactual scenarios where demographic attributes are modified while accounting for the complex causal pathways through which demographic factors may legitimately influence health outcomes versus pathways that may introduce unfair bias.

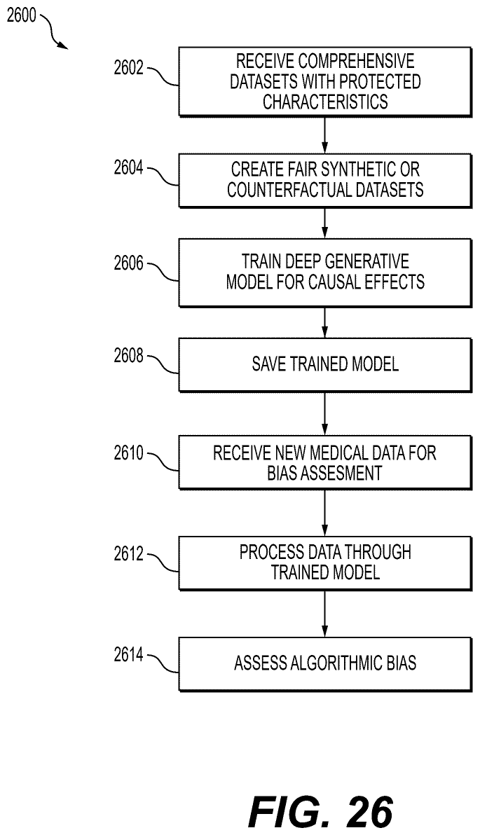

FIG. 26 may depict an exemplary method 2600 for using generative models to assess algorithmic bias in medical imaging analysis systems. The method 2600 may provide a systematic approach for evaluating whether artificial intelligence algorithms exhibit differential performance across various demographic groups or protected characteristic categories. In step 2602, the system may receive comprehensive datasets that may include detailed patient demographic information, longitudinal clinical outcomes, protected characteristics (such as age, gender, ethnicity, socioeconomic status, geographic location), and other relevant variables that may warrant bias assessment. These datasets may serve as the foundation for training and evaluating algorithmic fairness across diverse patient populations. In some implementations, the datasets may include coronary computed tomography angiography (CCTA) volumes, cardiac magnetic resonance imaging studies, echocardiography data, or other cardiovascular imaging modalities that may provide visualization of cardiac structures and pathology.

In step 2604, method 2600 may continue with creating fair synthetic or counterfactual datasets that may enable systematic evaluation of algorithmic performance across different demographic groups. The fair synthetic or counterfactual data may be generated using a generative adversarial network (GAN)-style model that may have been specifically designed to produce realistic patient profiles while controlling for demographic attributes. The training process of the GAN-style model may involve learning to generate synthetic patient profiles where demographic attributes may be systematically modified while maintaining realistic relationships between mediator variables and clinical outcomes. The generator network training may focus on producing counterfactual scenarios that may preserve the causal structure of relationships between clinical factors while enabling systematic evaluation of demographic influence on algorithmic predictions. The counterfactual generation process may incorporate various constraints and regularization techniques that may ensure the synthetic data maintains clinical plausibility while allowing for controlled manipulation of demographic attributes. In some implementations, the synthetic data generation may utilize paired examples where all factors except protected characteristics remain constant, enabling direct assessment of how demographic variations may affect algorithmic predictions.

In step 2606, method 2600 may involve training a deep generative model for estimating causal effects of demographic attributes on algorithmic predictions. In some instances, the generative model is a deep structural causal model (DSCM). This causal modeling approach may enable more sophisticated bias assessment compared to simple statistical comparisons of performance metrics across demographic groups. The deep generative model may incorporate structural causal modeling principles that may distinguish between legitimate clinical factors that should influence predictions and demographic attributes that should not affect clinical assessments in fair algorithms. The training methodology may involve various techniques including adversarial training, variational inference, and counterfactual reasoning that may enable the model to learn complex relationships between patient characteristics, clinical factors, and algorithmic outputs. The causal effect estimation capabilities may allow for quantification of both direct and indirect effects of demographic attributes on algorithmic predictions, potentially identifying subtle forms of bias that might not be apparent from conventional fairness metrics. In some implementations, the model may incorporate domain knowledge about cardiovascular disease mechanisms and risk factors to ensure that causal relationships may reflect established clinical understanding while identifying potential sources of algorithmic bias.

In step 2608, method 2600 may continue with saving the trained model to persistent storage for subsequent deployment and utilization. The storage process may preserve the complete model architecture, learned parameters/weights, and configuration settings necessary for bias assessment applications. The saved model may be formatted for efficient loading and execution in clinical evaluation environments, potentially incorporating optimization techniques that may enhance inference speed while maintaining assessment accuracy. The storage process may also include comprehensive documentation of training datasets, hyperparameter configurations, and performance metrics that may provide context for interpreting bias assessment results. In some implementations, the storage mechanism may incorporate version control capabilities that may enable tracking of model evolution and performance improvements across different iterations of the bias assessment system.

The trained model may be used to assess algorithmic bias, albeit these steps may be performed much later and/or by another entity. In step 2610, the method 2600 may involve receiving a new set of medical data for bias assessment. This data may include coronary computed tomography angiography (CCTA) volumes, cardiac magnetic resonance imaging studies, or other cardiovascular imaging modalities along with associated patient demographic information and/or clinical parameters. The input data may undergo preprocessing steps similar to those applied during model training, which could include image normalization, quality assessment, and formatting to ensure compatibility with the trained model's input requirements. The preprocessing may also involve extraction of metadata such as acquisition parameters, demographic information, or clinical factors that might influence the bias assessment process. In some implementations, the system may perform automated quality control checks to ensure that the input data meets minimum quality standards for reliable bias evaluation.

In step 2612, method 2600 may continue with processing the new data through the trained model to generate predictions and counterfactual scenarios for bias assessment. The processing may involve multiple stages including feature extraction from medical images, encoding of demographic information, generation of counterfactual scenarios with modified demographic attributes, and prediction of clinical outcomes across both original and counterfactual scenarios. The counterfactual generation process may systematically modify demographic attributes while maintaining other clinically relevant factors, enabling direct comparison of algorithmic predictions across different demographic scenarios. In some implementations, the system may generate multiple counterfactual scenarios for each input case, representing various demographic configurations to enable comprehensive bias assessment across different protected characteristic categories.

In step 2614, method 2600 may conclude with assessing algorithmic bias based on comparison of predictions between original and counterfactual scenarios. The bias assessment may involve computing various fairness metrics that may quantify differences in algorithmic performance across demographic groups and protected characteristic categories. These metrics may include demographic parity measures that may assess whether prediction distributions are similar across different groups, equalized odds metrics that may evaluate whether false positive and false negative rates are consistent across demographic categories, and counterfactual fairness measures that may assess whether predictions remain consistent when demographic attributes are modified while maintaining other clinically relevant factors, at least within predetermined threshold(s). The assessment process may generate comprehensive reports that may document identified bias patterns, quantify their magnitude and statistical significance, and provide recommendations for potential mitigation strategies. In some implementations, the system may incorporate visualization tools that may illustrate bias patterns through intuitive graphical representations, potentially enhancing interpretability for clinical stakeholders and algorithm developers. The bias assessment results may inform subsequent model refinement efforts, potentially guiding the development of more equitable algorithms that may provide consistent performance across diverse patient populations.

Multi-Modal Biomarker Discovery from Generative and Predictive Models for Clinical Use

CCTA data contains rich information which can be used to quantify the severity of a range of diseases. Many image features have already been established as relevant to the diagnosis and quantification of disease severity in the coronary arterial circulation, including quantification of coronary plaque and its subtypes, the quantification of lumen geometry-derived features such as percent diameter stenosis, and the computation of FFRCT for the physiological evaluation of disease severity. A broader set of cardiovascular diseases (e.g. aortic stenosis, hypertrophic cardiomyopathy, left atrial enlargement, etc.) similarly can be diagnosed via a range of established image-derived features, including assessment of left ventricular shape and size, cardiac chamber volumes at diastole and systole, characterization of calcifications surrounding cardiac valves, quantification and characterization of epicardial fat and thoracic fat, etc.

Deep learning models afford practitioners the ability to probe the rich learned representations of such models to identify potential new biomarkers predictive of disease, which may not yet have been identified via traditional approaches. Such novel biomarkers can be identified for example from generative models or predictive models, trained on CCTA as well as other modalities (e.g. MRI, echo, ECG, EMR data), and could be used by practitioners as new interpretable metrics to enhance diagnosis. Mechanisms for identifying such biomarkers include: Identifying relevant visual attributes from generative models informative of downstream prediction tasks (e.g. risk of acute coronary syndrome, or of the presence of certain clinical risk factors such as hypertension), Saliency mechanisms for convolutional neural networks, including Grad-CAM, guided back-propagation, which can enable novel visual features to be identified in relation to downstream tasks.

Novel learned biomarkers specific to the prediction of cardiovascular diseases can be discovered by such mechanisms in novel ways by combining multiple modalities and/or signals derived from these modalities as inputs to the biomarker discovery system. Modalities can include imaging (e.g. coronary CTA, non-contrast CT, MR and echocardiography), clinical reports, traditional clinical risk factors, ECG signals, plethysmography signals, genomic data, lab tests, wearable device signals, etc.

Certain biomarkers may require more than a single modality to be identified, where a multi-modal machine learning model can be used to learn relevant combinations of features across modalities that provide powerful new descriptors and predictors of disease and/or treatment outcomes. Additionally, machine learning models for biomarker discovery may ingest derived parameters from one or more other machine learning models (e.g. lumen segmentation, and/or centerline tree representation with derived/computed centerline properties, and/or large structures meshes), and/or from one or more biophysical models (e.g. flow and pressure and FFRct computed in the coronary tree from a Navier-Stokes model, or strain and/or contractility of the myocardium from a large deformation mechanics model) to learn biomarkers across raw input signals (e.g. image pixels) as well as derived signals. Such biomarkers may be discovered for the prediction of certain events such as acute coronary syndrome, heart failure, or cardiovascular death; similarly, such biomarkers may be discovered for the prediction of more general risk factors such as diabetes, hypertension, dyslipidemia, and smoker status. Novel identified biomarkers could in turn be used in an interpretable and quantifiable fashion by practitioners, independently of the generative or predictive deep learning models used to identify them in the first place.

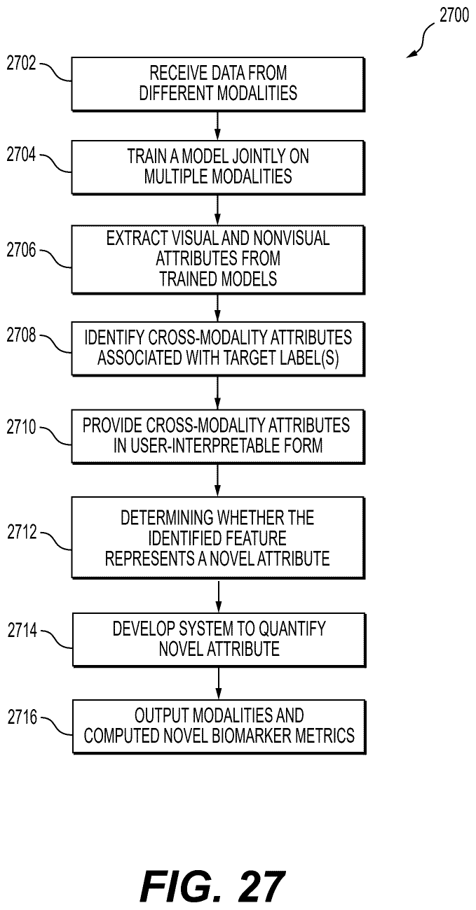

FIG. 27 illustrates a flowchart of a method 2700 for multi-modal biomarker discovery from generative and predictive models for cardiovascular disease assessment. The method 2700 provides a systematic approach for identifying novel biomarkers/attributes that may span multiple data modalities and may potentially enhance clinical decision-making through improved risk stratification and disease characterization.

In step 2702, method 2700 may begin with receiving data from different modalities that may include various types of medical information relevant to cardiovascular assessment. These modalities may include, but are not limited to, coronary computed tomography angiography (CCTA) images providing detailed visualization of coronary arteries and cardiac structures, electrocardiogram (ECG) signals showing cardiac electrical activity, magnetic resonance imaging (MRI) data offering tissue characterization and functional assessment, ultrasound (US) studies providing real-time cardiac visualization, genomic data containing genetic risk factors, laboratory test results indicating biomarker levels, and wearable sensor data capturing physiological parameters over time. The multi-modal data collection may enable comprehensive analysis of cardiovascular health from complementary perspectives, potentially revealing relationships between different physiological systems that may not be apparent when examining single modalities in isolation.

In step 2704, method 2700 continues with training a model jointly on multiple modalities from which cross-modality biomarkers may be discovered. This step may include several options for model development: a) Given target labels (e.g., clinical outcomes such as acute coronary syndrome or myocardial infarction, and/or clinical risk factors such as hypertension, diabetes, or dyslipidemia), the system may train a model that predicts one or more such labels from modality 1 (e.g., CCTA data) jointly with other available modalities (e.g., ECG, MRI, US, genomic data, wearable sensor data). The joint training approach may enable the model to learn complex relationships between features across different data types that may collectively contribute to cardiovascular risk or disease manifestation. b) Optionally, in addition to approach (a), the system may train a generative model, such as a variational autoencoder, generative adversarial network, or diffusion model, that learns embeddings to produce realistic samples from a given modality, e.g., CCTA image data, in addition to any other available modalities. The generative model may ingest multiple modalities simultaneously to learn joint representations, or alternatively, modality-specific generative models may be trained separately before combined use in subsequent analysis steps. The predictive models from approach (a) may be used to fine-tune the generative model(s) to produce counterfactuals in relation to the target labels described in approach (a), enabling exploration of how changes in specific features across modalities may influence clinical outcomes or risk factors. This approach may facilitate the identification of novel biomarkers by systematically manipulating features in the generative space and observing their effects on predicted outcomes.

The system may utilize any suitable generative and predictive models for biomarker discovery, providing flexibility in implementation based on specific clinical requirements and data characteristics. Generative models may include diffusion models that gradually transform noise into structured medical data through iterative denoising processes, variational autoencoders that learn probabilistic latent representations of medical data enabling controlled generation of new samples, generative adversarial networks that use competitive training between generator and discriminator networks to produce realistic medical data, or autoregressive models that generate data sequentially by modeling conditional probabilities. Predictive models may include regression models for continuous outcome prediction (such as time-to-event or risk scores), classification models for categorical outcome prediction (such as disease presence or absence), or segmentation models that identify and delineate anatomical structures or pathological regions within medical images. The selection of specific model architectures may depend on factors such as data dimensionality, sample size, computational resources, and the specific biomarker discovery objectives.

In step 2706, visual attributes (e.g., from medical images) and non-visual attributes (e.g., from genomic data, ECG signals, or laboratory values) from the trained models. These attributes may represent features or patterns that the models have identified as potentially relevant for clinical prediction tasks. The attributes may be derived using various techniques: Counterfactuals from the generative models, which may be generated by systematically manipulating latent variables to maximize sensitivity of a downstream predictor, thereby revealing features that strongly influence clinical outcomes; attention maps that highlight regions of input data that receive high attention weights in transformer-based or attention-augmented models, indicating areas of particular importance for prediction; and saliency maps from the predictive models that highlight features in the input data which are most important for the model prediction, using techniques such as gradient-based attribution methods, layer-wise relevance propagation, or integrated gradients. These visualization approaches may provide insights into which aspects of the multi-modal data are most informative for clinical predictions, potentially revealing novel biomarkers that span traditional diagnostic boundaries.

In step 2708, method 2700 may continue with identifying cross-modality visual (or non-visual) attributes most significantly associated with the prediction of a target label (e.g., myocardial infarction), or combination of target labels (e.g., diabetes, hypertension and BMI). Cross-modality visual attributes are those associated with at least 2 input modalities, representing patterns or features that span multiple data types and may collectively contribute to clinical outcomes. The identification process may involve statistical analysis of feature importance scores across modalities, examination of attention patterns in multi-modal models, or analysis of latent space trajectories in generative models when manipulating specific clinical variables. The system may rank identified cross-modality attributes based on their statistical significance, effect size, or consistency across different model architectures or training runs, helping to prioritize the most promising candidate biomarkers for further investigation. This step may be particularly valuable for discovering complex relationships between different physiological systems that may not be apparent when examining single modalities in isolation.

In step 2710, method 2700 may involve providing the cross-modality visual attributes for all available modalities in a form interpretable to a user, facilitating clinical understanding and potential application of the discovered biomarkers. This presentation may take various forms, including: As a series of counterfactual images animating the change in the image features most associated with prediction of a patient label, together with counterfactual EC traces indicating changes most strongly associated with the target label, enabling clinicians to visualize how coordinated changes across modalities may relate to disease risk or progression; alternatively as a heatmap, indicating the specific visual features that the model relies on to make a prediction in image data or continuous signals from any 1D (such as ECG or time-series laboratory values), 2D (such as standard radiographic images), 3D (such as CCTA or MRI volumes), or 4D (such as time-resolved 3D imaging) modality. The visualization approaches may be customized based on the specific modalities involved and the clinical context, with the goal of making the identified cross-modality biomarkers accessible and interpretable to healthcare providers who may not have expertise in machine learning or data science.

In step 2712, method 2700 may continue with determining whether the identified feature represents a novel attribute, potentially involving expert user input to triage out known and confounded attributes. This evaluation process may help distinguish truly novel biomarkers from established relationships or spurious correlations. For example, an example of known cross-modality attributes may include: An increase in patient age, an increase in patient lipid levels, and the progression of plaque to a state of increased severity are each associated with an increase in major adverse cardiovascular events (MACE). Cross-modality attributes highlighting these changes may be triaged out as established joint changes that commonly occur in association with an increase in MACE, as these relationships are already well-documented in clinical literature. In contrast, an example of a possible novel cross-modality attribute may include: The simultaneous change in dimension or shape of a certain cardiac structure in a CCTA image accompanied by a change in R-R interval duration from ECG are identified as a new cross-modality biomarker in relation to a target label (e.g., specific disease subtype or treatment response), which has not been previously identified in clinical research. The novelty assessment may involve literature review, consultation with clinical experts, and comparison with established risk factors and biomarkers to determine whether the identified relationship represents a genuinely new finding with potential clinical utility. This assessment may be carried out automatically by the system (cf. agentic AI), with and without guidance by a domain expert.

In step 2714, method 2700 may involve developing a system that may provide a quantification of the novel attribute from the input modalities to provide an interpretable metric for users. This quantification system may, for example, directly measure the length of the structure from CCTA identified in the example in step 2712, and the R-R interval duration, and provides thresholds of severity for the interpretation of the biomarker in relation to the target label. The quantification approach may involve developing standardized measurement techniques, establishing reference ranges based on population data, and creating severity classification systems that translate continuous measurements into clinically meaningful categories. The system may incorporate automated measurement tools that can extract the relevant parameters from raw imaging data or physiological signals, potentially enabling efficient integration into clinical workflows. The quantification methodology may be designed to be reproducible across different imaging systems or acquisition protocols, ensuring consistent biomarker assessment regardless of the specific equipment used for data collection.

Optionally, method 2700 may include assessing the novel attribute's importance in the identification and/or quantification of disease severity in relation to other known contributors (e.g., quantify how important the novel attribute is in comparison to plaque volume for the prediction of acute coronary syndrome), providing context for the clinical significance of the newly identified biomarker. This assessment may be performed through various approaches, including: correlating a measure of the novel attribute with the severity or presence of the target label(s), using statistical methods such as Pearson or Spearman correlation, regression analysis, or survival analysis to quantify the strength of association between the biomarker and clinical outcomes; and/or performing feature importance analysis of a multi-variable predictive model (e.g., predicting acute coronary syndrome), to determine the added value of the novel attribute in relation to established contributing parameters. This analysis may utilize techniques such as permutation importance, SHAP (SHapley Additive explanations) values, or partial dependence plots to quantify the relative contribution of different variables to model predictions. The importance assessment may help determine whether the novel biomarker provides incremental prognostic or diagnostic value beyond existing clinical factors, which may be crucial for establishing its potential utility in clinical practice.

In step 2716 of method 2700, the system may provide the modalities used to compute the novel attribute(s)/biomarker(s) identified above and provide the computed novel biomarker metrics for the user. This output may include visualization of the relevant imaging features or physiological signals, quantitative measurements of the biomarker values, interpretation guidelines that help clinicians understand the significance of different biomarker levels, and potentially decision support recommendations based on the biomarker assessment. The system may present this information through interactive displays that allow users to explore the relationships between different modalities and clinical outcomes, potentially enhancing understanding of complex physiological interactions. The biomarker reporting may be designed to integrate with existing clinical documentation systems, enabling efficient incorporation into patient records and clinical decision-making processes. By providing comprehensive information about the novel biomarkers in an accessible format, the system may facilitate translation of these research findings into practical clinical applications that may ultimately improve cardiovascular risk assessment and patient care.

### Watermarking and Identification of Generated (CT) Images

As generative AI algorithms become more advanced, it may become harder for humans to tell the difference between real and synthetic or modified CT image data. AI-generated and AI-modified image data can be helpful for a range of applications, including data augmentation for training downstream AI models (e.g. for outlier sample generation), or counterfactual image generation to simulate the effects of certain interventions. Synthetic or modified CT data could be used to misrepresent a patient's disease (e.g. by removing or adding disease), raising the need for the ability to detect generated or AI-modified CT image data. Watermarking AI-modified or AI-generated images may help ensure such images are used for their intended purpose. A watermark may be an imperceptible signal embedded in an image which can be tested for and extracted with a “reverse-image-hiding” algorithm.

As part of a pipeline for the generation or modification of image data with a generative AI model, a watermark can be embedded into the image with an algorithm. The watermarking process should be an integral part of the pipeline to create images with the generative model. For example, a publicly accessible web interface to use the generative model should have the watermarking algorithm applied to all images, so that in the event of the image being copied elsewhere, it will contain the watermark and can be detected.

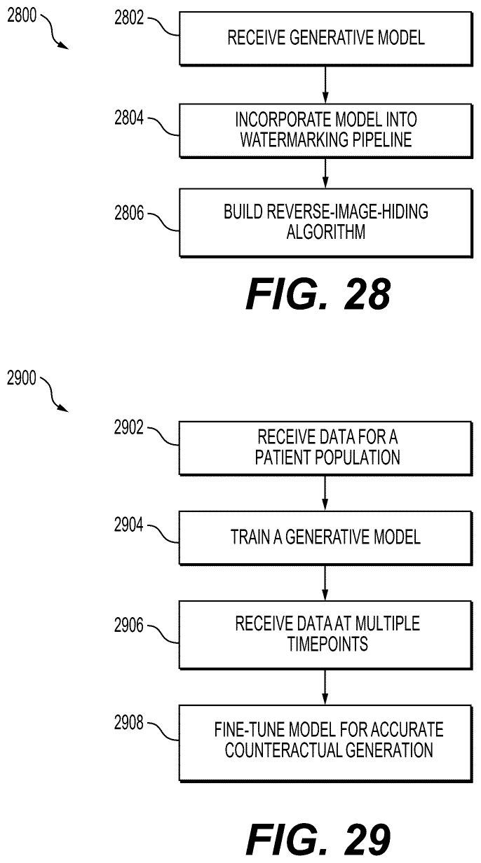

FIG. 28 depicts an exemplary method 2800 for watermarking and identifying generated images, which may provide mechanisms for ensuring the authenticity and proper use of AI-generated medical imaging data.

In step 2802, the system may receive, determine, or generate a generative model that can create images or counterfactual images (e.g. of CTA or other medical image data) in accordance with techniques discussed herein. The generative model may be implemented using various architectures such as deep structural causal models, generative adversarial networks, diffusion models, or other suitable approaches capable of producing realistic medical images. In some embodiments, the generative model may have been previously trained on large datasets of medical images to ensure high-quality output that maintains clinical relevance while supporting various downstream applications.

In step 2804, the system may incorporate this generative model into a pipeline which embeds a watermark in generated or modified images. The watermarking process can be implemented as an integral component of the image generation workflow, ensuring that synthetic images contain imperceptible yet detectable markers. The watermarking algorithm may utilize various techniques such as frequency domain modifications, spatial domain alterations, or deep learning-based approaches that can embed information without significantly affecting the diagnostic quality or visual appearance of the medical images. In some implementations, the watermark could encode metadata about the image generation process, including model version, generation date, or intended use classification. For general use of a generative model, the pipeline may be configured to ensure a watermark is embedded in output images; an example implementation could involve a publicly-accessible web interface to a generative model, where the system can be designed to automatically apply the watermarking process to each generated image before delivery to the end user, thereby maintaining provenance tracking capabilities regardless of how the images might be subsequently distributed or utilized.

Incorporating the watermarking system into the generative model may provide enhanced robustness and security benefits. By integrating the watermarking functionality into the generative model architecture, the system may ensure that outputs are watermarked by design. This approach may help prevent watermarking from being bypassed or omitted during the generation process. While traditional watermarking systems may add structured noise to the frequency or spatial domain of an image, a neural network-based approach may learn to embed non-linear watermark signals within the neural network's embedding space, which may be more challenging to detect and remove.

In step 2806, the system may build a “reverse-image-hiding” algorithm for use in detecting the watermark. This detection algorithm may be designed to analyze medical images and determine whether they contain the specific watermark pattern embedded by the generation pipeline. The detection process could involve various signal processing techniques, statistical analysis methods, or machine learning approaches capable of identifying the subtle patterns that constitute the watermark. In some embodiments, the detection algorithm may be designed with robustness against common image modifications such as compression, cropping, or minor editing that might otherwise interfere with watermark detection. The sensitivity and specificity of the detection algorithm can be calibrated to balance between minimizing false positives and ensuring reliable identification of AI-generated content.

In some embodiments, the “reverse-image-hiding” algorithm corresponding to the watermarking algorithm may be used for “De-watermarking”: As part of a data pre-processing pipeline when using the generated images for intended purposes by authorized parties, such as for outlier sample generation for downstream model training, training samples can be “de-watermarked.” This de-watermarking capability may be helpful in research contexts where the presence of watermarks could potentially influence the learning process of downstream models. The de-watermarking process could be implemented with various levels of access control to ensure that only properly authenticated users with appropriate permissions can remove watermarks from generated images. In certain implementations, the system might maintain audit logs of de-watermarking operations to support governance and compliance requirements.

The watermarking/dewatermarking model may be implemented with an embedding network and a corresponding detection/reconstruction network. During the image generation pipeline, the embedding network may introduce a subtle watermark that may be substantially imperceptible to human observers. The detection/reconstruction network may be trained to perform the inverse operation. The training objective may involve minimizing a composite loss function that may balance three components. The first component may be a perceptual loss that may reduce differences between the original and watermarked images to help maintain watermark invisibility. The second may be a reconstruction fidelity loss that may enable the reconstruction network to remove the watermark and restore the original image. The third may be a detection loss that may train the system to classify whether an image contains the embedded watermark. In other embodiments, the reverse image hiding algorithm may be used in order to detect whether images “in the wild” (e.g. online, or in a hospital PACS as the result of a suspected unauthorized intervention) were generated or modified by a watermarking generative model pipeline. Images can be assessed with the “reverse-image-hiding” algorithm to determine if they were generated by AI, without necessarily providing a “de-watermarked” image as output. This detection capability may serve important quality control and security functions in clinical environments where the provenance of medical images is critical for patient care decisions. The detection system could be integrated with existing medical imaging workflows through various implementation approaches, such as DICOM plugins, standalone verification tools, or cloud-based services that can analyze images upon upload or retrieval. In some implementations, the detection results might include confidence scores or probability estimates regarding the likelihood that an image was generated or modified using AI techniques.

### Using Generative Models to Aid in CAD Monitoring

In some implementations, counterfactuals of disease progression generated by a generative model may be utilized as a comparative benchmark to evaluate observed patient-specific disease progression, potentially aiding in various aspects of clinical decision making. As additional labeled disease progression data may be collected over time (e.g., serial CTA scans together with patient clinical characteristics, treatment data, and other serial tests), predictors and generative models for disease progression may become increasingly sophisticated and accurate. In certain embodiments, a generative model of disease progression, conditioned on a patient's data at baseline along with information about changes in lifestyle, medication regimens, and other therapeutic interventions, may be configured to generate counterfactuals of disease progression at various subsequent time points. When a patient attends a follow-up appointment and additional diagnostic data is acquired, the counterfactuals previously produced for the patient at that specified future time-point can potentially provide an indication of expected disease progression patterns. These counterfactuals may represent the expected disease progression trajectory derived from population-level data while being specifically conditioned on the individual patient's clinical parameters, effectively functioning as a “population-derived progression model” tailored to the specific patient's baseline characteristics. The comparative analysis between the algorithmically generated samples of a patient's projected disease progression and the actually observed disease state at a follow-up examination may be utilized to inform clinicians whether the patient's disease has progressed as anticipated, potentially providing a visual and quantitative illustration of the patient's clinical trajectory relative to model-based expectations.

FIG. 29 depicts an exemplary method 2900 for using generative models to aid in CAD monitoring. In step 2902, the system may receive data for a patient population. This data may include CTA image data in various formats and resolutions, along with any additional available patient data that could potentially influence disease progression (e.g., clinical risk factors such as diabetes status, hypertension measurements, BMI values, hyperlipidemia profiles, smoker status, medication regimens and adherence patterns, ECG data including rhythm and conduction parameters, other imaging modalities such as echocardiography or MRI, wearable device data capturing activity levels or physiological parameters, genomic data including relevant polymorphisms, etc.). In some implementations, CTA image data may be represented in various formats to optimize processing, such as 2D or 3D patches of varying dimensions extracted from the cardiac region, or can be processed as 2D or 3D samples captured along the coronary arterial tree in the form of curved planar reconstruction images that follow vessel centerlines. These representations may be preprocessed using various techniques such as normalization, artifact removal, or enhancement algorithms to improve data quality for subsequent analysis.

In step 2904, a generative model for CTA may be trained that is conditioned on all other available data variables where feasible. The generative model may be implemented using various architectures, including using techniques discussed elsewhere herein, such as a deep structural causal model, where a causal graph can be defined to represent relationships between different patient parameters and the image data. This causal structure may enable the model to distinguish between correlative and causal relationships, potentially improving the accuracy of generated counterfactuals. The training process may incorporate various regularization techniques, validation approaches, and hyperparameter optimization strategies to enhance model performance and generalizability across diverse patient populations.

In step 2906, the system may receive follow-up data acquired at a subsequent timepoint. This follow-up data may include imaging studies performed at various intervals after baseline assessment of an initial baseline scan, potentially ranging from months to years depending on clinical protocols and patient-specific factors. The follow-up data may be collected using standardized acquisition protocols to ensure comparability with baseline measurements, although the system may also be designed to accommodate variations in imaging parameters or equipment specifications that might occur between examinations.

In step 2908, the system may fine-tune the generative model to generate more accurate counterfactuals based on changes to various patient parameters (e.g., medication types, dosages and adherence patterns, invasive or non-invasive procedures, lifestyle modifications such as dietary changes, exercise regimens, or smoking cessation efforts, etc.). This fine-tuning process may utilize transfer learning techniques, where the pre-trained model is adapted using smaller datasets of longitudinal patient data to capture temporal progression patterns. The fine-tuning methodology may incorporate various optimization strategies such as stochastic gradient descent, optionally with momenta and adaptive estimates thereof, for example, learning rate schedules, and regularization approaches to prevent overfitting while enabling the model to learn meaningful relationships between interventions and disease outcomes. The objective of this fine-tuning process is to enable the generated counterfactuals to more accurately reflect future time points of disease progression under different intervention scenarios.

Given a patient who has undergone a baseline and a follow-up CCTA monitoring scan, the system may utilize the generative model to produce counterfactual images, using techniques discussed throughout herein, showing the expected progression of disease at the time point of the follow-up CCTA scan. These counterfactuals can be conditioned on the various therapeutic and lifestyle changes implemented by the patient since the baseline scan, potentially including medication adjustments, procedural interventions, or behavioral modifications. The counterfactual visualizations may display various aspects of coronary pathology, such as plaque characteristics in CPR images at different vessel locations and orientations, along with derived quantitative metrics such as percent diameter stenosis measurements, volumetric plaque quantification, plaque composition analysis, and functional parameters like FFRcr values at various points throughout the coronary tree. The visualization formats may be customizable to match clinical preferences and reporting standards used in different practice settings.

The system may utilize the generated counterfactuals as a comparative reference to evaluate actual disease progression observed in the acquired follow-up CTA scan, potentially informing subsequent treatment planning decisions. For example, clinicians may assess whether the patient's disease has progressed or regressed as anticipated in relation to the generated counterfactuals, and based on this comparative analysis, may consider various therapeutic adjustments such as medication dosage modifications, introduction of additional pharmacological agents, consideration of interventional procedures, or recommendations for lifestyle modifications. The system may provide quantitative metrics comparing predicted versus actual disease progression, potentially including statistical measures of similarity or deviation between counterfactual and actual imaging findings across multiple anatomical locations and pathological parameters.

The system may also generate alternative counterfactuals at the date of the follow-up CTA monitoring scan without conditioning on the therapeutic or lifestyle changes implemented by the patients since the baseline scan. These alternative counterfactuals may serve to illustrate how the disease might have potentially progressed under different circumstances, such as in the absence of specific interventions or with lower or higher adherence to recommended treatments. This comparative visualization approach may provide educational value for both clinicians and patients by demonstrating the potential impact of therapeutic decisions on disease trajectory, potentially enhancing treatment adherence and clinical decision-making. The system may present these alternative counterfactuals alongside the actual follow-up images and intervention-conditioned counterfactuals to facilitate multi-scenario comparison.

The system may further generate additional counterfactuals at the date of the follow-up CTA monitoring scan conditioning on various hypothetical changes the patient could have potentially implemented since the baseline scan. These hypothetical scenarios may include alternative medication regimens, different intensities of lifestyle modifications, or various combinations of interventions that might have been considered but not implemented. Such counterfactual scenarios may help illustrate the range of possible disease trajectories that could have occurred under different management approaches, potentially informing future treatment decisions by highlighting intervention strategies that might have yielded more favorable outcomes. The system may allow for interactive exploration of these hypothetical scenarios, enabling clinicians to adjust various parameters and observe the corresponding effects on predicted disease progression.

The system may also generate prospective counterfactuals at future dates beyond the current follow-up CTA scan to illustrate how disease may be expected to further progress or regress over various time horizons. These future projections may be conditioned on anticipated therapeutic modifications (e.g., planned medication dosage adjustments, scheduled interventional procedures) and the projected time interval until subsequent imaging evaluation. In some implementations, these future projections may optionally be conditioned on the current follow-up CTA scan findings, potentially providing more personalized projections that account for the patient's observed disease trajectory to date. These future projections may assist with longer-term treatment planning by illustrating potential outcomes of different therapeutic strategies over extended time periods. The system may generate these projections at multiple future time points (e.g., 6 months, 1 year, 5 years) to illustrate both short-term and long-term disease trajectory patterns under various management approaches.

Optionally, the system may provide a comprehensive set of quantitative metrics relevant for diagnosis, prognosis, treatment planning, monitoring, or risk prediction at various future time points. These metrics may include, but are not limited to: FFRct values at multiple locations throughout the coronary tree, potentially including branch vessels and distal segments; Detailed plaque characteristics such as volume, composition (calcified, non-calcified, mixed), remodeling index, napkin-ring sign presence, spotty calcification patterns, and low-attenuation plaque quantification; Various metrics related to pericoronary adipose tissue (PCAT) such as attenuation patterns, volume measurements, and inflammatory markers; and/or comprehensive risk assessments for various adverse cardiovascular events, potentially including acute coronary syndromes, myocardial infarction, need for revascularization, heart failure development, or cardiovascular mortality, with corresponding confidence intervals or probability distributions to represent prediction uncertainty. These metrics may be presented in various formats including numerical values, trend graphs showing projected changes over time, color-coded visualizations overlaid on anatomical images, or comparative displays showing values across different counterfactual scenarios.

Most Informed Model: Improving and Adapting Digital Twins with New Patient

Patients may undergo a series of physician-ordered tests, where each additional test may reveal further information about the patient's condition, diagnosis, prognosis and treatment options. Disease may often be multi-faceted, and multiple tests may be performed to provide physicians with the information needed to determine the optimal treatment plan. While physicians may be trained to interpret individual tests as well as interactions between tests to inform decision making, there may be other mechanisms to combine patient data algorithmically to further enhance patient diagnosis and treatment options.

Software as a medical device (SaMD) may ingest a fixed set of input modalities and clinical tests to provide outputs such as making a disease classification, a prediction of patient risk, or a treatment pathway recommendation. One instantiation of SaMD may be a digital twin, which may be one or more computational representations of patient data, including biophysical and/or machine learning models. Digital twins may be built from multiple input sources. A digital twin of a patient may be used for various purposes, such as diagnosis, treatment planning, prognosis and risk prediction. If this digital twin reflects the actual patient, its accuracy in these clinical applications may improve. Inclusion of additional modalities as they become available for a patient may improve (1) the accuracy of existing models, and (2) expand on or enhance capabilities of digital twins.

A digital twin which may be flexible in how it can ingest new data may allow physicians to gain further insights into their patient data with each additional test that becomes available, by means of incorporating each data source automatically or semi-automatically into said model, and providing updated predictions, computations, and recommendations for patient care.

In this disclosure a “most informed model” for cardiac care using CT may be described. A most informed model may be one that may be able to ingest additional data as they become available from other tests and modalities.

Availability of modalities that may provide improved accuracy in the computation of any intermediate representation or output of the model may be leveraged by the system. One example may be a model that ingests a coronary computed tomography angiography (CCTA) image, and outputs a geometric model of the patient coronary tree, quantification of plaque, and computation of physiological parameters in the coronary circulation. Certain assumptions and limitations may be faced by the model using CCTA image data alone to produce an output (e.g. resolution limitations, artifacts, physiological assumptions), which may be improved with the acquisition of additional modalities. These may include higher resolution invasive tests such as X-Ray fluoroscopy, optical coherence tomography (OCT) or intravascular ultrasound (IVUS), which may be used to update the geometric model, plaque quantification and physiology models.

Similarly, a digital twin used for risk assessment and treatment planning may be built using inputs from multiple modalities. Inclusion of additional relevant patient parameters, for example additional clinical test metrics, or predictions of relevant features from machine learning algorithms applied to various data sources, may enhance the predictive accuracy of a system used for risk assessment, and/or treatment planning, and/or enable the model to be used for the estimation of risk of other cardiovascular and non-cardiovascular conditions (e.g. risk of heart failure, various cancers, aortic dissection, post-operative success of an intervention, etc.).

Data may be acquired before or at some future time point after an initial CT scan, as snapshots (e.g. imaging scans, clinical tests) or as continuous signals (wearable device monitoring signals). A most informed model may be designed flexibly to leverage available data at any given time-point, making certain assumptions (e.g. regarding boundary conditions of a biophysical model) and being subject to limitations (e.g. resolution limits of computed tomography angiogram (CTA), compared to invasive imaging, for deep learning-based lumen segmentation) of available data, which may be improved with acquisition of other modalities.

There may be different methods of combining multiple modalities and time points of data for a patient. One option may be for the construction of a biophysical model, or “digital twin,” personalized to the patient. A biophysical model may typically use mathematical equations that describe the underlying biomechanical, biological and physiological processes that may govern the behavior of a structure, or organ, organ system (e.g. the combined biomechanics, electrophysiology, and blood flow of the heart). As new modalities may be acquired for a patient, the patient-specific digital twin (e.g. of the heart or entire cardiovascular system) may be updated to capture the observed data (e.g. by data assimilation methods, or directly updating model parameters) and better inform the underlying mechanisms of disease, improving accuracy of clinically relevant parameters. Another option for combining multiple data sources may be through use of machine learning models applied to the additional modalities or time points to produce one or more predictions, e.g. predicting biomarkers and diseases in the form of classification or any other predicted output, which may be incorporated into one or more downstream models to interpret these predictions alongside any other parameters for diagnosis and treatment planning.

Additionally, another possible extension of the most informed model may be to use a multi-modal foundation model, which may ingest any or all of the above modalities and above model outputs, to provide insight into the patient's health. For example, a multi-modal foundation model may identify relevant features in each modality as well as connections between modalities to inform clinical decision making. A multi-modal foundation model may be trained to interpret all possible data sources acquired for a patient and be updated with additional data as they are acquired, providing powerful embeddings that may enable integrative reasoning about patient data to help physicians identify important factors for consideration in diagnosis and treatment planning.

The most informed model system may also optionally be used in an interactive fashion, whereby the system may be queried by a user for insights into the model's decision making, and in relation to any of the available patient data. The system may also leverage retrieval mechanisms to find similar cases from a patient database from which to draw comparisons for patient decision making.

This most informed model may be deployed in a range of settings, including but not limited to being embedded in a workstation at a clinical site, and integrated into a local Picture Archiving and Communication System (PACS) system where data may become available; the system may be deployed on a mobile device, where data and models may for example be accessed remotely or locally.

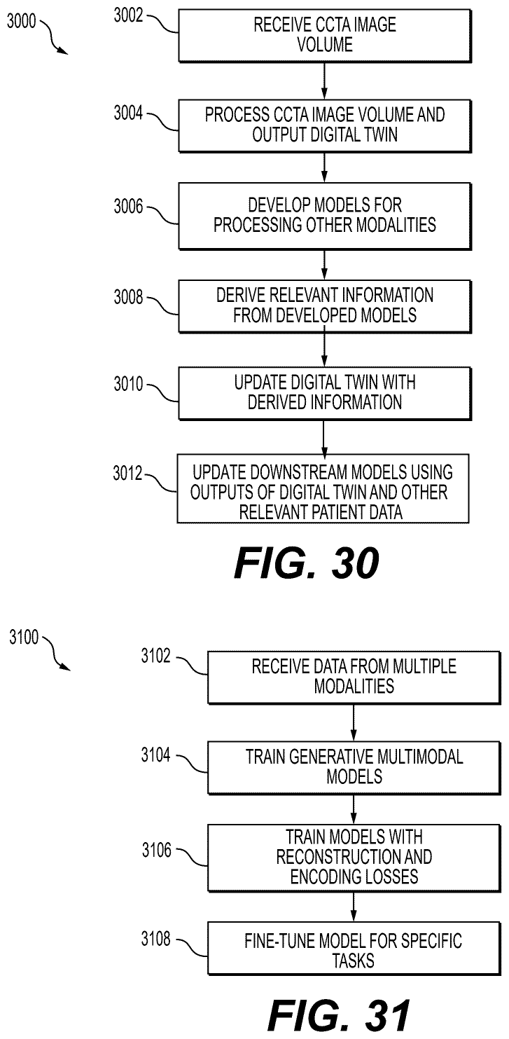

FIG. 30 depicts an exemplary method 3000 to generate and update a digital twin model, which may provide a comprehensive computational representation of a patient's cardiovascular system that can be dynamically refined as additional clinical data becomes available.

In step 3002, the system may receive at least one 3D CCTA image volume. This volumetric dataset may be acquired using various CT scanner configurations and acquisition protocols, potentially including contrast-enhanced imaging techniques that highlight coronary vasculature. In some embodiments, the received CCTA volume may include multiple cardiac phases to capture dynamic cardiac motion, while in other implementations, a single phase representing diastole may be utilized for optimal coronary visualization. The image volume could be provided in various formats, such as DICOM series, and may include metadata describing acquisition parameters, patient information, and other relevant clinical context.

In step 3004, the system may process the 3D CCTA image volume and output a digital twin of the patient's heart, including for example: a geometric model of the patient's coronary tree, quantification of plaque, computation of physiological parameters in the coronary circulation. The processing may involve multiple computational stages, potentially including image segmentation to delineate coronary lumen boundaries, myocardium, and cardiac chambers; centerline extraction to characterize vessel topology; plaque detection and characterization algorithms to identify calcified, non-calcified, and mixed plaque components; and computational fluid dynamics simulations to derive hemodynamic parameters such as pressure gradients, flow rates, and fractional flow reserve values. In some embodiments, the digital twin may incorporate machine learning-based approaches for feature extraction and parameter estimation, potentially leveraging deep neural networks trained on large cardiovascular imaging datasets to enhance accuracy and computational efficiency.

In step 3006, the system may develop models and processes for processing other modalities to derive relevant information to update the digital twin. These models could be designed to extract complementary information from various imaging and non-imaging data sources that may provide additional insights beyond what can be derived from CCTA alone. The development process may involve training specialized machine learning algorithms tailored to each modality's unique characteristics and information content. In some implementations, transfer learning approaches could be employed to leverage knowledge gained from one modality to enhance feature extraction from another, potentially improving model performance when limited training data is available for certain modalities. The developed models may incorporate various architectural designs including convolutional neural networks for spatial feature extraction, recurrent neural networks for temporal data processing, or transformer-based approaches for capturing complex relationships across different data types.

In some instances, the system may develop a model to automatically estimate myocardial blood flow from perfusion imaging and update coronary flow and pressure computations in the digital twin model. This model could process various perfusion imaging modalities, such as stress/rest nuclear perfusion studies, first-pass contrast-enhanced cardiac magnetic resonance, or dynamic CT perfusion sequences. The blood flow estimation algorithms may incorporate quantitative analysis of contrast dynamics, potentially including time-intensity curve analysis, deconvolution techniques, or compartmental modeling approaches to derive absolute or relative perfusion metrics. In certain embodiments, the model may be capable of identifying perfusion defects, quantifying their extent and severity, and establishing correspondence between these defects and specific coronary territories to refine boundary conditions for computational fluid dynamics simulations within the digital twin framework.

In other instances, the system may develop a model to estimate total coronary flow from phase contrast MRI and update coronary flow and pressure computations in the digital twin model. This model could analyze velocity-encoded MRI sequences acquired at the coronary ostia or in the aortic root to quantify volumetric flow rates entering the coronary circulation. The flow estimation process may involve segmentation of the relevant vascular structures, extraction of velocity vectors from phase data, and integration across vessel cross-sections to compute time-resolved flow measurements. Advanced processing techniques could be implemented to address technical challenges such as partial volume effects, phase wrap artifacts, or cardiac and respiratory motion. The derived flow measurements may serve as critical boundary conditions for the digital twin's hemodynamic simulations, potentially improving the accuracy of downstream pressure gradient and fractional flow reserve predictions by incorporating patient-specific flow parameters rather than relying on population-based assumptions.

In other instances, the system may develop a model to estimate deformation and strain from Cine-CMR to update the deformation of a digital twin model, also affecting the flow and pressure in the coronary tree. This model could analyze time-resolved cardiac magnetic resonance images capturing the full cardiac cycle to quantify myocardial motion, wall thickening, and regional contractility patterns. The deformation analysis may employ various computational approaches such as feature tracking, deformable registration, or physics-informed neural networks to derive displacement fields and strain tensors throughout the myocardium. In some embodiments, the model could incorporate tissue tagging or displacement encoding techniques for enhanced motion tracking accuracy. The extracted deformation parameters may enable more sophisticated fluid-structure interaction modeling within the digital twin, potentially accounting for the dynamic effects of cardiac contraction and relaxation on coronary flow patterns, including phasic flow variations and the impact of myocardial compression on vessel resistance during systole. This biomechanical coupling could provide more physiologically realistic simulations compared to static models, particularly for assessing conditions where coronary-myocardial interactions play significant roles.

Still referring to FIG. 30, in step 3008, the system may derive relevant information utilizing one or more of the developed models. This derivation process could involve applying the trained models to newly acquired multi-modal patient data to extract parameters that complement or refine the initial CCTA-based digital twin. The information extraction may be performed through automated pipelines that handle data preprocessing, model inference, and post-processing steps to generate quantitative metrics and anatomical characterizations. In some implementations, the system may employ ensemble approaches that combine outputs from multiple models to enhance prediction robustness, potentially using weighted averaging or more sophisticated fusion techniques based on estimated confidence levels for each model's outputs. The derived information could include various physiological parameters such as regional perfusion values, time-resolved flow measurements, myocardial contractility indices, or tissue characterization metrics that provide insights into myocardial viability, fibrosis, or other structural properties relevant to cardiovascular function assessment.

In step 3010, the system may update the digital twin model using the additional derived relevant information from other processed modalities, and the computation of clinically-relevant metrics, including but not limited to: percent diameter stenosis (% DS), plaque volume or burden, physiological clinical parameters such as factional flow reserve (FFRCT), % Myocardium at Risk, or myocardial contractility. The updating process could involve sophisticated data assimilation techniques that integrate new information while maintaining consistency with previously established model components. In some embodiments, Bayesian approaches may be employed to update model parameters based on the relative uncertainty of different data sources, potentially giving greater weight to more reliable or higher-resolution measurements. The digital twin refinement may occur at multiple levels, potentially including geometric updates to vessel or chamber morphology, adjustment of boundary conditions for fluid dynamics simulations, modification of tissue material properties for mechanical modeling, or recalibration of electrophysiological parameters. This multi-scale, multi-physics updating approach could enable comprehensive refinement of the digital twin to more accurately reflect the patient's specific cardiovascular characteristics as revealed through the integration of complementary imaging and functional assessments. The updated digital twin may provide enhanced diagnostic capabilities, more accurate risk stratification, and improved treatment planning guidance compared to models based on single-modality assessments.

In step 3012, downstream models may be updated using outputs of digital twin and other relevant patient data.

In some embodiments utilizing a risk estimation system, one or more models may be developed to ingest different sets of available data to update the risk of a patient given any new data. Possible models may for example include survival models, or classifiers or regression models, or any other suitable model.

In another embodiment, all available patient data may be combined into a unifying system (which may constitute multiple sub-models, each interpretable in their own right) of a patient's risk, which may be applied to one or more diseases. This system may use both machine learning and biophysical models, where most appropriate, to best represent the contribution of additional modalities/risk factors in the identification, characterization and decision making for treatment for each disease.

In further embodiments, missing clinical parameters for a patient may be imputed, for example by training machine learning models to make predictions of relevant patient parameters from existing data sources (e.g. CCTA) which might otherwise require additional testing (e.g. blood tests for determining dyslipidemia), or by using any suitable data imputation technique.

In another embodiment, to integrate multiple data sources into a unified framework, optimally one which may be interpretable and interactive for a physician, a multi-modal foundation model incorporating all available datasets (e.g. imaging, ECG, physiological measurements, text and clinical data) may be trained to learn relationships between different modalities and clinical parameters. Foundation models may also be trained on individual modalities (for example where only a single modality may be available for a set of the total population), and may then be combined later into a unified multi-modal foundation model, for example in a fine-tuning or transfer learning stage of model training. This system may be used to train additional downstream models for risk prediction in relation to available or imputed input variables. This system may also be used interactively by physicians to query the importance of factors derived from the input data, and to provide guidance on diagnosis and treatment planning given existing patient data. This system may also be queried to suggest acquisition of further tests that would be most informative for the diagnosis and treatment planning of a patient.

In another embodiment, to generate and use a retrieval mechanism to find similar patients from which insights may be drawn, multi-modal generative models may be trained to produce embeddings of all existing patient (multi-modal) data, such that search may be performed with the system to find similar patient cases which may be used as an additional reference for physicians to make better informed decisions for a patient at hand.

Additionally, saliency methods for neural networks (e.g. grad-CAM; guided back-propagation) and methods feature importance (e.g. Shapley analysis; feature importance by permutation; coefficient analysis) may enable users to better understand the impact of different input data on the system's predictions.

In some embodiments, a most informed model may be developed that incorporates newly available data to update computations or predictions for a given product. For example, given a CTA scan, one or more models may extract relevant features and compute clinically relevant metrics from the image. Additional data may be provided from another modality that may be used to update the model, its derived features and computed metrics, improving the accuracy of these. For example, the additional data may be provided from a model developed to process IVUS images, which may update the 3D model geometry, plaque and RoadMap analysis. In another example, a Major adverse cardiovascular events (MACE) risk prediction may be made for a patient initially based on a CT scan alone. Clinical risk factors may be subsequently provided, allowing the risk estimation to be updated incorporating these additional risk factors. Genomic features may be made available for the patient, which may allow an updated risk to be computed. Diagnostic information of other diseases, e.g. cancer, may be provided, which may update the patient risk and treatment options. Wearable data may become available over a period of time, indicating changes to patient characteristics, which may update the patient risk.

In other embodiments, a most-informed model may be developed that incorporates a combination of biophysical models and machine learning where appropriate to inform patient risk. For example, a biophysical model of the heart may be built from a single CTA scan, incorporating the myocardium of the large structures of the heart and the coronary artery tree lumen geometry derived from deep learning models. This model may make assumptions of aortic pressure, healthy microvascular resistance, and may simulate steady-state flow in the coronary arteries and perfusion in the myocardium, which may be used to compute FFRCT

In another example, a machine learning model may be trained to predict patient-specific microvascular resistance may be applied to the biophysical model, updating the boundary conditions, allowing the effect of microvascular disease to be observed in the perfusion-derived and FFRCT parameters, as well as microvascular-specific clinical parameters (e.g. MRR). Cardiac Magnetic Resonance Imaging (CMR) image data may be acquired, including for example: Cine-CMR, with which a time-dependent mechanics model of the heart may be fitted, updating the flow from steady-state to dynamic and incorporating the effects of myocardial cross-talk on perfusion of the myocardium and flow in the coronary arteries, updating the computation of perfusion-derived parameters and FFRCT. Additional clinically relevant parameters may also now be computed such as ejection fraction, end-diastolic volume and end-systolic volume, informing diagnosis of other conditions such as heart failure. Other acquisition protocols may also be used to update a digital twin model, for example late gadolinium enhancement may be used to identify scar which may be used to update model boundary conditions (e.g. flow, where scarred myocardium does not receive blood). Phase contrast imaging may be used to quantify flow in the aortic root, which may be used to update model boundary conditions, e.g. total coronary flow. T1 imaging may be used to identify MI, fibrosis and edema, and may be used to update model boundary conditions

In another example, a most-informed model may be developed that uses an interactive multi-modal foundation model to enable physicians to better understand and reason about patient data, at different time points upon acquisition of additional modalities. The multi-modal foundation model may have been trained on a range of clinical modalities relevant to assessing cardiac disease, including but not limited to 3D and 2D medical imaging modalities (CTA, CMR, US), electrocardiogram (ECG), genomics data, electronic health record (EHR) structured tabular data as well as text reports. The system may be fine-tuned with a large language model for question and answering tasks, enabling an interactive chat system for doctors to query about their patients. In some instances, a physician may be able to query the system to generate a report of all of the relevant factors that may be derived from the available patient data, where the system may also be able to provide diagnoses of identified conditions and suggest treatment options. In other instances, a physician may be able to query the system to explain its decision making. Additionally, the physician may ask the system about other tests and modalities that may be valuable to acquire to better inform decision making, and provide an explanation. Furthermore, given newly acquired data, the physician may query the system to update its reasoning, reports, diagnoses and treatment suggestions based on the new data. Additionally, the physician may use the system to provide further evidence from similar patients to inform its reasoning, diagnoses, and treatment suggestions.

In summary, a most-informed model may combine biophysical model outputs, results of clinical tests from EHRs, and machine learning-derived parameters as inputs to the interactive multi-modal foundation model, providing a holistic understanding of the patient's disease state, and deriving further insights for the physician to determine further data that may be most informative to update the model, and determine the most important factors for a physician to consider, and an appropriate course of action in treating the patient.

### Modality Translation and Generation

Modality translation and generation systems may enable cardiovascular assessment through automated conversion between different types of medical data representations including imaging modalities, anatomical segmentations, and textual descriptions. The modality translation methodology may utilize multi-modal generative models that learn unified representation spaces capable of encoding information from diverse data sources while maintaining the ability to generate outputs in various target formats. The translation system may be configured to process coronary computed tomography angiography images, cardiac magnetic resonance imaging datasets, echocardiographic studies, and associated clinical documentation to create integrated analysis capabilities that extend beyond the limitations of individual data modalities.

FIG. 31 depicts an exemplary method 3100 for modality translation and generation, which may provide a framework for converting between different medical data representations while preserving clinically relevant information across various formats.

In step 3102, the system may receive data from various modalities, including medical images (e.g., CCTA, SPECT/PET, MRI, echocardiography), segmentations (manual and automated), annotations (such as disease classifications, quantitative measurements, or radiologist observations), and text descriptions of the anatomy. The received data may be in various formats, resolutions, and dimensionalities, potentially including 2D slices, 3D volumes, or time-series acquisitions that capture dynamic physiological processes. In some implementations, the system may perform preprocessing steps such as normalization, registration, or quality assessment to ensure consistency across different data sources prior to subsequent processing stages.

In step 3104, the system may train a suitable set of generative multi-modal models, capable of handling multiple input and output modalities, which share a joint embedding space.

The multi-modal model may be trained to learn a single latent representation for multiple modalities and is capable of producing different output views (image modalities, segmentations, text, 3D geometric representations) of the anatomy. The joint embedding space may enable seamless translation between different data representations while preserving anatomical consistency and clinical relevance. In some embodiments, the training process may involve progressive stages where simpler transformations are learned first before tackling more complex cross-modal translations. The architecture may incorporate attention mechanisms that help the model focus on relevant anatomical structures when generating outputs in different modalities, potentially improving the accuracy of fine details in the translated representations.

In some instances, the multi-modal model may be trained with Vision models built using vision transformers, or convolutional neural network backbones. The vision transformer architecture may incorporate self-attention mechanisms that can capture long-range dependencies within medical images, potentially enabling more effective modeling of anatomical relationships across different spatial scales. The transformer-based approach may be particularly suitable for handling the variable field-of-view and resolution characteristics common in medical imaging datasets. Convolutional neural network backbones may provide complementary capabilities through their inherent inductive biases toward local feature extraction and spatial hierarchy, which can be advantageous for capturing fine-grained anatomical details. In certain implementations, hybrid architectures combining elements of both approaches may be employed to leverage their respective strengths for different aspects of the modality translation task.

In some instances, the multi-modal model is trained with VAEs, GANs and diffusion models. Variational autoencoders (VAEs) may provide probabilistic latent representations that can capture uncertainty in the relationships between different modalities, potentially enabling more robust translation in cases where the mapping between modalities is inherently ambiguous. Generative adversarial networks (GANs) may incorporate discriminator components that help ensure the realism and clinical plausibility of generated outputs across different modalities, potentially addressing challenges related to domain gaps between different imaging techniques. Diffusion models may offer advantages through their iterative denoising approach to generation, which can provide fine-grained control over the generation process and potentially produce higher-quality outputs for complex medical imaging modalities. In some implementations, ensemble approaches combining multiple generative frameworks may be employed to leverage their complementary strengths for different aspects of the cross-modal translation task.

In some instances, the multi-modal model is trained with training frameworks for joint embeddings that use contrastive learning or masked multi-modal reconstruction. Contrastive learning approaches may help the model learn representations that bring semantically similar content from different modalities closer in the embedding space while pushing dissimilar content apart, potentially improving the alignment between corresponding anatomical structures across different data representations. The contrastive objectives may be implemented through various techniques such as InfoNCE, SimCLR, or MoCo adaptations tailored to medical imaging contexts. Masked multi-modal reconstruction frameworks may involve selectively obscuring portions of input data and training the model to recover the missing information, potentially encouraging the learning of robust representations that capture the shared information content across different modalities. These self-supervised approaches may be particularly valuable when paired training data is limited, as they can leverage unlabeled examples to learn meaningful cross-modal relationships.

In step 3106, the system may train the models with reconstruction and encoding losses. These complementary loss functions can guide the learning process toward representations that effectively capture both modality-specific details and cross-modal relationships. The combination of different loss components may be weighted dynamically during training to balance various aspects of the learning objectives, potentially adapting to the characteristics of different data modalities and their relative importance for specific clinical applications.

Training with reconstruction losses may ensure that the generated outputs closely match the target outputs. This involves minimizing the difference between the generated and real data across all modalities. The reconstruction losses may be implemented through various metrics such as mean squared error, structural similarity index, perceptual losses based on feature activations from pretrained networks, or specialized medical image quality metrics that emphasize clinically relevant features. In some embodiments, the reconstruction objectives may incorporate anatomical constraints or prior knowledge about the expected characteristics of different imaging modalities, potentially improving the preservation of diagnostically important details during the translation process. The loss functions may be adapted to the specific characteristics of each modality, with different weighting schemes applied to different image regions based on their clinical significance.

Training with encoding losses enforces matching the encoding space for different modalities/inputs of the same anatomy. This helps the model learn a unified representation of the anatomy across various data types. The encoding losses may be implemented through various approaches such as KL divergence between latent distributions, cosine similarity between embedding vectors, or mutual information maximization between representations derived from different modalities. In some implementations, the encoding objectives may incorporate hierarchical structures that align representations at multiple levels of abstraction, potentially capturing both fine-grained anatomical details and higher-level structural relationships. The alignment process may be guided by anatomical landmarks or semantic segmentations when available, providing additional supervision signals that can improve the correspondence between different modality representations.

In step 3108, the system may fine tune the model using specific tasks or applications, such as plaque enhancement, text report generation, or modality translation, to optimize performance for these use cases. The fine-tuning process may involve additional training with task-specific loss functions, specialized datasets focused on particular clinical scenarios, or adaptation techniques that adjust the model parameters to better address the requirements of specific applications. In some embodiments, the fine-tuning stage may incorporate feedback from clinical experts to guide the optimization process toward outputs that align with diagnostic priorities and clinical workflows. The task-specific adaptation may involve freezing certain model components while updating others, potentially preserving the general cross-modal representation capabilities while enhancing performance for particular translation tasks.

In some embodiments, the model may be fine-tuned to enhance visualization of plaque. In this embodiment, given an input CCTA image, the system may generate plaque-enhanced CCTA that highlights locations and types of plaque, such as non-calcified plaque which can be difficult to discern in CCTA alone. The generative model trained on CCTA and invasive modalities can gain a better understanding of plaque characteristics and yield better plaque segmentations than segmentation from CCTA alone. The plaque segmentation can be used as an overlay on a CCTA image for highlighting plaque. The enhancement process may involve selective contrast adjustment, color mapping, or texture emphasis techniques that make different plaque components more visually distinguishable. In some implementations, the system may generate multi-parametric visualizations that combine information from different imaging sequences or modalities to provide comprehensive characterization of plaque composition, including lipid content, fibrous components, calcification patterns, and inflammatory markers. The enhanced visualization may incorporate confidence estimates or uncertainty representations that indicate the reliability of plaque detection in different regions, potentially helping clinicians interpret the results with appropriate caution in areas of higher uncertainty.

In other embodiments, the system may be used to combine information from non-contrast computed tomography (NCCT) and coronary computed tomography angiography (CCTA) for enhanced detection and characterization of calcified plaque that may be missed or underestimated in CCTA alone due to the contrast agents having similar Hounsfield unit (HU) values as calcified plaque. The multi-modal approach may leverage the complementary information provided by both imaging techniques, where NCCT may provide clear visualization of calcium deposits without contrast interference, while CCTA may offer detailed anatomical context and lumen visualization. In some implementations, the system may utilize registration algorithms to spatially align the NCCT and CCTA datasets, potentially enabling precise correlation of calcium deposits with specific coronary segments and anatomical landmarks. The fusion methodology may incorporate machine learning algorithms trained to distinguish between true calcified plaque and contrast-enhanced regions based on the combined information from both modalities, potentially improving the accuracy of calcium scoring and plaque burden assessment. In certain embodiments, the system may generate composite visualizations that overlay calcium information from NCCT onto the anatomical framework provided by CCTA, potentially facilitating more comprehensive assessment of coronary atherosclerosis and enabling more accurate risk stratification for cardiovascular events.

In some embodiments, the model may be fine-tuned for text report generation. In this embodiment, given an input image (e.g. CCTA), the system may generate a summary in the form of a written report of plaque presence adapted to a specific audience (e.g. doctor versus patients) with references to images and locations in the anatomy. The report generation capability may incorporate natural language processing techniques that translate visual features into clinically appropriate terminology and descriptive language. In some implementations, the system may generate structured reports following standardized reporting templates such as CAD-RADS for coronary artery disease or other specialty-specific reporting frameworks. The generated text may include quantitative measurements extracted from the imaging data, comparative assessments with population norms or prior examinations, and suggested follow-up recommendations based on identified findings. The audience adaptation features may adjust terminology complexity, explanation depth, visualization references, and contextual information based on whether the intended reader is a healthcare professional or a patient, potentially improving communication effectiveness across different clinical scenarios.

In some embodiments, the model may be fine-tuned for modality translation. In this embodiment, given an input image, the model may visualize modalities not acquired during patient examination. For example, the model may generate SPECT/PET perfusion images from CCTA and FFRct data, potentially providing functional information about myocardial blood flow without requiring additional radiation exposure or contrast administration. The synthetic perfusion images may incorporate physiological models that relate coronary anatomy and computed flow parameters to expected tissue perfusion patterns under various conditions. Furthermore, the model may convert between different image modalities, segmentations, and annotations. The translation capabilities may extend to generating synthetic MRI sequences with different contrast weightings, ultrasound visualizations from tomographic data, or angiographic projections from volumetric datasets. In some implementations, the system may provide side-by-side visualizations of original and translated data to facilitate comparison and validation by clinical users. The modality translation functionality may be particularly valuable in cases where certain imaging studies are contraindicated due to patient-specific factors such as implanted devices, contrast allergies, or radiation exposure concerns.

In some embodiments, the model may be fine-tuned for disease co-location. In this embodiment, the model may identify and co-locate disease indicators across different modalities, providing a comprehensive view of the patient's condition. The co-location capabilities may involve spatial registration techniques that align findings from different imaging studies within a common coordinate system, potentially enabling more accurate correlation between anatomical and functional abnormalities. In some implementations, the system may generate fusion visualizations that combine information from multiple modalities into integrated displays, such as overlaying perfusion data on anatomical images or correlating tissue characterization findings with structural abnormalities. The disease co-location functionality may incorporate temporal alignment for studies performed at different timepoints, potentially enabling assessment of disease progression or treatment response across multiple imaging parameters. The system may provide quantitative metrics of spatial correspondence between findings in different modalities, potentially helping clinicians assess the consistency and reliability of detected abnormalities across different imaging techniques.

In some embodiments, the model may be fine-tuned for image-to-text and text-to-image conversion. The model may generate text descriptions from medical images, potentially including detailed anatomical descriptions, pathological findings, measurement reports, and differential diagnostic considerations. The text generation capabilities may incorporate domain-specific medical terminology and reporting conventions appropriate for different clinical specialties and contexts. Alternatively, the model may generate medical images or segmentations from text descriptions, potentially enabling visualization of findings described in clinical notes or radiology reports. The text-to-image conversion may support various levels of specificity in the input descriptions, from general anatomical references to detailed pathological characterizations. In some implementations, the system may provide interactive capabilities where users can refine generated outputs through iterative text prompts, potentially enabling exploration of different visualization options or anatomical variations based on textual specifications. The bidirectional conversion capabilities may facilitate communication between different members of healthcare teams who may have varying preferences for visual or textual information formats.

In some embodiments, the model may be fine-tuned for anatomy encoding and sampling. In this embodiment, the model may generate modality views from arbitrary samplings of the anatomy encoding space, allowing for the exploration of different anatomical variations and representations. The encoding space may capture continuous variations in anatomical structures, pathological features, and imaging characteristics, potentially enabling systematic exploration of the spectrum of normal and abnormal appearances. In some implementations, the system may support controlled manipulation of specific anatomical parameters while maintaining overall physiological plausibility, such as adjusting vessel dimensions, chamber volumes, or tissue composition within realistic ranges. The sampling capabilities may enable generation of educational materials illustrating progressive stages of disease development, anatomical variants, or the effects of different imaging parameters on visualization of specific structures. The anatomy encoding functionality may incorporate population statistics to inform the sampling process, potentially generating representations that reflect the distribution of anatomical variations observed in clinical populations while allowing exploration of rare or unusual configurations that might be underrepresented in available training data.

### Fine-Tuning/Refining a Generative Model

Fine-tuning and refining trained models may extend the capabilities of trained artificial intelligence systems to address related but different clinical prediction tasks while maintaining performance on original applications. Trained models may refer to any trained deep neural network, including pre-trained unsupervised feature extractors, or trained generative models, or models that have been trained on one or more tasks, optionally in conjunction with some form of self- or semi-supervised training.

The fine-tuning process may involve obtaining a trained\model that has been developed for a specific medical imaging task and adapting the model to perform additional or alternative functions using supplementary training data. This approach may provide computational efficiency advantages compared to training entirely new models from scratch, while enabling the leveraging of learned representations and feature extraction capabilities that have been developed during the initial training process.

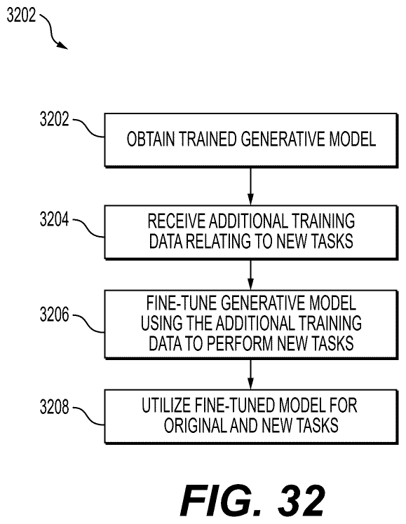

FIG. 32 depicts an exemplary method 3200 for fine-tuning/refining a trained model. Method 3200 may begin with obtaining a trained model that has demonstrated proficiency in a particular clinical prediction task, in step 3202. For example, a generative model may have been initially trained, using techniques discussed herein, to predict acute coronary syndrome based on coronary computed tomography angiography data and associated clinical parameters. The trained model may have learned to identify complex patterns and relationships between imaging features, patient characteristics, and clinical outcomes that are relevant to acute coronary syndrome prediction. The learned representations within the model may capture anatomical features, pathological patterns, and risk factors that contribute to the development of acute coronary syndrome events.

In step 3204, the system may receive additional training data that corresponds to the new target task or tasks of interest. The additional training data may include medical images, clinical parameters, and outcome labels that are relevant to the new prediction task. For instance, if the objective involves extending an acute coronary syndrome prediction model to also predict stroke events, the additional training data may include imaging data and clinical information from patients who have experienced stroke events, along with corresponding outcome labels indicating the occurrence and timing of stroke events. The additional data may also include patients who have not experienced stroke events to provide negative examples for the prediction task.

In step 3206, the trained model may be fine-tuned with the additional training data. Regularization techniques may play a central role in the fine-tuning process to ensure that the model maintains performance on the original task while successfully learning to perform the new task. Regularization approaches may include techniques such as weight decay, dropout, early stopping, and various forms of constraint-based regularization that prevent the model parameters from deviating excessively from the values learned during the original training process. The regularization techniques may help prevent catastrophic forgetting, where the model loses the ability to perform the original task as the model parameters are updated to accommodate the new task.

In step 3208, the fine-tuned model may be utilized to perform the original tasks as well as new tasks. In some instances, the fine-tuned model may used for new tasks as a result of transfer learning.

In some instances, the architecture and training objectives of the original model may be modified to accommodate the new prediction task while preserving the learned representations that remain relevant to both the original and new tasks. The model architecture may be extended to include additional output layers or prediction heads that correspond to the new clinical outcomes being predicted. The training objectives may be modified to include loss functions that correspond to the new prediction tasks, while maintaining loss functions that correspond to the original tasks to prevent degradation of performance on the original applications.

Multi-task learning approaches may be incorporated into the fine-tuning process to enable the model to simultaneously optimize performance on both the original and new prediction tasks. Multi-task learning may involve training the model with combined loss functions that include terms corresponding to both the original and new tasks, with appropriate weighting factors to balance the relative importance of different prediction objectives. The multi-task approach may enable the model to learn shared representations that are beneficial for both tasks while maintaining task-specific capabilities that are tailored to the unique requirements of each prediction objective.

The fine-tuning process may involve iterative training procedures where the model parameters are gradually adjusted to improve performance on the new task while monitoring performance on the original task to ensure that capabilities are preserved. The training process may involve alternating between training on data corresponding to the original task and training on data corresponding to the new task, or simultaneous training on combined datasets that include examples from both tasks. The training schedule and data sampling strategies may be optimized to achieve balanced performance across all tasks while minimizing the risk of performance degradation on any individual task.

Transfer learning techniques may be applied during the fine-tuning process to leverage the learned feature representations from the original model while adapting the model to the specific characteristics of the new prediction task. Transfer learning may involve freezing certain layers of the original model while allowing other layers to be updated during fine-tuning, or applying different learning rates to different parts of the model to control the extent of parameter updates in different model components. The transfer learning approach may help preserve valuable learned representations while enabling the model to adapt to the new task requirements.

The fine-tuning process may incorporate validation procedures to assess the performance of the refined model on both the original and new prediction tasks. Cross-validation techniques may be applied to evaluate model performance on held-out datasets that were not used during the fine-tuning process. The validation procedures may include metrics that assess prediction accuracy, sensitivity, specificity, and other performance measures that are relevant to the specific clinical applications. The validation process may also include assessments of model calibration to ensure that predicted probabilities correspond appropriately to actual event rates in the target population.

The refined model may provide enhanced clinical utility by enabling comprehensive risk assessment across multiple related clinical outcomes using a single integrated system. Clinicians may benefit from the ability to assess patient risk for multiple types of cardiovascular and cerebrovascular events using a unified modeling approach that leverages shared risk factors and imaging features. The multi-task prediction capabilities may enable more comprehensive patient risk stratification and may inform clinical decision-making by providing a broader perspective on patient health status and potential future clinical events.

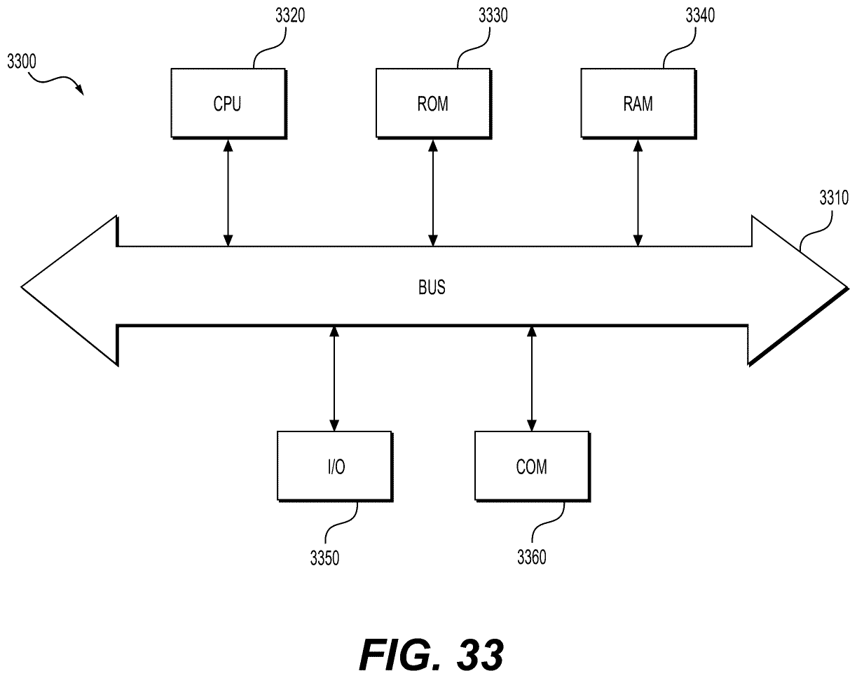

FIG. 33 is a simplified block diagram of an exemplary computer system 3300 in which embodiments of the present disclosure may be implemented, for example as any of the physician devices or servers 102, third party devices or servers 104, and server systems 106. A platform for a server 3300, for example, may include a data communication interface for packet data communication 3360. The platform may also include a central processing unit (CPU) 3320, in the form of one or more processors, for executing program instructions. The platform typically includes an internal communication bus 3310, program storage and data storage for various data files to be processed and/or communicated by the platform such as ROM 3330 and RAM 3340, although the server 3300 often receives programming and data via a communications network (not shown). The hardware elements, operating systems and programming languages of such equipment are conventional in nature, and it is presumed that those skilled in the art are adequately familiar therewith. The server 3300 also may include input and output ports 3350 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

As described above, the computer system 3300 may include any type or combination of computing systems, such as handheld devices, personal computers, servers, clustered computing machines, and/or cloud computing systems. In one embodiment, the computer system 3300 may be an assembly of hardware, including a memory, a central processing unit (“CPU”), and/or optionally a user interface. The memory may include any type of RAM or ROM embodied in a physical storage medium, such as magnetic storage including floppy disk, hard disk, or magnetic tape; semiconductor storage such as solid-state disk (SSD) or flash memory; optical disc storage; or magneto-optical disc storage. The CPU may include one or more processors for processing data according to instructions stored in the memory. The functions of the processor may be provided by a single dedicated processor or by a plurality of processors. Moreover, the processor may include, without limitation, digital signal processor (DSP) hardware, or any other hardware capable of executing software. The user interface may include any type or combination of input/output devices, such as a display monitor, touchpad, touchscreen, microphone, camera, keyboard, and/or mouse.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms, such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A method of training a whole medical image foundation model, the method comprising:
receiving a plurality of medical image datasets;
extracting local sections of image data from the plurality of medical image datasets;
obtaining one or more causal variables associated with the local sections and/or patient;
training one or more self-supervised learning models based on the local sections of image data and the causal variables;
combining the one or more trained self-supervised learning models with a deep learning network configured to combine a latent representation of the local sections of image data from the one or more trained self-supervised learning models into a patient-level representation; and
combining, with the one or more trained self-supervised learning models and the deep learning network, at least one further network or function configured to accept the patient-level representation as input, the at least one further network or function operable to perform one or more patient-specific prediction tasks.

2. The method of claim 1, wherein the deep learning network comprises at least one of: a Convolutional Neural Network, a Graph Convolutional Neural Network, a PointNet, or a Transformer architecture.

3. The method of claim 1, wherein the medical image datasets comprise coronary computed tomography angiography images.

4. The method of claim 1, wherein a first self-supervised learning model is trained using a portion of the local sections of image data corresponding to regions surrounding coronary arteries.

5. The method of claim 4, wherein:
at least one further self-supervised learning model is trained using a further portion of the local sections of image data corresponding to at least one other structure in the medical image datasets; and
the at least one other structure comprises myocardium.

6. The method of claim 1, wherein the prediction tasks comprise at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.

7. The method of claim 1, further comprising incorporating an unsupervised clustering loss function trained concurrently with the at least one further network or function, wherein the clustering loss function is configured to group patients into clusters with low intra-class variations and high inter-class variations.

8. The method of claim 1, further comprising:
freezing networks used to obtain the patient-level representations; and
training additional tasks using the patient-level representation.

9. A system for training a whole medical image foundation model, the system comprising:
at least one memory storing instructions; and
at least one processor configured to execute the instructions to perform operations, including:
receiving a plurality of medical image datasets;
extracting local sections of image data from the plurality of medical image datasets;
obtaining one or more causal variables associated with the local sections and/or patient;
training one or more self-supervised learning models based on the local sections of image data and the causal variables;
combining the one or more trained self-supervised learning models with a deep learning network configured to combine a latent representation of the local sections of image data from the one or more trained self-supervised learning models into a patient-level representation; and
combining, with the one or more trained self-supervised learning models and the deep learning network, at least one further network or function configured to accept the patient-level representation as input, the at least one further network or function operable to perform one or more patient-specific prediction tasks.

10. The system of claim 9, wherein the deep learning network comprises at least one of: a Convolutional Neural Network, a Graph Convolutional Neural Network, a PointNet, or a Transformer architecture.

11. The system of claim 9, wherein the medical image datasets comprise coronary computed tomography angiography images.

12. The system of claim 9, wherein a first self-supervised learning model is trained using a portion of the local sections of image data corresponding to regions surrounding coronary arteries.

13. The system of claim 12, wherein:
at least one further self-supervised learning model is trained using a further portion of the local sections of image data corresponding to at least one other structure in the medical image datasets; and
the at least one other structure comprises myocardium.

14. The system of claim 9, wherein the prediction tasks comprise at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.

15. The system of claim 9, further comprising incorporating an unsupervised clustering loss function trained concurrently with the at least one further network or function, wherein the clustering loss function is configured to group patients into clusters with low intra-class variations and high inter-class variations.

16. The system of claim 9, further comprising:
freezing networks used to obtain the patient-level representations; and
training additional tasks using the patient-level representation.

17. A non-transitory computer-readable medium storing instructions that, when executed by a computer, cause the computer to perform a method for training a whole medical image foundation model, the method comprising:
receiving a plurality of medical image datasets;
extracting local sections of image data from the plurality of medical image datasets;
obtaining one or more causal variables associated with the local sections and/or patient;
training one or more self-supervised learning models based on the local sections of image data and the causal variables;
combining the one or more trained self-supervised learning models with a deep learning network configured to combine a latent representation of the local sections of image data from the one or more trained self-supervised learning models into a patient-level representation; and
combining, with the one or more trained self-supervised learning models and the deep learning network, at least one further network or function configured to accept the patient-level representation as input, the at least one further network or function operable to perform one or more patient-specific prediction tasks.

18. The non-transitory computer-readable medium of claim 17, wherein the deep learning network comprises at least one of: a Convolutional Neural Network, a Graph Convolutional Neural Network, a PointNet, or a Transformer architecture.

19. The non-transitory computer-readable medium of claim 17, wherein the medical image datasets comprise coronary computed tomography angiography images.

20. The non-transitory computer-readable medium of claim 17, wherein the prediction tasks comprise at least one of: predicting if a patient may experience a cardiovascular event, identifying whether a patient has a condition selected from hypertension, hyperlipidemia, or diabetes, recognizing a CT vendor or scanner type, determining patient preparation factors, estimating microvascular resistance reserve values, predicting demographic characteristics, or assessing image quality for Fractional Flow Reserve Computed Tomography analysis.
